(19) United States
(12) Patent Application Publication
(10) Pub. No.: US 2012/0020518 A1
(43) Pub. Date: Jan. 26, 2012

(54) PERSON TRACKING DEVICE AND PERSON TRACKING PROGRAM

(76) Inventor: Shinya Taguchi, Tokyo (JP)

(21) Appl. No.: 13/147,639

(22) PCT Filed: Feb. 9, 2010
(86) PCT No.: PCT/JP2010/000777

§ 371 Date: Aug. 3, 2011

(30) Foreign Application Priority Data
Feb. 24, 2009 (JP) 2009-040742

(51) Int. Cl. G06K 9/00

(52) U.S. Cl. 382/103

(57) ABSTRACT

A two-dimensional moving track calculating unit 45 is provided for calculating a two-dimensional moving track of each individual person in each of a plurality of video images by tracking the position on each of the plurality of video images which is calculated by a person position calculating unit 44, and a three-dimensional moving track calculating unit 46 carries out stereo matching between two-dimensional moving tracks in the plurality of video images, which are calculated by the two-dimensional moving track calculating unit 45, to calculate a degree of match between the two-dimensional moving tracks, and calculates a three-dimensional moving track of each individual person from two-dimensional moving tracks each having a degree of match equal to or larger than a specific value.

### FIELD OF THE INVENTION

The present invention relates to a person tracking device for and a person tracking program for detecting each individual person which exists in an area to be monitored to track each individual person.

### BACKGROUND OF THE INVENTION

Although a huge number of elevators are installed in a skyscraper, a group control operation of causing such many elevators to operate in conjunction with one another is required in order to convey passengers efficiently at the time of morning commuter rush-hour and rush-hour for lunch break, for example. In order to carry out the group control operation of causing many elevators to operate in conjunction with one another efficiently, it is necessary to measure movement histories of passengers about “on which floor how many persons got on each elevator and on which floor how many persons got off each elevator”, and to provide the movement histories for a group management system.

Conventionally, various proposals have been made as to a person tracking technology of counting of the number of passengers, and measuring each passenger's movements by using a camera.

As one of them, a person tracking device for detecting passengers in an elevator to count the number of passengers in the elevator by determining for a difference image (a background difference image) between a background image pre-stored therein and an image of the inside of the elevator captured by a camera (refer to patent reference 1) has been proposed.

However, in the case in which the elevator is greatly crowded, each passenger exists in an about-25 cm square and a situation in which passengers in the image overlap one another occurs. Therefore, the background difference image may become a silhouette of a group of people. As a result, it is very difficult to separate an image of each individual person from the background difference image, and the above-mentioned person tracking device cannot count the number of passengers in the elevator correctly.

Furthermore, as another technology, a person tracking device provided with a camera installed in an upper portion of an elevator cage, for carrying out pattern matching between a reference pattern of each person's head image pre-stored therein and an image captured by a camera to detect the head of each passenger in the elevator and count the number of passengers in the elevator case (refer to patent reference 2) has been proposed.

However, if a passenger is shaded by another passenger when the passenger is viewed from the camera, for example, when passengers are detected by using such the simple pattern matching, the number of passengers may be counted erroneously. Furthermore, in the case in which a mirror is installed in the elevator cage, a passenger in the mirror may be detected erroneously.

In addition, as another technology, a person tracking device provided with a stereoscopic camera installed in an upper portion of an elevator cage, for carrying out stereo vision of each person who is detected from an image captured by the stereoscopic camera to determine the person's three-dimensional position (refer to patent reference 3) has been proposed.

However, this person tracking device may detect a larger number of persons than the actual number of persons.

More specifically, in the case of this person tracking device, as shown in FIG. 45, for example, when determining a person X's three-dimensional position, a point at which a vector VA1 from a camera to the detected person and a vector VB1 from another camera to the detected person intersect is calculated as the person's position.

However, it may be estimated that the person exists also at a point that the vector VA1 and a vector VB2 intersect, and, even when only two persons exist actually, it may be therefore determined erroneously that three persons exist.

In addition, as methods of detecting two or more persons by using multiple cameras, a method of using dynamic programming to determine each person's moving track on the basis of a silhouette of the person which is acquired from a background difference (refer to nonpatent reference 1) and a method of determining each person's moving track by using “Particle Filter” (refer to nonpatent reference 2) have been proposed.

The use of each of these methods makes it possible to, even when a person is shared by another person at a point of view, determine the number of persons and each person's moving track by using silhouette information and time series information at another point of view.

However, because the silhouettes of some persons always overlap one another in a crowded elevator cage or train even though each of them is shot from any point of view, these methods cannot be applied to such a situation.

### RELATED ART DOCUMENT

### Patent Reference

Patent reference 1: JP, 8-26611,A (paragraph [0024] and FIG. 1)
Patent reference 2: JP, 2006-168930,A (paragraph [0027] and FIG. 1)
Patent reference 3: JP, 11-66319,A (paragraph [0005] and FIG. 2)

### Nonpatent reference

Nonpatent reference 1: Berclaz, J., Fleuret, F., Fua, P., “Robust People Tracking with Global Trajectory Optimization,” Proc. CVPR, Voll, pp 744-750, June 2006.
Nonpatent reference 2: Otsuka, K., Mukawa, N., “A particle filter for tracking densely populated objects based on explicit multiview occlusion analysis,” Proc. of the 17th International Conf. on Pattern Recognition, Vol. 4, and pp. 745-750, August 2004.

### SUMMARY OF THE INVENTION

Because the conventional person tracking devices are constructed as mentioned above, a problem with these conventional person tracking devices is that in a situation in which an elevator cage which is an area to be monitored is crowded greatly, passengers in the elevator cage cannot be correctly detected and each of the passengers cannot be tracked correctly.

The present invention is made in order to solve the above-mentioned problem, and it is therefore an object of the present invention to provide a person tracking device and a person tracking program which can correctly track each person who exists in an area to be monitored even when the area to be monitored is crowded greatly.

A person tracking device in accordance with the present invention includes: a plurality of shooting units installed at different positions, each for shooting an identical area to be monitored; a person position calculating unit for analyzing a plurality of video images of the area to be monitored which is shot by the plurality of shooting units to determine a position on each of the plurality of video images of each individual person existing in the area to be monitored; and a two-dimensional moving track calculating unit for calculating a two-dimensional moving track of each individual person in each of the plurality of video images by tracking the position on each of the plurality of video images which is calculated by the person position calculating unit, and a three-dimensional moving track calculating unit carries out stereo matching between two-dimensional moving tracks in the plurality of video images, which are calculated by the two-dimensional moving track calculating unit, to calculate a degree of match between the two-dimensional moving tracks, and calculates a three-dimensional moving track of each individual person from two-dimensional moving tracks each having a degree of match equal to or larger than a specific value.

Because the person tracking device in accordance with the present invention is constructed in such a way that the person tracking device includes the a person position calculating unit for analyzing a plurality of video images of the area to be monitored which is shot by the plurality of shooting units to determine the position on each of the plurality of video images of each individual person existing in the area to be monitored; and the two-dimensional moving track calculating unit for calculating a two-dimensional moving track of each individual person in each of the plurality of video images by tracking the position on each of the plurality of video images which is calculated by the person position calculating unit, and the three-dimensional moving track calculating unit carries out stereo matching between two-dimensional moving tracks in the plurality of video images, which are calculated by the two-dimensional moving track calculating unit, to calculate the degree of match between the two-dimensional moving tracks, and for calculates a three-dimensional moving track of each individual person from two-dimensional moving tracks each having a degree of match equal to or larger than the specific value, there is provided an advantage of being able to correctly track each person existing in the area to be monitored even when the area to be monitored is crowded greatly.

### BRIEF DESCRIPTION OF THE FIGURES

FIG. 1 is a block diagram showing a person tracking device in accordance with Embodiment 1 of the present invention;

FIG. 2 is a block diagram showing the inside of a door opening and closing recognition unit 11 which constructs a video analysis unit 3;

FIG. 3 is a block diagram showing the inside of a floor recognition unit 12 which constructs the video analysis unit 3;

FIG. 4 is a block diagram showing the inside of a person tracking unit 13 which constructs the video analysis unit 3;

FIG. 5 is a block diagram showing the inside of an image analysis result display unit 4 which constructs the video analysis unit 3;

FIG. 6 is a flow chart showing a process carried out by the person tracking device in accordance with Embodiment 1 of the present invention;

FIG. 7 is a flow chart showing a process carried out by the door opening and closing recognition unit 11;

FIG. 8 is an explanatory drawing showing the process carried out by the door opening and closing recognition unit 11;

FIG. 9 is an explanatory drawing showing a door index of the door opening and closing recognition unit 11;

FIG. 10 is a flow chart showing a process carried out by the floor recognition unit 12;

FIG. 11 is an explanatory drawing showing the process carried out by the floor recognition unit 12;

FIG. 12 is a flow chart showing pre-processing carried out by the person tracking unit 13;

FIG. 13 is a flow chart showing post-processing carried out by the person tracking unit 13;

FIG. 14 is an explanatory drawing showing an example of using a checkered flag pattern as a calibration pattern;

FIG. 15 is an explanatory drawing showing an example of selecting a ceiling and four corners of an elevator cage as the calibration pattern;

FIG. 16 is an explanatory drawing showing a process of detecting a human head;

FIG. 17 is an explanatory drawing showing a camera perspective filter;

FIG. 18 is a flow chart showing a calculating process carried out by a two-dimensional moving track calculating unit 45;

FIG. 19 is an explanatory drawing showing the process carried out by the two-dimensional moving track calculating unit 45;

FIG. 20 is an explanatory drawing showing a process carried out by a two-dimensional moving track graph generating unit 47;

FIG. 21 is an explanatory drawing showing the process carried out by the two-dimensional moving track graph generating unit 47;

FIG. 22 is a flow chart showing a process carried out by a track stereo unit 48;

FIG. 23 is an explanatory drawing showing a process of searching through a two-dimensional moving track graph which is carried out by the track stereo unit 48;

FIG. 24 is an explanatory drawing showing a process of calculating the degree of match between two-dimensional moving tracks;

FIG. 25 is an explanatory drawing showing an overlap between two-dimensional moving tracks;

FIG. 26 is an explanatory drawing showing a process carried out by a three-dimensional moving track graph generating unit 49;

FIG. 27 is an explanatory drawing showing the process carried out by the three-dimensional moving track graph generating unit 49;

FIG. 28 is a flow chart showing a process carried out by track combination estimating unit 50;

FIG. 29 is an explanatory drawing showing the process carried out by the track combination estimating unit 50;

FIG. 30 is an explanatory drawing showing an example of a screen configuration of the image analysis result display unit 4;

FIG. 31 is an explanatory drawing showing a detailed example of a screen of a time series information display unit 52;

FIG. 32 is an explanatory drawing showing an example of a screen of a summary display unit 53;

FIG. 33 is an explanatory drawing showing an example of a screen of an operation related information display unit 54;

FIG. 34 is an explanatory drawing showing an example of a screen of a sorted data display unit 55;

FIG. 35 is a block diagram showing the inside of a person tracking unit 13 of a person tracking device in accordance with Embodiment 2 of the present invention;

FIG. 36 is a flow chart showing a process carried out by a track combination estimating unit 61;

FIG. 37 is an explanatory drawing showing the process carried out by the track combination estimating unit 61;

FIG. 38 is a block diagram showing the inside of a person tracking unit 13 of a person tracking device in accordance with Embodiment 3 of the present invention;

FIG. 39 is a flow chart showing a process carried out by a two-dimensional moving track labeling unit 71 and a process carried out by a three-dimensional moving track cost calculating unit 72;

FIG. 40 is an explanatory drawing showing the process carried out by the two-dimensional moving track labeling unit 71 and the process carried out by the three-dimensional moving track cost calculating unit 72;

FIG. 41 is a block diagram showing a person tracking device in accordance with Embodiment 4 of the present invention;

FIG. 42 is a flow chart showing a process carried out by the person tracking device in accordance with Embodiment 4 of the present invention;

FIG. 43 is a block diagram showing a person tracking device in accordance with Embodiment 5 of the present invention;

FIG. 44 is a flow chart showing a process carried out by the person tracking device in accordance with Embodiment 5 of the present invention; and

FIG. 45 is an explanatory drawing showing a person detecting method which a conventional person tracking device uses.

### EMBODIMENTS OF THE INVENTION

Hereafter, in order to explain this invention in greater detail, the preferred embodiments of the present invention will be described with reference to the accompanying drawings.

### Embodiment 1

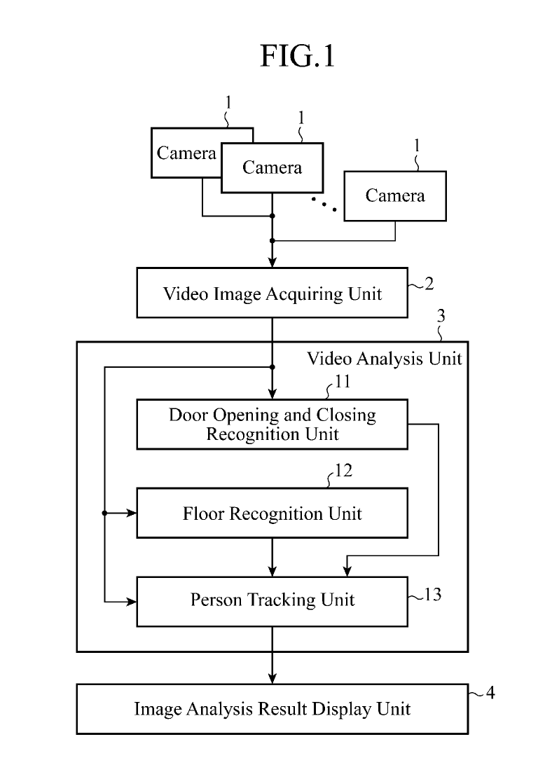

FIG. 1 is a block diagram showing a person tracking device in accordance with Embodiment 1 of the present invention. In FIG. 1, a plurality of cameras 1 which construct shooting units are installed at different positions of an upper portion in an elevator cage which is an area to be monitored, respectively, and simultaneously shoot the inside of the cage from different angles.

However, the type of each of the plurality of cameras 1 is not limited to a specific type. Each of the plurality of cameras 1 can be a general surveillance camera. As an alternative, each of the plurality of cameras 1 can be a visible camera, a high sensitivity camera capable of shooting up to a near infrared region, a far-infrared camera capable of shooting a heat source, or the like. As an alternative, infrared distance sensors, laser range finders or the like capable of measuring a distance can be substituted for such cameras.

A video image acquiring unit 2 is a video input interface for acquiring a video image of the inside of the elevator cage shot by each of the plurality of cameras 1, and carries out a process of outputting the video image of the inside of the elevator cage to a video analysis unit 3.

In this embodiment, it is assumed that the video image acquiring unit 2 outputs the video image of the inside of the elevator cage to the video analysis unit 3 in real time. The video image acquiring unit 2 can alternatively record the video image into a recorder, such as a hard disk prepared beforehand, and can output the video image to the video analysis unit 3 through an off-line process.

The video analysis unit 3 carries out a process of analyzing the video image the inside of the elevator cage outputted from the video image acquiring unit 2 to calculate a three-dimensional moving track of each individual person existing in the cage, and then calculating a person movement history showing the floor where each individual person has got on the elevator cage and the floor where each individual person has got off the elevator cage, and so on according to the three-dimensional moving track.

An image analysis result display unit 4 carries out a process of displaying the person movement history and so on which are calculated by the video analysis unit 3 on a display (not shown). The image analysis result display unit 4 constructs an image analysis result display unit.

A door opening and closing recognition unit 11 carries out a process of analyzing the video image of the inside of the elevator cage outputted from the video image acquiring unit 2 to specify the opening and closing times of the door of the elevator. The door opening and closing recognition unit 11 constructs a door opening and closing time specifying unit.

A floor recognition unit 12 carries out a process of analyzing the video image of the inside of the elevator cage outputted from the video image acquiring unit 2 to specify the floor where the elevator is located at each time. The floor recognition unit 12 constructs a floor specifying unit.

A person tracking unit 13 carries out a process of analyzing the video image of the inside of the elevator cage outputted from the video image acquiring unit 2 and then tracking each individual person existing in the cage to calculate a three-dimensional moving track of each individual person, and calculate a person movement history showing the floor where each individual person has got on the elevator cage and the floor where each individual person has got off the elevator cage, and so on according to the three-dimensional moving track.

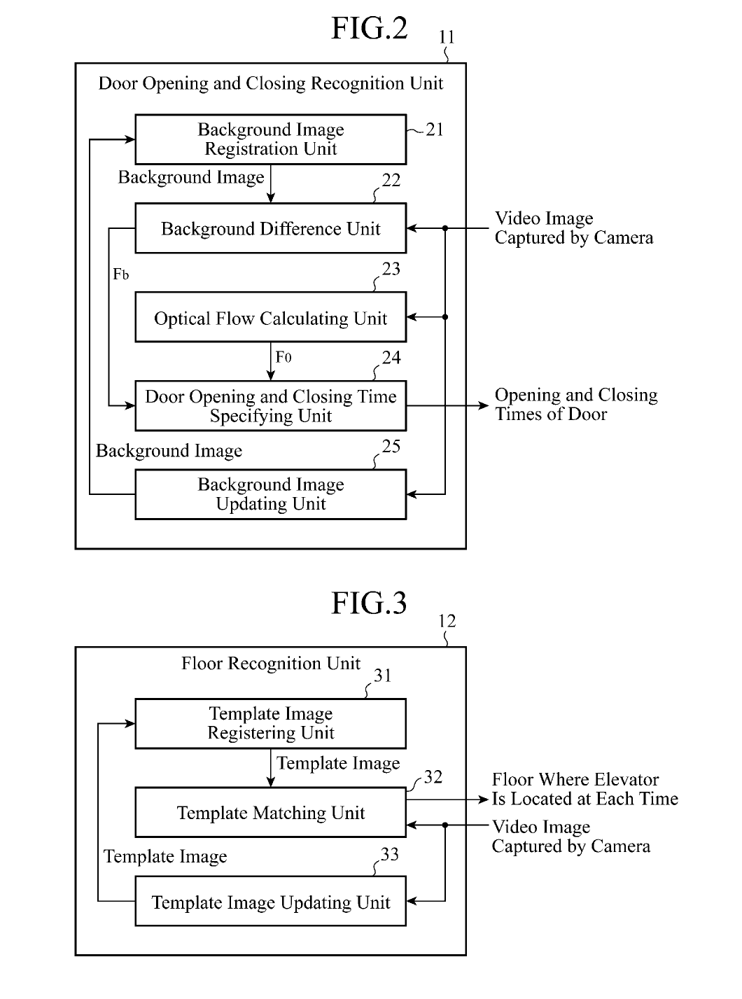

FIG. 2 is a block diagram showing the inside of the door opening and closing recognition unit 11 which constructs the video analysis unit 3.

In FIG. 2, a background image registration unit 21 carries out a process of registering, as a background image, an image of a door region in the elevator in a state in which the door is closed.

A background difference unit 22 carries out a process of calculating a difference between the background image registered by the background image registration unit 21 and a video image of the door region shot by a camera 1.

An optical flow calculating unit 23 carries out a process of calculating a motion vector showing the direction of the door's movement from a change of the video image of the door region shot by the camera 1.

A door opening and closing time specifying unit 24 carries out a process of determining an open or closed state of the door from the difference calculated by the background difference unit 22 and the motion vector calculated by the optical flow calculating unit 23 to specify an opening or closing time of the door.

A background image updating unit 25 carries out a process of updating the background image by using a video image of the door region shot by the camera 1.

FIG. 3 is a block diagram showing the inside of the floor recognition unit 12 which constructs the video analysis unit 3.

In FIG. 3, a template image registering unit 31 carries out a process of registering, as a template image, an image of an indicator showing the floor where the elevator is located.

A template matching unit 32 carries out a process of performing template matching between the template image registered by the template image registering unit 31 and a video image of an indicator region in the elevator shot by a camera 1 to specify the floor where the elevator is located at each time, or carries out a process of analyzing control base information about the elevator to specify the floor where the elevator is located at each time.

A template image updating unit 33 carries out a process of updating the template image by using a video image of the indicator region shot by the camera 1.

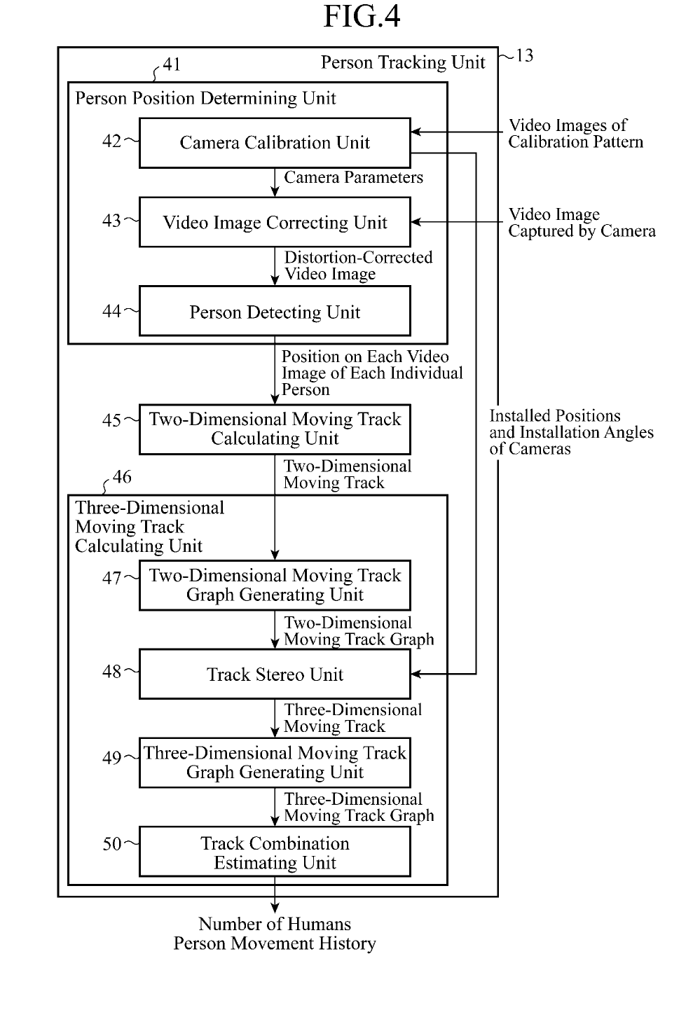

FIG. 4 is a block diagram showing the inside of the person tracking unit 13 which constructs the video analysis unit 3.

In FIG. 4, a person position determining unit 41 carries out a process of analyzing the video images of the inside of the elevator cage shot by the plurality of cameras 1 to calculate the position on each video image of each individual person existing in the cage. The person position determining unit 41 constructs a person position calculating unit.

A camera calibration unit 42 of the person position determining unit 41 carries out a process of analyzing a degree of distortion of each of video images of a calibration pattern which are shot in advance by the plurality of cameras 1 before the person tracking process is started to calculate camera parameters of the plurality of cameras 1 (parameters regarding a distortion of the lens of each camera, the focal length, optical axis and principal point of each camera).

The camera calibration unit 42 also carries out a process of determining the installed positions and installation angles of the plurality of cameras 1 with respect to a reference point in the elevator cage by using both the video images of the calibration pattern shot by the plurality of cameras 1 and the camera parameters of the plurality of cameras 1.

A video image correcting unit 43 of the person position determining unit 41 carries out a process of correcting a distortion of the video image of the elevator cage shot by each of the plurality of cameras 1 by using the camera parameters calculated by the camera calibration unit 42.

A person detecting unit 44 of the person position determining unit 41 carries out a process of detecting each individual person in each video image in which the distortion has been corrected by the video image correcting unit 43 to calculate the position on each video image of each individual person.

A two-dimensional moving track calculating unit 45 carries out a process of calculating a two-dimensional moving track of each individual person in each video image by tracking the position of each individual person on each video image calculated by the person detecting unit 44. The two-dimensional moving track calculating unit 45 constructs a two-dimensional moving track calculating unit.

A three-dimensional moving track calculating unit 46 carries out a process of performing stereo matching between each two-dimensional moving track in each video image and a two-dimensional moving track in another video image, the two-dimensional moving tracks being calculated by the two dimensional moving track calculating unit 45, to calculate the degree of match between them and then calculate a three-dimensional moving track of each individual person from the corresponding two-dimensional moving tracks each having a degree of match equal to or larger than a specified value, and also determining a person movement history showing the floor where each individual person has got on the elevator cage and the floor where each individual person has got off the elevator cage by bringing the three-dimensional moving track of each individual person into correspondence with the floors specified by the floor recognition unit 12. The three-dimensional moving track calculating unit 46 constructs a three-dimensional moving track calculating unit.

A two-dimensional moving track graph generating unit 47 of the three-dimensional moving track calculating unit 46 carries out a process of performing a dividing process and a connecting process on two-dimensional moving tracks calculated by the two-dimensional moving track calculating unit 45 to generate a two-dimensional moving track graph.

A track stereo unit 48 of the three-dimensional moving track calculating unit 46 carries out a process of searching through the two-dimensional moving track graph generated by the two-dimensional moving track graph generating unit 47 to determine a plurality of two-dimensional moving track candidates, carrying out stereo matching between each two-dimensional moving track candidate in each video image and a two-dimensional moving track candidate in another video image by taking into consideration the installed positions and installation angles of the plurality of cameras 1 with respect to the reference point in the cage which are calculated by the camera calibration unit 42 to calculate the degree of match between the candidates, and then calculating a three-dimensional moving track of each individual person from the corresponding two-dimensional moving track candidates each having a degree of match equal to or larger than a specified value.

A three-dimensional moving track graph generating unit 49 of the three-dimensional moving track calculating unit 46 carries out a process of performing a dividing processing and a connecting process on three-dimensional moving tracks calculated by the track stereo unit 48 to generate a three-dimensional moving track graph.

A track combination estimating unit 50 of the three-dimensional moving track calculating unit 46 carries out a process of searching through the three-dimensional moving track graph generated by the three-dimensional moving track graph generating unit 49 to determine a plurality of three-dimensional moving track candidates, selecting optimal three-dimensional moving tracks from among the plurality of three-dimensional moving track candidates to estimate the number of persons existing in the cage, and also calculating a person movement history showing the floor where each individual person has got on the elevator cage and the floor where each individual person has got off the elevator cage by bringing the optimal three-dimensional moving track of each individual person into correspondence with the floors specified by the floor recognition unit 12.

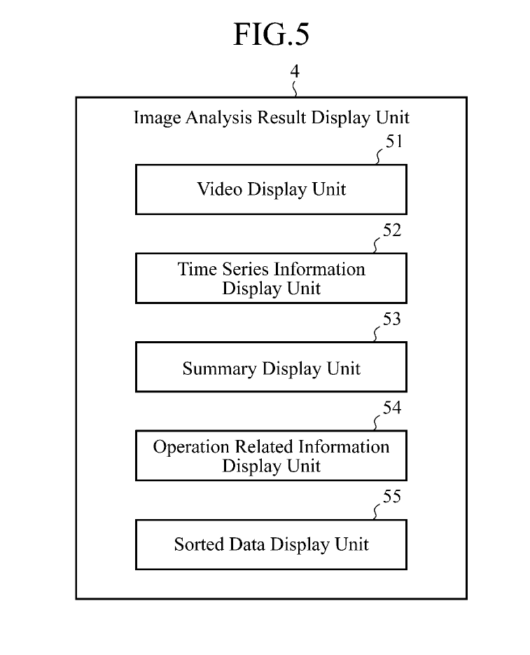

FIG. 5 is a block diagram showing the inside of the image analysis result display unit 4 which constructs the video analysis unit 3.

In FIG. 5, a video display unit 51 carries out a process of displaying the video image of the inside of the elevator cage shot by each of the plurality of cameras 1.

A time series information display unit 52 carries out a process of performing graphical representation of person movement histories calculated by the three-dimensional moving track calculating unit 46 of the person tracking unit 13 in time series.

A summary display unit 53 carries out a process of calculating statistics on the person movement histories calculated by the three-dimensional moving track calculating unit 46 to display the statistic results of the person movement histories.

An operation related information display unit 54 carries out a process of displaying information about the operation of the elevator with reference to the person movement histories calculated by the three-dimensional moving track calculating unit 46.

A sorted data display unit 55 carries out a process of sorting and displaying the person movement histories calculated by the three-dimensional moving track calculating unit 46.

In FIG. 1, it is assumed that each of the video image acquiring unit 2, the video analysis unit 3, and the image analysis result display unit 4, which are components of the person tracking device, consists of hardware for exclusive use (e.g., a semiconductor integrated circuit substrate on which a CPU is mounted). In a case in which the person tracking device is constructed of a computer, a person tracking program in which the processes carried out by the video image acquiring unit 2, the video analysis unit 3 and the image analysis result display unit 4 are described can be stored in a memory of the computer, and the CPU of the computer can execute the person tracking program stored in the memory.

Next, the operation of the person tracking device will be explained.

First, an outline of the operation of the person tracking device of FIG. 1 will be explained.

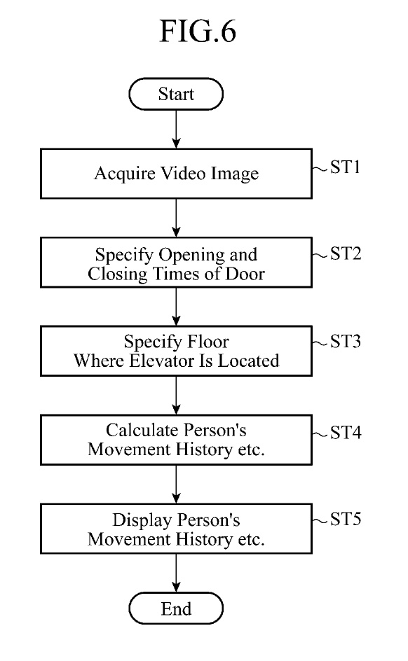

FIG. 6 is a flow chart showing processing carried out by the person tracking device in accordance with Embodiment 1 of the present invention.

When the plurality of cameras 1 start capturing video images of the inside of the elevator cage, the video image acquiring unit 2 acquires the video images of the inside of the elevator cage from the plurality of cameras 1 and outputs each of the video images to the video analysis unit 3 (step ST1).

When receiving each of the video images captured by the plurality of cameras 1 from the video image acquiring unit 2, the door opening and closing recognition unit 11 of the video analysis unit 3 analyzes each of the video images to specify the opening and closing times of the door of the elevator (step ST2).

More specifically, the door opening and closing recognition unit 11 analyzes each of the video images to specify the time when the door of the elevator is open and the time when the door is closed.

When receiving the video images captured by the plurality of cameras 1 from the video image acquiring unit 2, the floor recognition unit 12 of the video analysis unit 3 analyzes each of the video images to specify the floor where the elevator is located (i.e., the stopping floor of the elevator) at each time (step ST3).

When receiving the video images captured by the plurality of cameras 1 from the video image acquiring unit 2, the person tracking unit 13 of the video analysis unit 3 analyzes each of the video images to detect each individual person existing in the cage.

The person tracking unit 13 then refers to the result of the detection of each individual person and the opening and closing times of the door specified by the door opening and closing recognition unit 11 and tracks each individual person existing in the cage to calculate a three-dimensional moving track of each individual person.

The person tracking unit 13 also calculates a person movement history showing the floor where each individual person has got on the elevator and the floor where each individual person has got off the elevator by bringing the three-dimensional moving track of each individual person into correspondence with the floors specified by the floor recognition unit 12 (step ST4).

The image analysis result display unit 4 displays the person movement history on the display after the video analysis unit 3 calculates the person movement history and so on (step ST5).

Next, the process carried out by the video analysis unit 3 in the person tracking device of FIG. 1 will be explained in detail.

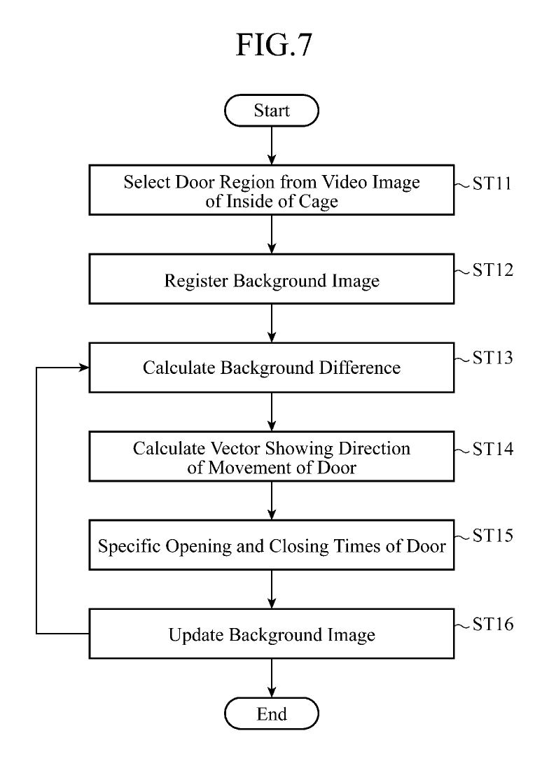

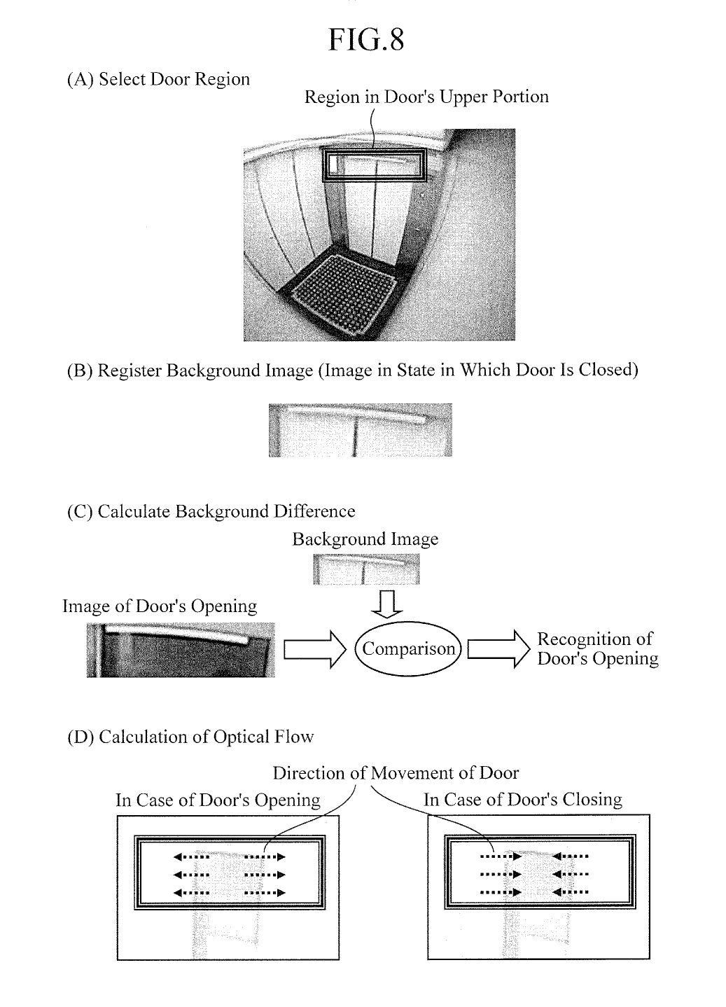

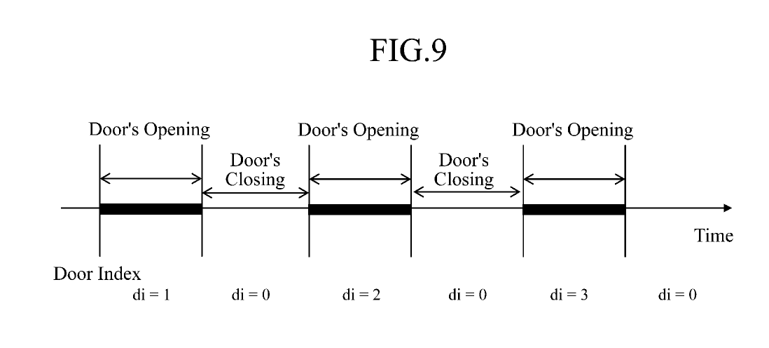

FIG. 7 is a flow chart showing the process carried out by the door opening and closing recognition unit 11. FIG. 8 is an explanatory drawing showing the process carried out by the door opening and closing recognition unit 11, and FIG. 9 is an explanatory drawing showing a door index of the door opening and closing recognition unit 11.

First, the door opening and closing recognition unit 11 selects a door region in which the door is shot from one of the video images of the elevator cage shot by the plurality of cameras 1 (step ST11).

In the example of FIG. 8(A), a region including an upper portion of the door is selected as the door region.

The background image registration unit 21 of the door opening and closing recognition unit 11 acquires an image of the door region in the elevator in a state where the door is closed (e.g., a video image captured by one camera 1 when the door is closed: refer to FIG. 8(B)), and registers the image as a background image (step ST12).

After the background image registration unit 21 registers the background image, the background difference unit 22 of the door opening and closing recognition unit 11 receives the video image captured by the camera 1 which varies from moment to moment from the video image acquiring unit 2 and calculates the difference between the video image of the door region in the video image captured by the camera 1 and the above-mentioned background image in such a way as shown in FIG. 8(C) (step ST13).

When calculating the difference between the video image of the door region and the background image, and determining that the difference is large (e.g., when the difference is larger than a predetermined threshold and the video image of the door region greatly differs from the background image), the background difference unit 22 sets a flag Fb for door opening and closing determination to “1” because there is a high possibility that the door is open.

In contrast, when determining that the difference is small (e.g., when the difference is smaller than the predetermined threshold and the video image of the door region hardly differs from the background image), the background difference unit 22 sets the flag Fb for door opening and closing determination to “0” because there is a high possibility that the door is closed.

The optical flow calculating unit 23 of the door opening and closing recognition unit 11 receives the video image captured by the camera 1 which varies from moment to moment from the video image acquiring unit 2, and calculates a motion vector showing the direction of movement of the door from a change of the video image (two continuous image frames) of the door region in the video image captured by the camera 1 (step ST14).

For example, in a case in which the door of the elevator is a central one, as shown in FIG. 8(D), when the direction of movement of the door shown by the motion vector is an outward one, the optical flow calculating unit 23 sets a flag Fo for door opening and closing determination to “1” because there is a high possibility that the door is opening.

In contrast, when the direction of movement of the door shown by the motion vector is an inward one, the optical flow calculating unit 23 sets the flag Fo for door opening and closing determination to “0” because there is a high possibility that the door is closing.

Because the motion vector does not show any direction of movement of the door when the door of the elevator is not moving (when a state in which the door is open or closed is maintained), the optical flow calculating unit sets the flag Fo for door opening and closing determination to “2”.

After the background difference unit 22 sets the flag Fb for door opening and closing determination and the optical flow calculating unit 23 sets the flag Fo for door opening and closing determination, the door opening and closing time specifying unit 24 of the door opening and closing recognition unit 11 determines the open or closed state of the door with reference to those flags Fb and Fo to specify the opening and closing times of the door (step ST15).

More specifically, the door opening and closing time specifying unit 24 determines that the door is closed during a time period during which both the flag Fb and the flag Fo are “0” and during a time period during which the flag Fb is “0” and the flag Fo is “2”, and also determines that the door is open during a time period during which at least one of the flag Fb and the flag Fo is “1”.

In addition, the door opening and closing time specifying unit 24 sets the door index di of each time period during which the door is closed to “0”, as shown in FIG. 9, and also sets the door index di of each time period during which the door is open to 1, 2, 3, . . . in the order of occurrence of the door open state from the start of the video image.

The background image updating unit 25 of the door opening and closing recognition unit 11 receives the video image of the camera 1 which varies from moment to moment from the video image acquiring unit 2, and updates the background image registered into the background image registration unit 21 (i.e., the background image which the background difference unit 22 uses at the next time) by using the video image of the door region in the video image captured by the camera 1 (step ST16).

As a result, even when a video image of a region in the vicinity of the door varies due to an illumination change, for example, the person tracking device can carry out the background difference process adaptively according to the change.

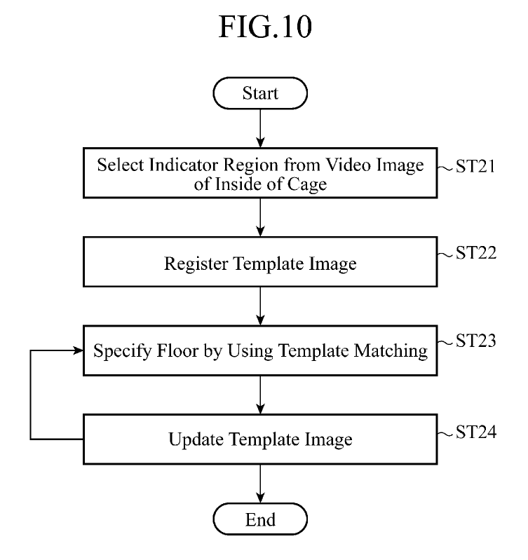

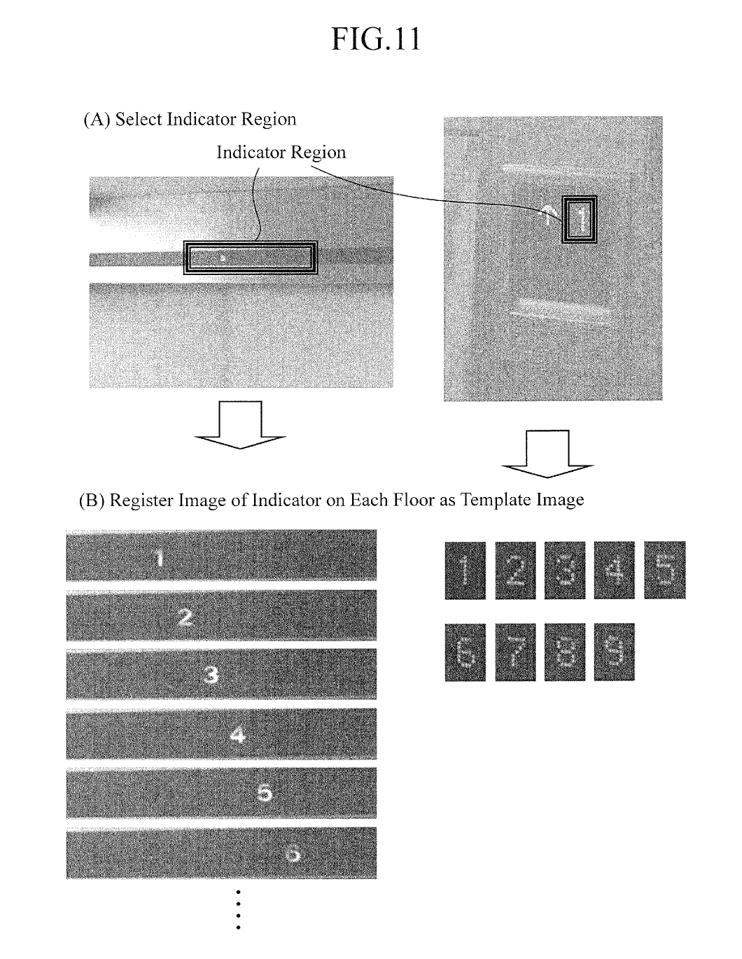

FIG. 10 is a flow chart showing the process carried out by the floor recognition unit 12, and FIG. 11 is an explanatory drawing showing the process carried out by the floor recognition unit 12.

First, the floor recognition unit 12 selects an indicator region in which the indicator showing the floor where the elevator is located is shot from one of the video images of the inside of the elevator cage shot by the plurality of cameras 1 (step ST21).

In an example of FIG. 11(A), the floor recognition unit selects a region where the numbers of the indicator are displayed as the indicator region.

The template image registering unit 31 of the floor recognition unit 12 registers an image of each of the numbers showing the corresponding floor in the selected indicator region as a template image (step ST22).

For example, in a case in which the elevator moves from the first floor to the ninth floor, the template image registering unit successively registers number images (“1”, “2”, “3”, “4”, “5”, “6”, “7”, “8”, and “9”) of the numbers respectively showing the floors as template images, as shown in FIG. 11(B).

After the template image registering unit 31 registers the template images, the template matching unit 32 of the floor recognition unit 12 receives the video image captured by the camera 1 which varies from moment to moment from the video image acquiring unit 2, and carries out template matching between the video image of the indicator region in the video image captured by the camera 1 and the above-mentioned template images to specify the floor where the elevator is located at each time (step ST23).

Because an existing normalized cross correlation method or the like can be used as a method of carrying out the template matching, a detailed explanation of this method will be omitted hereafter.

The template image updating unit 33 of the floor recognition unit 12 receives the video image captured by the camera 1 which varies from moment to moment from the video image acquiring unit 2, and uses a video image of the indicator region in the video image captured by the camera 1 to update the template images registered in the template image registering unit 31 (i.e., the template images which the template matching unit 32 uses at the next time) (step ST24).

As a result, even when a video image of a region in the vicinity of the indicator varies due to an illumination change, for example, the person tracking device can carry out the template matching process adaptively according to the change.

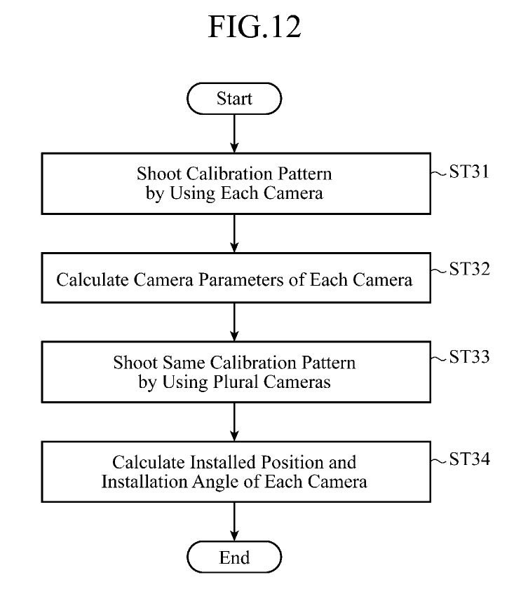

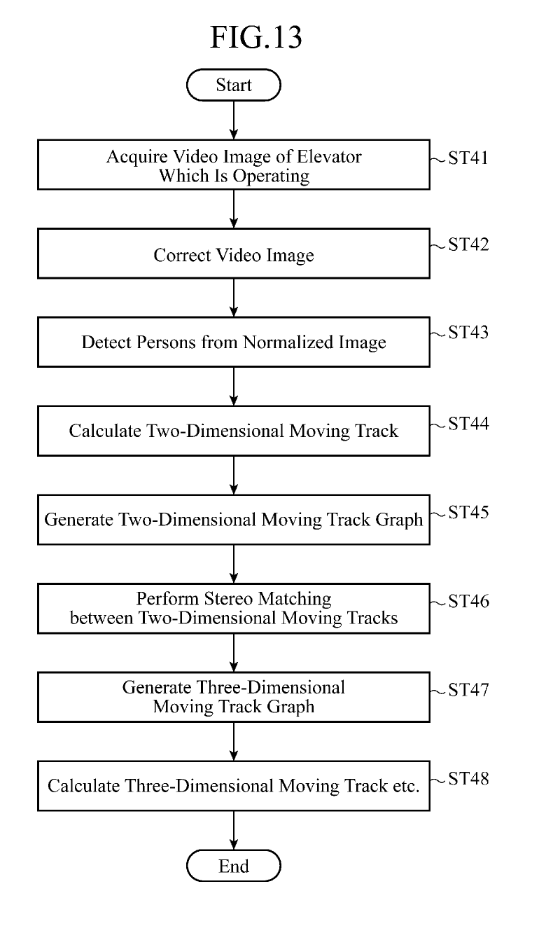

FIG. 12 is a flow chart showing pre-processing carried out by the person tracking unit 13, and FIG. 13 is a flow chart showing post-processing carried out by the person tracking unit 13.

First, each of the cameras 1 shoots the calibration pattern before the camera calibration unit 42 of the person tracking unit 13 determines the camera parameters of each of the cameras 1 (step ST31).

The video image acquiring unit 2 acquires the video image of the calibration pattern captured by each of the cameras 1, and outputs the video image of the calibration pattern to the camera calibration unit 42.

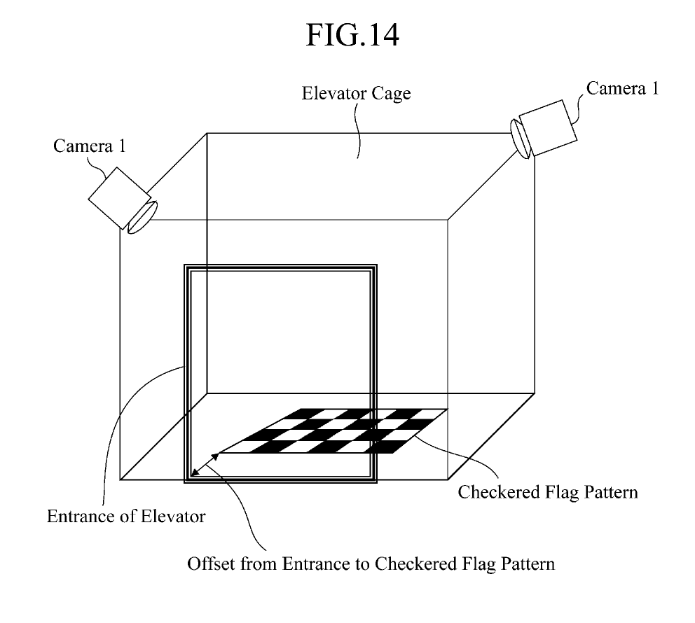

As the calibration pattern used in this embodiment, a black and white checkered flag pattern having a known size (refer to FIG. 14) can be used, for example.

The calibration pattern is shot by the plurality of camera 1 at about 1 to 20 different positions and at about 1 to 20 different angles.

When receiving the video image of the calibration pattern captured by each of the cameras 1 from the video image acquiring unit 2, the camera calibration unit 42 analyzes the degree of distortion of the video image of the calibration pattern to determine the camera parameters of each of the cameras 1 (e.g., the parameters regarding a distortion of the lens of each camera, the focal length, optical axis and principal point of each camera) (step ST32).

Because the method of determining the camera parameters is a well-known technology, a detailed explanation of the method will be omitted hereafter.

Next, when the camera calibration unit 42 determines the installed positions and installation angles of the plurality of cameras 1, the plurality of cameras 1 shoot the identical calibration pattern having a known size simultaneously after the plurality of cameras 1 are installed in an upper portion in the elevator cage (step ST33).

For example, as shown in FIG. 14, a checkered flag pattern is laid out on the floor of the elevator cage as the calibration pattern, and the person tracking device shoots the checkered flag pattern simultaneously by using the plurality of cameras 1.

At that time, the position and angle of the calibration pattern laid out on the floor of the cage with respect to a reference point in the cage (e.g., the entrance of the cage) are measured as an offset, and the inside dimension of the cage is also measured.

In the example of FIG. 14, a checkered flag pattern laid out on the floor of the cage is used as the calibration pattern, and this embodiment is not limited to this example. For example, a pattern which is drawn directly on the floor of the cage can be used as the calibration pattern. In this case, the size of the pattern which is drawn on the floor is measured in advance.

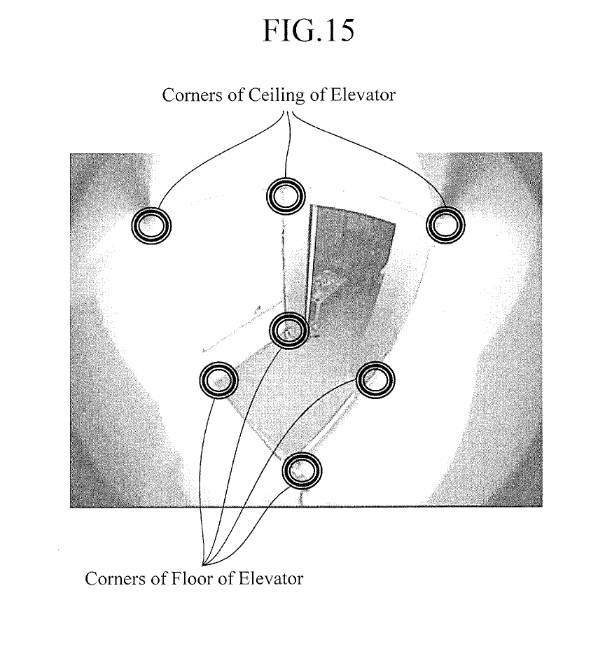

As an alternative, as shown in FIG. 15, the inside of the cage can be shot, and the four corners of the floor of the cage and three corners of the ceiling can be selected as the calibration pattern. In this case, the inside dimension of the cage is measured in advance.

When receiving the video images of the calibration pattern captured by the plurality of cameras 1 from the video image acquiring unit 2, the camera calibration unit 42 calculates the installed positions and installation angles of the plurality of cameras 1 with respect to the reference point in the elevator cage by using both the video images of the calibration pattern and the camera parameters of the plurality of cameras 1 (step ST34).

More specifically, when a black and white checkered flag pattern is used as the calibration pattern, for example, the camera calibration unit 42 calculates the relative positions and relative angles of the plurality of cameras 1 with respect to the checker pattern shot by the plurality of cameras 1.

By then adding the offset of the checkered pattern which is measured beforehand (the position and angle of the checkered pattern with respect to the entrance of the cage which is the reference point in the cage) to the relative position and relative angle of each of the plurality of cameras 1, the camera calibration unit calculates the installed positions and installation angles of the plurality of cameras 1 with respect to the reference point in the cage.

In contrast, when the four corners of the floor of the cage and three corners of the ceiling are used as the calibration pattern, as shown in FIG. 15, the camera calibration unit calculates the installed positions and installation angles of the plurality of cameras 1 with respect to the reference point in the cage from the inside dimension of the cage which is measured in advance.

In this case, it is possible to automatically determine the installed position and installation angle of each camera 1 by simply installing the camera 1 in the cage.

When the person tracking unit 13 carries out a detecting process of detecting a person, an analysis process of analyzing a moving track, or the like, the plurality of cameras 1 repeatedly shoot an area in the elevator cage which is actually operating.

The video image acquiring unit 2 acquires the plurality of video images of the inside of the elevator cage shot by the plurality of cameras 1 from moment to moment (step ST41).

Every time when acquiring the plurality of video images captured by the plurality of cameras 1 from the video image acquiring unit 2, the video image correcting unit 43 of the person tracking unit 13 corrects a distortion in each of the plurality of video images by using the camera parameters calculated by the camera calibration unit 42 to generate a normalized image which is a distortion-free video image (step ST42).

Because the method of correcting a distortion in each of the plurality of video images is a well-known technology, a detailed explanation of the method will be omitted hereafter.

After the video image correcting unit 43 generates the normalized images from the video images captured by the plurality of cameras 1, the person detecting unit 44 of the person tracking unit 13 detects, as a person, appearance features of each human body which exists in each normalized image to calculate the position (image coordinates) of the person on each normalized image and also calculate the person's degree of certainty (step ST43).

The person detecting unit 44 then performs a camera perspective filter on the person's image coordinates to delete the person detection result if the person detection result has an improper size.

For example, when the person detecting unit 44 detects the head (one appearance feature) of each human body, the image coordinates of the person show the coordinates of the center of a rectangle surrounding a region including the head.

Furthermore, the degree of certainty is an index showing how much similarity there is between the corresponding object detected by the person detecting unit 44 and a human being (a human head). The higher degree of certainty the object has, the higher probability that the object is a human being while the lower degree of certainty the object has, the lower probability that the object is a human being.

Hereafter, the process of detecting a person which is carried out by the person detecting unit 44 will be explained concretely.

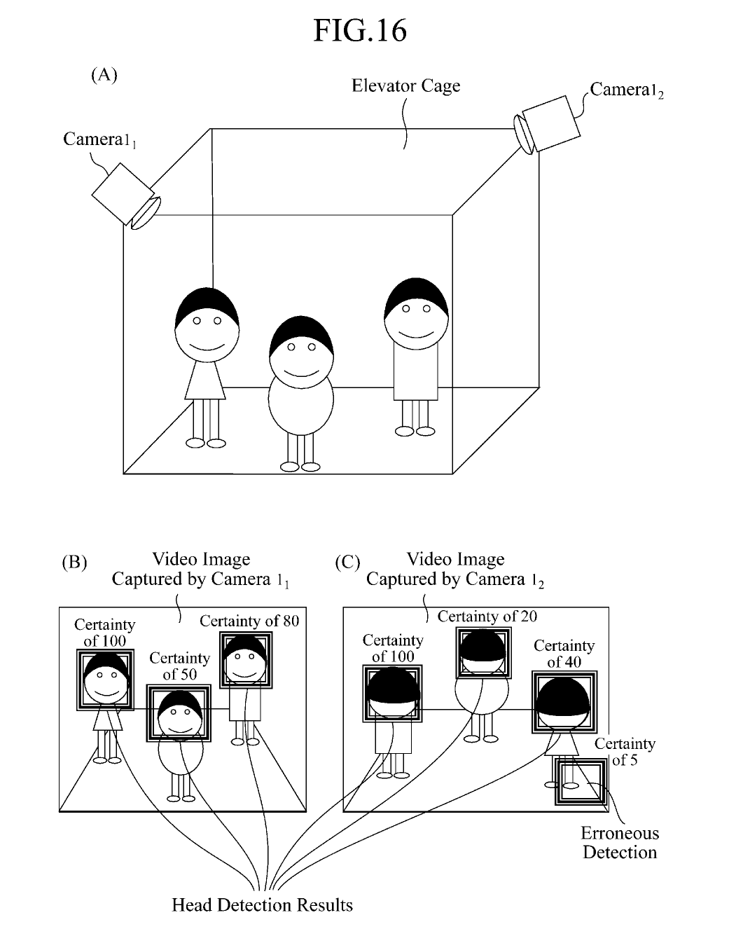

FIG. 16 is an explanatory drawing showing the process of detecting a human head.

FIG. 16(A) shows a situation in which three passengers (persons) in the cage are shot by two cameras 1₁ and 1₂ installed at diagonal positions of the ceiling in the cage.

FIG. 16(B) shows a state in which their heads are detected from video images of their faces captured by the camera 1₁, and a degree of certainty is attached to the region of each of their heads which are the detection results.

FIG. 16(C) shows a state in which their heads are detected from video images of the backs of their heads captured by the camera 1₂, and a degree of certainty is attached to the region of each of their heads which are the detection results.

In the case of FIG. 16(C), a passenger's (person's) leg in the far-right portion in the figure is erroneously detected, and the degree of certainty of the erroneously detected portion is calculated to be a low value.

In this case, as the detecting method of detecting a head, a face detection method disclosed by the following reference 1 can be used.

More specifically, Haar-basis-like patterns which are called “Rectangle Features” are selected by using Adaboost and many weak classifiers are acquired, so that the sum of the outputs of these weak classifiers and a proper threshold can be used as the degree of certainty.

Furthermore, a road sign detecting method disclosed by the following reference 2 can be applied as the detecting method of detecting ahead so that the image coordinates and the degree of certainty of each detected head can be calculated.

In the case of FIG. 16, when detecting each person, the person detecting unit 44 detects each person's head which is an appearance feature of a human body. This case is only an example, and the person detecting unit 44 can alternatively detect each person's shoulder, body or the like, for example.

### REFERENCE 1

Viola, P., Jones, M., “Rapid Object Detection Using a Boosted Cascade of Simple Features”, IEEE Computer Society Conference on Computer Vision and Pattern Recognition (CVPR), ISSN: 1063-6919, Vol. 1, pp. 511-518, December 2001

### REFERENCE 2

Shinya Taguchi, Junshiro Kanda, Yoshihiro Shima, Jun-ichi Takiguchi, “Accurate Image Recognition From a Small Number of Samples Using Correlation Matrix of Feature Vector: Application to Traffic Sign Recognition”, The Institute of Electronics, Information and Communication Engineers Technical Research Report IE, Image engineering, Vol. 106, No. 537 (20070216), pp. 55-60, IE2006-270

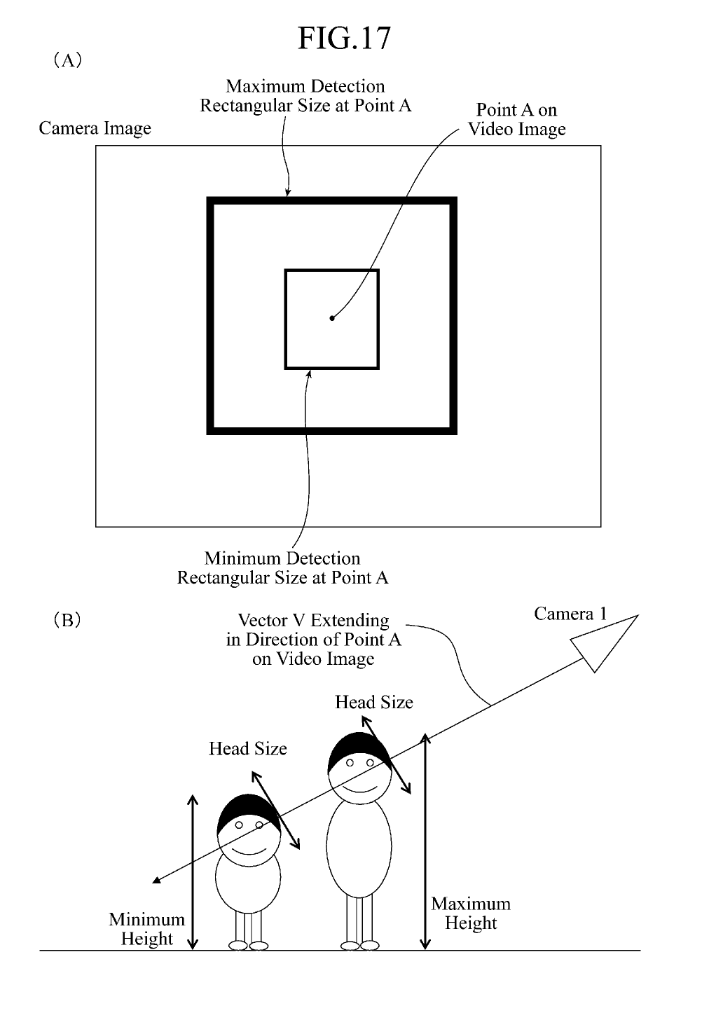

FIG. 17 is an explanatory drawing showing the camera perspective filter.

As shown in FIG. 17(A), the camera perspective filter assumes a detection result having a size larger than a maximum rectangular head size at a point A and a detection result having a size smaller than a minimum rectangular head size at the point A, among the person detection results at the point A on the video image, as erroneous detection results, and deletes these detection results.

FIG. 17(B) shows how to determine the maximum detection rectangular head size at the point A and the minimum detection rectangular head size at the point A.

First, the person detecting unit 44 determines a direction vector V passing through both the point A on a video image captured by a camera 1 and the center of the camera 1.

The person detecting unit 44 then sets up a maximum height (e.g., 200 cm), a minimum height (e.g., 100 cm), and a typical head size (e.g., 30 cm) of persons which can be assumed to get on the elevator.

Next, the person detecting unit 44 projects the head of a person having the maximum height onto the camera 1, and defines the size of a rectangle on the image surrounding the projected head as the maximum detection rectangular head size at the point A.

Similarly, the person detecting unit 44 projects the head of a person having the minimum height onto the camera 1, and defines the size of a rectangle on the image surrounding the projected head as the minimum detection rectangular head size at the point A.

After defining both the maximum detection rectangular head size at the point A and the minimum detection rectangular head size at the point A, the person detecting unit 44 compares each person's detection result at the point A with the maximum detection rectangular head size and the minimum detection rectangular head size. When each person's detection result at the point A is larger than the maximum rectangular head size or is smaller than the minimum rectangular head size, the person detecting unit 44 determines the detection result as an erroneous detection and deletes this detection result.

Every time when the person detecting unit 44 calculates the image coordinates of each individual person by detecting each individual person from each normalized image (image frames) which is generated from moment to moment by the video image correcting unit 43, the two-dimensional moving track calculating unit 45 determines a sequence of points each shown by the image coordinates to calculate a two-dimensional moving track of each individual person which is moving along the sequence of points (step ST44).

Hereafter, the process of determining a two-dimensional moving track which is carried out by the two-dimensional moving track calculating unit 45 will be explained concretely.

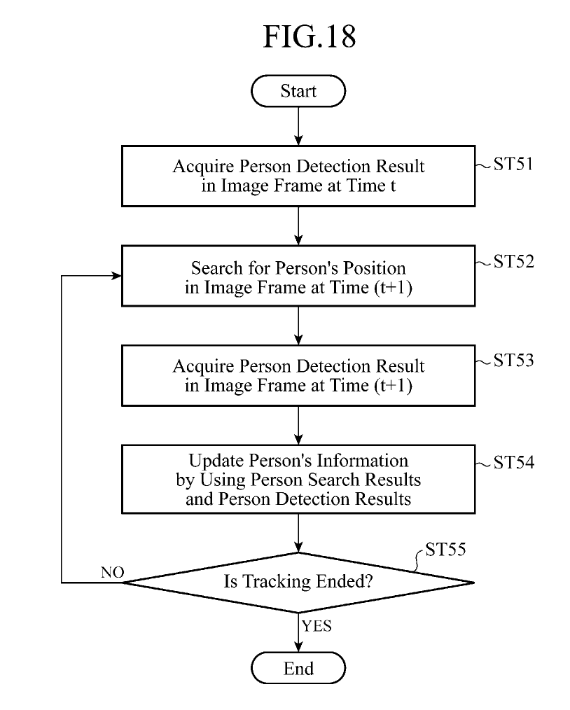

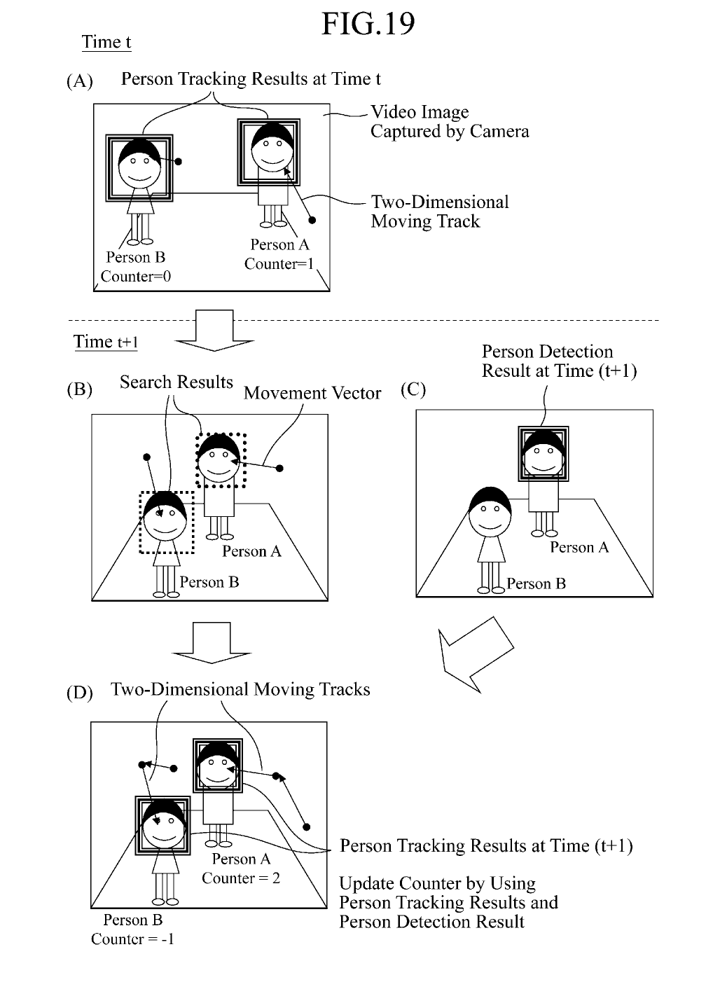

FIG. 18 is a flow chart showing the determining process carried out by the two-dimensional moving track calculating unit 45, and FIG. 19 is an explanatory drawing showing the process carried out by the two-dimensional moving track calculating unit 45.

First, the two-dimensional moving track calculating unit 45 acquires the person detection results (the image coordinates of persons) in the image frame at a time t which are determined by the person detecting unit 44, and assigns a counter to each of the person detection results (step ST51).

For example, as shown in FIG. 19(A), when starting tracking each person from the time t, the two-dimensional moving track calculating unit acquires the person detection results in the image frame at the time t.

In this case, the two-dimensional moving track calculating unit assigns a counter to each of the person detection results, and initializes the value of the counter to “0” when starting tracking each person.

Next, the two-dimensional moving track calculating unit 45 uses each person detection result in the image frame at the time t as a template image to search for the image coordinates of the corresponding person in the image frame at the next time t+1 shown in FIG. 19(B) (step ST52).

In this case, as a method of searching for the image coordinates of the person, a normalized cross correlation method which is a known technology, or the like can be used, for example.

In the case, the two-dimensional moving track calculating unit uses an image of a person region at the time t as a template image to determine the image coordinates of a rectangular region having the highest correlation value at the time (t+1) with those at the time t by using the normalized cross correlation method, and output the image coordinates.

As another method of searching for the image coordinates of the person, a correlation coefficient of a feature described in above-mentioned reference 2 can be used, for example.

In this case, a correlation coefficient of a feature in each of a plurality of subregions included in each person region at the time t is calculated, and a vector having the correlation coefficients as its components is defined as a template vector of the corresponding person. Then, a region whose distance to the template vector is minimized at the next time (t+1) is searched for, and the image coordinates of the region are outputted as the search result about the person.

In addition, as another method of searching for the image coordinates of the person, a method using a distributed covariance matrix of a feature described in the following reference 3 can be used. By using this method, person tracking can be carries out to determine the person's image coordinates from moment to moment.

### REFERENCE 3

Porikli, F. Tuzel, O. Meer, P., “Covariance Tracking using Model Update Based on Lie Algebra”, Computer Vision and Pattern Recognition 2006, Volume 1, 17-22, June 2006, pp. 728-735

Next, the two-dimensional moving track calculating unit 45 acquires the person detection results (each person's image coordinates) in the image frame at the time t+1 which are calculated by the person detecting unit 44 (step ST53).

For example, the two-dimensional moving track calculating unit acquires the person detection results as shown in FIG. 19(C). It is assumed that these person detection results show a state in which the person A is detected, but the person B is not detected.

Next, the two-dimensional moving track calculating unit 45 updates each person's information which the person tracking device is tracking by using both the person image coordinates calculated in step ST52 and the person image coordinates acquired in step ST53 (step ST54).

For example, as shown in FIG. 19(B), the result of person detection of the person A as shown in FIG. 19(C) exists around the result of searching for the person A at the time (t+1). Therefore, as shown in FIG. 19(D), the two-dimensional moving track calculating unit raises the value of the counter for the person A from “1” to “2”.

In contrast, when the person detecting unit has failed in person detection of the person B at the time (t+1), as shown in FIG. 19(C), no result of person detection of the person B exists around the result of searching for the person B shown in FIG. 19(B). Therefore, as shown in FIG. 19(D), the two-dimensional moving track calculating unit drops the value of the counter for the person B from “0” to “−1”.

Thus, when a detection result exists around the search result, the two-dimensional moving track calculating unit 45 increments the value of the counter by one, whereas when no detection result exists around the search result, the two-dimensional moving track calculating unit decrements the value of the counter by one.

As a result, the value of the counter becomes large as the number of times that the person is detected increases, while the value of the counter becomes small as the number of times that the person is detected decreases.

Furthermore, the two-dimensional moving track calculating unit 45 can accumulate the degree of certainty of each person detection in step ST54.

For example, when a detection result exists around the search result, the two-dimensional moving track calculating unit 45 accumulates the degree of certainty of the corresponding person detection result, whereas when no detection result exists around the search result, the two-dimensional moving track calculating unit 45 does not accumulate the degree of certainty of the corresponding person detection result. As a result, the larger number of times that the person is detected, the higher degree of accumulated certainty the corresponding two-dimensional moving track has.

The two-dimensional moving track calculating unit 45 then determines whether or not to end the tracking process (step ST55).

As a criterion by which to determine whether or not to end the tracking process, the value of the counter described in step ST54 can be used.

For example, when the value of the counter determined in step ST54 is lower than a fixed threshold, the two-dimensional moving track calculating unit determines that the object is not a person and then ends the tracking.

As an alternative, by carrying out a process of comparing the degree of accumulated certainty described in step ST54 with a predetermined threshold, as a criterion by which to determine whether or not to end the tracking process, the two-dimensional moving track calculating unit can determine whether or not to end the tracking process.

For example, when the degree of accumulated certainty is lower than the predetermined threshold, the two-dimensional moving track calculating unit determines that the object is not a person and then ends the tracking.

Thus, by thus determining whether or not to end the tracking process, the person tracking device can prevent itself from erroneous tracking anything which is not a human being.

By repeatedly performing the image template matching process in steps ST52 to ST55 on frame images from which persons who have entered the elevator from moment to moment are detected, the two-dimensional moving track calculating unit 45 can express each of the persons as a sequence of image coordinates of each person moving, i.e., as a sequence of points. The two-dimensional moving track calculating unit calculates this sequence of points as a two-dimensional moving track of each person moving.

In this case, when the tracking of a person is ended on the way due to shading or the like, the person tracking device can simply restart tracking the person after the shading or the like is removed.

In this Embodiment 1, the two-dimensional moving track calculating unit 45 tracks each person's image coordinates calculated by the person detecting unit 44 in the forward direction of time (the direction from the present to the future), as mentioned above. The two-dimensional moving track calculating unit 45 can further track each person's image coordinates in the backward direction of time (the direction from the present to the past), and can calculate two-dimensional moving tracks of each person along the backward direction of time and along the forward direction of time.

By thus tracking each person's image coordinates in the backward direction of time and in the forward direction of time, the person tracking device can calculate each person's two-dimensional moving track while reducing the risk of missing each person's two-dimensional moving track as much as possible. For example, even when failing in the tracking of a person in the forward direction of time, the person tracking device can eliminate the risk of missing the person's two-dimensional moving track as long as it succeeds in tracking the person in the backward direction of time.

After the two-dimensional moving track calculating unit 45 calculates the two-dimensional moving tracks of each individual person, the two-dimensional moving track graph generating unit 47 performs a dividing process and a connecting process on the two-dimensional moving tracks of each individual person to generate a two-dimensional moving track graph (step ST45 of FIG. 13).

More specifically, the two-dimensional moving track graph generating unit 47 searches through the set of two-dimensional moving tracks of each individual person calculated by the two-dimensional moving track calculating unit 45 for two-dimensional moving tracks close to one another with respect to space or time, and then performs processes, such as division and connection, on them to generate a two-dimensional moving track graph having the two-dimensional moving tracks as vertices of the graph, and having connected two-dimensional moving tracks as directed sides of the graph.

Hereafter, the process carried out by the two-dimensional moving track graph generating unit 47 will be explained concretely.

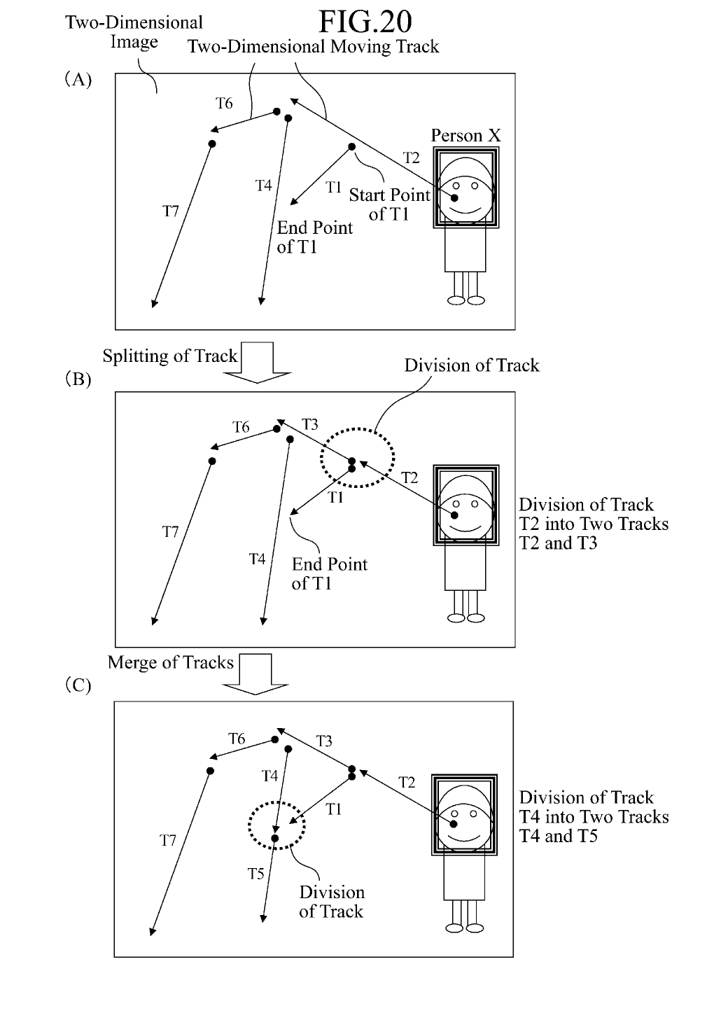

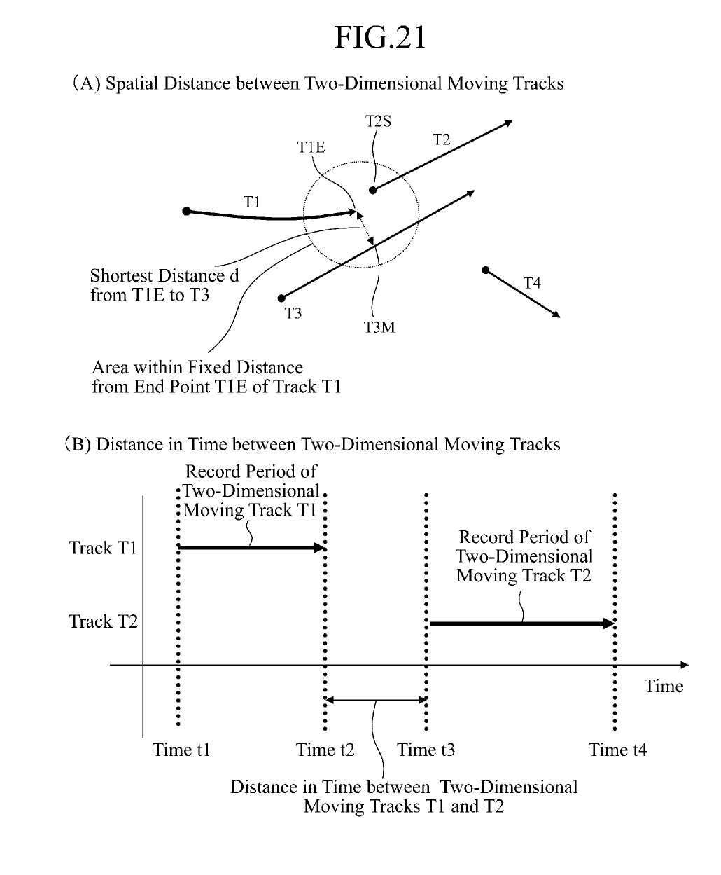

FIGS. 20 and 21 are explanatory drawings showing the process carried out by the two-dimensional moving track graph generating unit 47.

First, an example of two-dimensional moving tracks close to one another with respect to space, which are processed by the two-dimensional moving track graph generating unit 47, will be mentioned.

For example, as shown in FIG. 21(A), as a two-dimensional moving track which exists close to an end point T1E of a two-dimensional moving track T1 with respect to space, either a two-dimensional moving track having a start point located within a fixed distance (e.g., a distance of 20 pixels) from the end point T1E or a two-dimensional moving track whose shortest distance to the end point T1E of the two-dimensional moving track T1 falls within a fixed distance is defined.

In the example of FIG. 21(A), the start point T2S of a two-dimensional moving track T2 exists within the fixed distance from the end point T1E of the two-dimensional moving track T1, and it can be therefore said that the start point T2S of the two-dimensional moving track T2 exists close to the end point T1E of the two-dimensional moving track T1 with respect to space.

Furthermore, because the shortest distance d between the end point T1E of the two-dimensional moving track T1 and the two-dimensional moving track T3 falls within the fixed distance, it can be said that the two-dimensional moving track T3 exists close to the end point T1E of the two-dimensional moving track T1 with respect to space.

In contrast, because a two-dimensional moving track T4 has a start point which is distant from the end point T1E of the two-dimensional moving track T1, it can be said that the two-dimensional moving track T4 does not exist close to the two-dimensional moving track T1 with respect to space.

Next, an example of two-dimensional moving tracks close to one another with respect to time, which are processed by the two-dimensional moving track graph generating unit 47, will be mentioned.

For example, assuming that a two-dimensional moving track T1 shown in FIG. 21(B) has a record time period of [t1 t2] and a two-dimensional moving track T2 shown in FIG. 21(B) has a record time period of [t3 t4], when the length of the time interval |t3−t2| between the record time t2 of the end point of the two-dimensional moving track T1 and the record time t3 of the start point of the two-dimensional moving track T2 is less than a constant value (e.g., less than 3 seconds), it is defined that the two-dimensional moving track T2 exists close to the two-dimensional moving track T1 with respect to time.

In contrast with this, when the length of the time interval |t3−t2| exceeds the constant value, it is defined that the two-dimensional moving track T2 does not exist close to the two-dimensional moving track T1 with respect to time.

Although the examples of the two-dimensional moving track close to the end point T1E of the two-dimensional moving track T1 with respect to space and with respect to time are described above, two-dimensional moving tracks close to the start point of a two-dimensional moving track with respect to space and with respect to time can be defined similarly.

Next, the track dividing process and the track connecting process carried out by the two-dimensional moving track graph generating unit 47 will be explained.

### [Track Dividing Process]

When another two-dimensional moving track A exists close to the start point S of a two-dimensional moving track calculated by the two-dimensional moving track calculating unit 45 with respect to time and with respect to space, the two-dimensional moving track graph generating unit 47 divides the other two-dimensional moving track A into two portions at a point near the start point S.

For example, when two-dimensional moving tracks {T1, T2, T4, T6, T7} are calculated by the two-dimensional moving track calculating unit 45, as shown in FIG. 20(A), the start point of the two-dimensional moving track T1 exists close to the two-dimensional moving track T2.

Therefore, the two-dimensional moving track graph generating unit 47 divides the two-dimensional moving track T2 into two portions at a point near the start point of the two-dimensional moving track T1 to generate a two-dimensional moving track T2 and a two-dimensional moving track T3 newly and acquires a set of two-dimensional moving tracks {T1, T2, T4, T6, T7, T3} as shown in FIG. 20(B).

Furthermore, when another two-dimensional moving track A exists close to the end point S of a two-dimensional moving track calculated by the two-dimensional moving track calculating unit 45 with respect to time and space, the two-dimensional moving track graph generating unit 47 divides the other two-dimensional moving track A into two portions at a point near the end point S.

In the example of FIG. 20(B), a two-dimensional moving track T1 has an end point existing close to a two-dimensional moving track T4.

Therefore, the two-dimensional moving track graph generating unit 47 divides the two-dimensional moving track T4 into two portions at a point near the end point of the two-dimensional moving track T1 to generate a two-dimensional moving track T4 and a two-dimensional moving track T5 newly and acquire a set of two-dimensional moving tracks {T1, T2, T4, T6, T7, T3, T5} as shown in FIG. 20(C).

### [Track Connecting Process]

When the start point of another two-dimensional moving track B exists close to the endpoint of a two-dimensional moving track A with respect to space and with respect to time in the set of two-dimensional moving tracks acquired through the track dividing process, the two-dimensional moving track graph generating unit 47 connects the two two-dimensional moving tracks A and B to each other.

More specifically, the two-dimensional moving track graph generating unit 47 acquires a two-dimensional moving track graph by defining each two-dimensional moving track as a vertex of a graph, and also defining each pair of two-dimensional moving tracks connected to each other as a directed side of the graph.

In the example of FIG. 20(C), the following information can be acquired through the track dividing process and the track connecting process.
Set of two-dimensional moving tracks connected to T1={T5}
Set of two-dimensional moving tracks connected to T2={T1, T3}
Set of two-dimensional moving tracks connected to T3={T4, T6}
Set of two-dimensional moving tracks connected to T4={T5}
Set of two-dimensional moving tracks connected to T5={□ (empty set)}
Set of two-dimensional moving tracks connected to T6={T7}
Set of two-dimensional moving tracks connected to T7={□ (empty set)}

In this case, the two-dimensional moving track graph generating unit 47 generates a two-dimensional moving track graph having information about the two-dimensional moving tracks T1 to T7 as the vertices of the graph, and information about directed sides which are pairs of two-dimensional moving tracks: (T1, T5), (T2, T1), (T2, T3), (T3, T4), (T3, T6), (T4, T5), and (T6, T7).

Furthermore, the two-dimensional moving track graph generating unit 47 can not only connect two-dimensional moving tracks in the forward direction of time (in the direction toward the future), but also generate a graph in the backward direction of time (in the direction toward the past). In this case, the two-dimensional moving track graph generating unit can connect two-dimensional moving tracks to each other along a direction from the end point of each two-dimensional moving track toward the start point of another two-dimensional moving track.

In the example of FIG. 20(C), the two-dimensional moving track graph generating unit generates the following information through the track dividing process and the track connecting process.
Set of two-dimensional moving tracks connected to T7 {T6}
Set of two-dimensional moving tracks connected to T6={T3}
Set of two-dimensional moving tracks connected to T5={T4, T1}
Set of two-dimensional moving tracks connected to T4={T3}
Set of two-dimensional moving tracks connected to T3={T2}
Set of two-dimensional moving tracks connected to T2={□ (empty set)}
Set of two-dimensional moving tracks connected to T1={T2}

While tracking a person, when another person wearing a dress of the same color as the person's dress exists in a video image, or when another person overlaps the person in a video image and therefore shades the person, the person's two-dimensional moving track may branch off into two parts or may be discrete with respect to time. Therefore, as shown in FIG. 20(A), two or more two-dimensional moving track candidates may be calculated for an identical person.

Therefore, the two-dimensional moving track graph generating unit 47 can hold information about a plurality of moving paths for such a person by generating a two-dimensional moving track graph.

After the two-dimensional moving track graph generating unit 47 generates the two-dimensional moving track graph, the track stereo unit 48 determines a plurality of two-dimensional moving track candidates by searching through the two-dimensional moving track graph, carries out stereo matching between each two-dimensional moving track candidate in each video image and a two-dimensional moving track in any other video image by taking into consideration the installed positions and installation angles of the plurality of cameras 1 with respect to the reference point in the cage calculated by the camera calibration unit 42 to calculate the degree of match between the two-dimensional moving track candidates, and calculates three-dimensional moving tracks of each individual person from the two-dimensional moving track candidates each having a degree of match equal to or larger than a specified value (step ST46 of FIG. 13).

Hereafter, the process carried out by the track stereo unit 48 will be explained concretely.

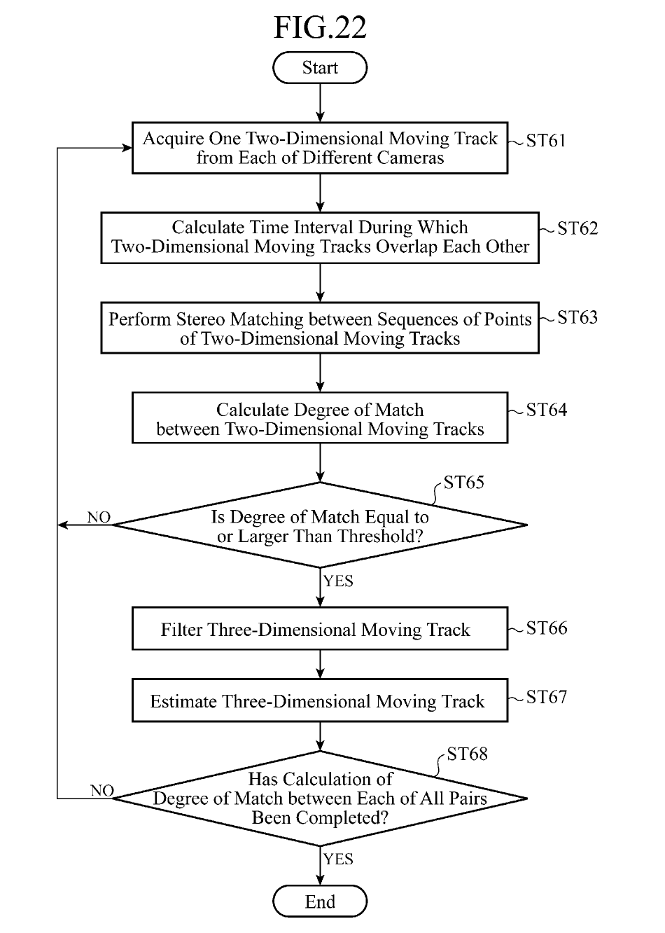

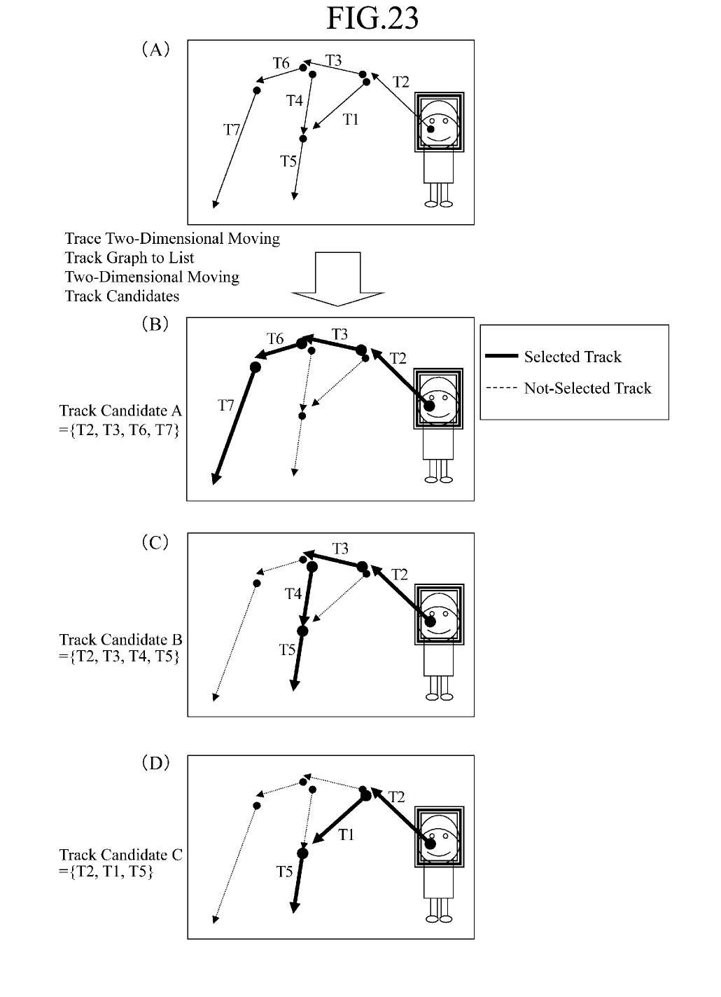

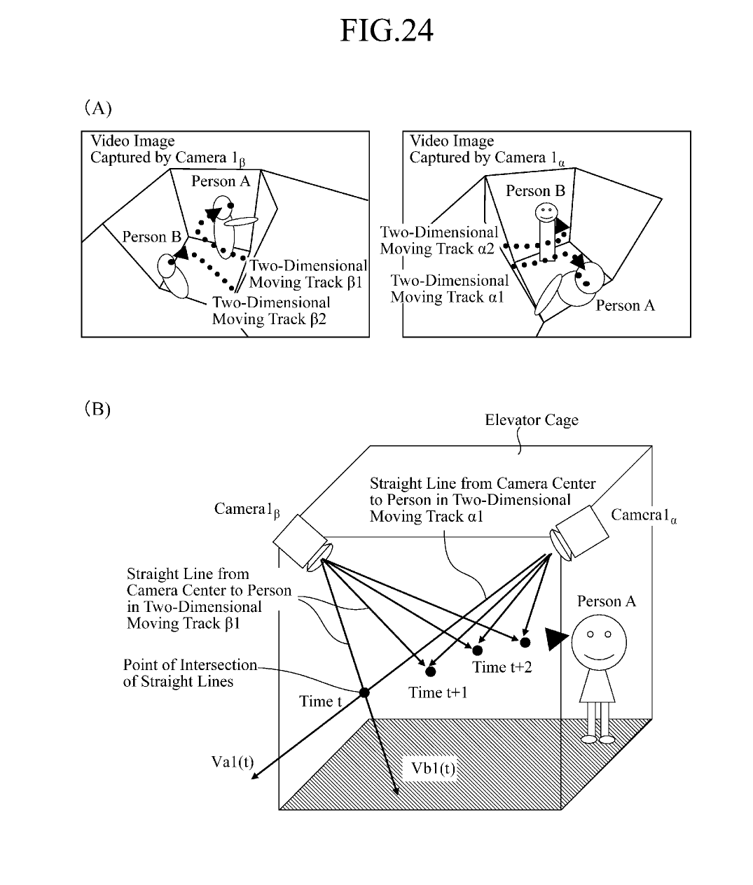

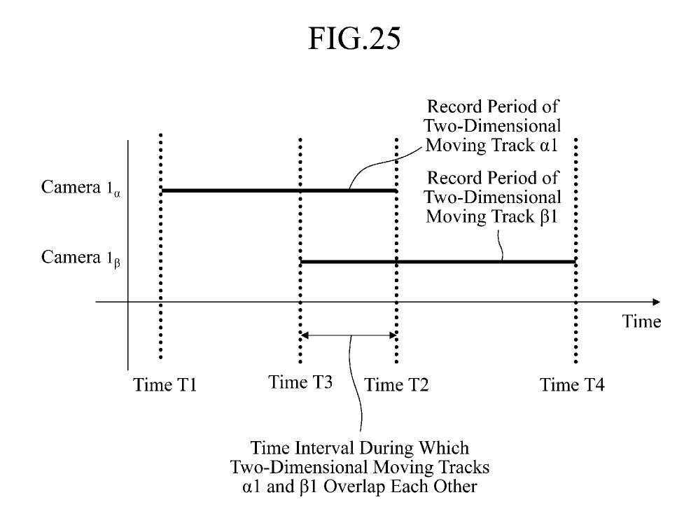

FIG. 22 is a flow chart showing the process carried out by the track stereo unit 48. Furthermore, FIG. 23 is an explanatory drawing showing the process of searching through a two-dimensional moving track graph which is carried out by the track stereo unit 48, FIG. 24 is an explanatory drawing showing the process of calculating the degree of match between two-dimensional moving tracks, and FIG. 25 is an explanatory drawing showing an overlap between two-dimensional moving tracks.

First, a method of searching through a two-dimensional moving track graph to list two-dimensional moving track candidates will be described.

Hereafter, it is assumed that, as shown in FIG. 23(A), a two-dimensional moving track graph G that consists of two-dimensional moving tracks T1 to T7 is acquired, and the two-dimensional moving track graph G has the following graph information.
Set of two-dimensional moving tracks connected to T1={T5}
Set of two-dimensional moving tracks connected to T2={T1, T3}
Set of two-dimensional moving tracks connected to T3={T4, T6}
Set of two-dimensional moving tracks connected to T4={T5}
Set of two-dimensional moving tracks connected to T5={□ (empty set)}
Set of two-dimensional moving tracks connected to T6={T7}
Set of two-dimensional moving tracks connected to T7={□ (empty set)}

At this time, the track stereo unit 48 searches through the two-dimensional moving track graph G to list all connected two-dimensional moving track candidates.

In the example of FIG. 23, the following connected two-dimensional moving track candidates are determined.
Two-dimensional moving track candidate A={T2, T3, T6, T7}
Two-dimensional moving track candidate B={T2, T3, T4, T5}
Two-dimensional moving track candidate C={T2, T1, T5}

First, the track stereo unit 48 acquires one two-dimensional moving track corresponding to each of camera images captured by the plurality of cameras 1 (step ST61), and calculates a time interval during which each two-dimensional moving track overlaps another two-dimensional moving track (step ST62).

Hereafter, the process of calculating the time interval during which each two-dimensional moving track overlaps another two-dimensional moving track will be explained concretely.

Hereafter, it is assumed that, as shown in FIG. 24(B), the inside of the cage is shot by using two cameras 1_{α} and 1_{β} installed at different positions inside the elevator.

FIG. 24(A) virtually shows a situation in which two-dimensional moving tracks are calculated for each of persons A and B, α1 shows a two-dimensional moving track of the person A in the video image captured by the camera 1_{α}, and α2 shows a two-dimensional moving track of the person B in the video image captured by the camera 1_{α}.

Furthermore, β1 shows a two-dimensional moving track of the person A in the video image captured by the camera 1_{β}, and β2 shows a two-dimensional moving track of the person B in the video image captured by the camera 1_{β}.

For example, when, in step ST61, acquiring the two-dimensional moving track α1 and the two-dimensional moving track β1 which are shown in FIG. 24(A), the track stereo unit 48 assumes the two-dimensional moving track α1 and the two-dimensional moving track β1 to be as shown by the following equations, respectively.

$$Two \text{-} dimensional moving track α 1 ≡ {\{ Xa 1 ( t ) \}}_{t = T 1 , … , T 2} = \{ Xa 1 ( T 1 ) , Xa 1 ( T 1 + 1 ) , … , Xa 1 ( T 2 ) \}$$

$$Two \text{-} dimensional moving track β1 ≡ {\{ Xb 1 ( t ) \}}_{t = T 3 , … , T4} = \{ Xb 1 ( T 3 ) , Xb 1 ( T 3 + 1 ) , … , Xb 1 ( T 4 ) \}$$

where Xa1(t) and Xb1(t) are the person's A two-dimensional image coordinates at the time t. The two-dimensional moving track α1 shows that its image coordinates are recorded during the time period from the time T1 to the time T2, and the two-dimensional moving track β1 shows that its image coordinates are recorded during the time period from the time T3 to the time T4.

FIG. 25 shows the time periods during which these two two-dimensional moving tracks α1 and β1 are recorded, and it can be seen from this figure that the image coordinates of the two-dimensional moving track α1 are recorded during the time period from the time T1 to the time T2 whereas the image coordinates of the two-dimensional moving track β1 are recorded during the time period from the time T3 to the time T4.

In this case, because a time interval during which the two-dimensional moving track α1 and the two-dimensional moving track β1 overlap each other extends from the time T3 to the time T2, the track stereo unit 48 calculates this time interval.

After calculating the time interval during which each two-dimensional moving track overlaps another two-dimensional moving track, the track stereo unit 48 carries out stereo matching between the corresponding sequences of points which form the two-dimensional moving tracks at each time within the overlapping time interval by using the installed position and installation angle of each of the cameras 1 which is calculated by the camera calibration unit 42 to calculate the distance between the sequences of points (step ST63).

Hereafter, the process of carrying out stereo matching between the sequences of points will be explained concretely.

As shown in FIG. 24(B), the track stereo unit 48 determines a straight line Va1(t) passing through the center of the camera 1_{α} and the image coordinates Xa1(t) and also determines a straight line Vb1(t) passing through the center of the camera 1_{β} and the image coordinates Xb1(t) during all of the overlapping time interval by using the installed positions and installation angles of the two cameras 1_{α} and 1_{β} which are calculated by the camera calibration unit 42.

Furthermore, the track stereo unit 48 calculates the distance d(t) between the straight line Va1(t) and the straight line Vb1(t) at the same time when calculating a point of intersection of the straight line Va1(t) and the straight line Vb1(t) as a three-dimensional position Z(t) of the person.

For example, from {Xa1(t)}t=T1, . . . , T2 and {Xb1(t)}t=T3, . . . , T4, the track stereo unit acquires a set {Z(t), d(t)}t=T3, . . . , T2 of pairs of the three-dimensional position vector Z(t) and the distances d(t) between the straight lines during the overlapping time interval t=T3, . . . , T2.

FIG. 24(B) shows a case in which the straight line Va1(t) and the straight line Vb1(t) intersect. However, in actuality, the straight line Va1(t) and the straight line Vb1(t) are simply close to each other, but does not intersect in many cases due to a detection error of the head of the person and a calibration error. In such a case, the distance d(t) of a line segment which connects the straight line Va1(t) and the straight line Vb1(t) with the shortest distance is determined, and the middle point of the line segment can be determined as the point of intersection Z(t).

As an alternative, the distance d(t) between the two straight lines and the point of intersection Z(t) can be calculated by using an “optimum correction” method disclosed by the following reference 4.

### REFERENCE 4

K. Kanatani, “Statistical Optimization for Geometric Computation: Theory and Practice and Elsevier Science”, Amsterdam, The Netherlands, April 1996.

Next, the track stereo unit 48 calculates the degree of match between the two-dimensional moving tracks by using the distance between the sequences of points which the track stereo unit has acquired by carrying out stereo matching between the corresponding sequences of points (step ST64).

When the overlapping time interval has a length of “0”, the track stereo unit determines the degree of match as “0”. In this embodiment, for example, the track stereo unit calculates, as the degree of match, the number of times that the straight lines intersect during the overlapping time interval.

More specifically, in the example of FIGS. 24 and 25, the track stereo unit calculates, as the degree of match, the number of times that the distance d(t) becomes equal to or shorter than a fixed threshold (e.g., 5 cm) during the time interval t=T3, . . . , T2.

In this embodiment, the example in which the track stereo unit calculates, as the degree of match, the number of times that the straight lines intersect during the overlapping time interval is shown. However, this embodiment is not limited to this example. For example, the track stereo unit can calculate, as the degree of match, a proportion of the overlapping time interval during which the two straight lines intersect.

More specifically, in the example of FIGS. 24 and 25, the track stereo unit calculates the number of times that the distance d(t) becomes equal to or shorter than a fixed threshold (e.g., 15 cm) during the time interval t=T3, . . . , T2, and divides the number of times by the length of the overlapping time interval |T3−T2| to define this division result as the degree of match.

As an alternative, the track stereo unit can calculate, as the degree of match, the average of the distance between the two straight lines during the overlapping time period.

More specifically, in the example of FIG. 24, the track stereo unit calculates, as the degree of match, the average of the reciprocal of the distance d(t) during the time interval t=T3, . . . , T2.

As an alternative, the track stereo unit can calculate, as the degree of match, the sum total of values of the distance of the two straight lines during the overlapping time interval.

More specifically, in the example of FIG. 24, the track stereo unit calculates, as the degree of match, the sum total of values of the reciprocal of the distance d(t) during the time interval t=T3, . . . , T2.

In addition, the track stereo unit can calculate the degree of match by combining some of the above-mentioned calculating methods.

Hereafter, advantages provided by carrying out the stereo matching between two-dimensional moving tracks will be described.

For example, because the two-dimensional moving track α2 and the two-dimensional moving track β2 shown in FIG. 24 belong to the identical person B, the distance d(t) at each time, which the track stereo unit acquires by carrying out the stereo matching between the two-dimensional moving track α2 and the two-dimensional moving track β2, has a small value. Therefore, the average of the reciprocal of distance d(t) has a large value, and hence the degree of match between the two-dimensional moving track α2 and the two-dimensional moving track β2 has a high value.

In contrast, because the two-dimensional moving track α1 and the two-dimensional moving track β2 belong to the different persons A and B, respectively, the stereo matching between the two-dimensional moving track α1 and the two-dimensional moving track β2 which is carried out by the track stereo unit may show that the straight lines intersect at a time by accident. However, the straight lines do not intersect almost all the time, and the average of the reciprocal of the distance d(t) has a small value. Therefore, the degree of match between the two-dimensional moving track α1 and the two-dimensional moving track β2 has a low value.

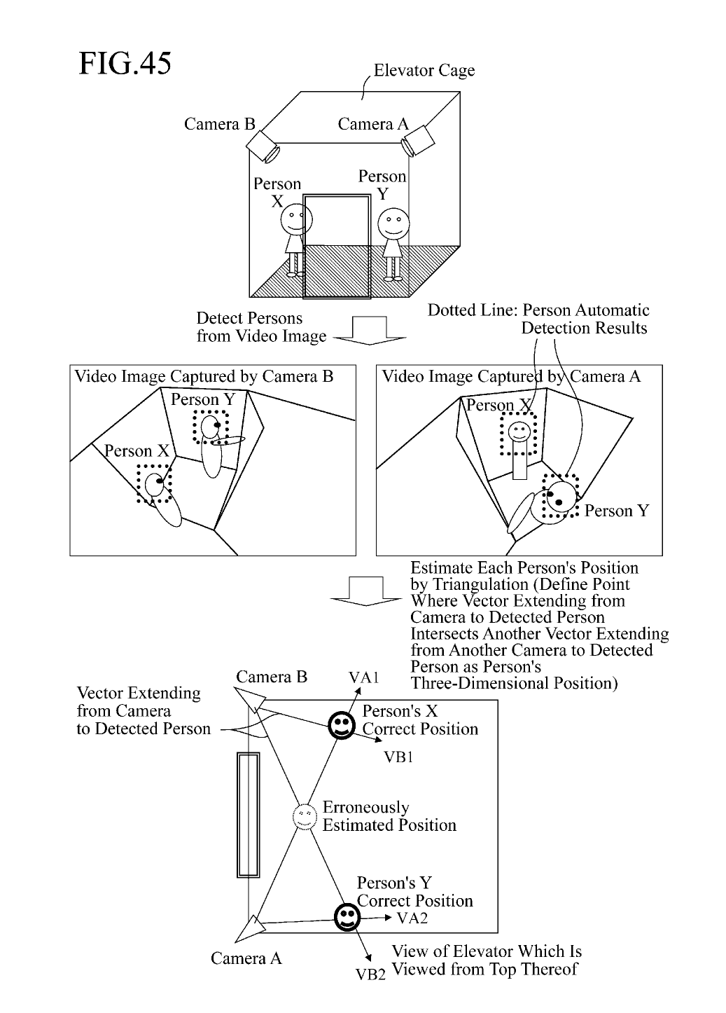

Conventionally, because the stereo matching is performed on person detection results at a moment to estimate each person's three-dimensional position, as shown in FIG. 45, there can be a case in which the ambiguity of the stereo vision cannot be avoided and therefore an estimation of each person's position is carried out erroneously.

In contrast, the person tracking device in accordance with this Embodiment 1 can cancel the ambiguity of the stereo vision and becomes possible to determine each person's three-dimensional moving track correctly by carrying out the stereo matching between two-dimensional moving tracks of each person throughout a fixed time interval.

After calculating the degree of match between the two-dimensional moving track of each person in each video image and the two-dimensional moving track of a person in any other video image in the above-mentioned way, the track stereo unit 48 compares the degree of match with a predetermined threshold (step ST65).

When the degree of match between the two-dimensional moving track of each person in each video image and the two-dimensional moving track of a person in another video image exceeds the threshold, the track stereo unit 48 carries out a process of calculating a three-dimensional moving track during a time interval during which the two-dimensional moving track of each person in each video image and the two-dimensional moving track of a person in another video image overlap each other from these two-dimensional moving tracks (although the three-dimensional positions where a portion of the two-dimensional moving track of each person in each video image and a portion of the two-dimensional moving track of a person in another video image overlap each other during the time interval can be estimated by carrying out normal stereo matching, a detailed explanation of this normal stereo matching will be omitted because this is a known technique), and performing filtering on the three-dimensional moving track to remove an erroneously-estimated three-dimensional moving track (step ST66).

More specifically, because when the person detecting unit 44 carries out an erroneous detection of a person, the track stereo unit 48 may calculate the person's three-dimensional moving track erroneously because of the erroneous detection, the track stereo unit 48 determines the three-dimensional moving track as what is not a person's essential track to cancel this three-dimensional moving track when the person's three-dimensional position Z(t) does not satisfy any criteria (a) to (c) shown below.

Criterion (a): The person's height is higher than a fixed length (e.g., 50 cm).

Criterion (b): The person exists in a specific area (e.g., the inside of the elevator cage).

Criterion (c): The person's three-dimensional movement history is smooth.

According to the criterion (a), a three-dimensional moving track at an extremely low position is determined as one which is erroneously detected and is therefore canceled.

Furthermore, according to the criterion (b), for example, a three-dimensional moving track of a person image in a mirror installed in the cage is determined as one which is not a person's track and is therefore canceled.

Furthermore, according to the criterion (c), for example, an unnatural three-dimensional moving track which varies rapidly both vertically and horizontally is determined as one which is not a person's track and is therefore canceled.

Next, the track stereo unit 48 calculates the three-dimensional positions of the sequence of points which form portions of the two-dimensional moving tracks which do not overlap each other with respect to time by using the three-dimensional positions where a portion of the two-dimensional moving track of each person in each video image and a portion of the two-dimensional moving track of a person in another video image overlap each other during the time interval to estimate three-dimensional moving tracks of each individual person (step ST67).

In the case of FIG. 25, while the two-dimensional moving track α1 and the two-dimensional moving track β1 overlap each other during the time interval t=T3, . . . , T2, they do not overlap each other at any other time.

No three-dimensional moving track of a person can be calculated during a time interval during which any two two-dimensional moving tracks of the person do not overlap each other by using the normal stereo matching method. In this case, in accordance with this embodiment, the average of each person's height during a time interval which two two-dimensional moving tracks of each person overlap each other is calculated and each person's three-dimensional moving track during a time interval during which any two two-dimensional moving tracks of each person do not overlap each other is estimated by using the average of the height.

In the example of FIG. 25, the track stereo unit calculates the average aveH of the height of the three-dimensional position vector Z(t) in {Z(t),d(t)}t=T3, . . . , T2 first.

Next, the track stereo unit determines the point at each time t whose height from the floor is equal to aveH from among the points on the straight line Va1(t) passing through both the center of the camera 1_{α}, and the image coordinates Xa1(t), and then estimates this point as the three-dimensional position Z(t) of the person. Similarly, the track stereo unit estimates the person's three-dimensional position Z(t) from the image coordinates Xb1(t) at each time t.

As a result, the track stereo unit can acquire a three-dimensional moving track {Z(t)}t=T1, . . . , T4 throughout all the time period from the time T1 to the time T4 during which the two-dimensional moving track α1 and the two-dimensional moving track β1 are recorded.

As a result, even when the person is not shot during a certain time period by one of the cameras for the reason that the person is shaded by someone else, or the like, the track stereo unit 48 can calculate the person's three-dimensional moving track as long as the person's two-dimensional moving track is calculated by using a video image captured by another camera, and the two-dimensional moving track overlaps another two-dimensional moving track before and after the person is shaded by someone else.

After the calculation of the degree of match between the two-dimensional moving tracks of each of all the pairs is completed, the person tracking device ends the process by the track stereo unit 48 and then makes a transition to the process by the three-dimensional moving track calculating unit 49 (step ST68).

After the track stereo unit 48 calculates three-dimensional moving tracks of each individual person, the three-dimensional moving track graph generating unit 49 performs a dividing process and a connecting process on the three-dimensional moving tracks of each individual person to generate a three-dimensional moving track graph (step ST47).

More specifically, the three-dimensional moving track graph generating unit 49 searches through the set of three-dimensional moving tracks of each individual person calculated by the track stereo unit 48 for three-dimensional moving tracks close to one another with respect to space or time, and then performs processes such as division and connection, on them to generate a three-dimensional moving track graph having the three-dimensional moving tracks as vertices of the graph, and having connected three-dimensional moving tracks as directed sides of the graph.

Hereafter, the process carried out by the three-dimensional moving track graph generating unit 49 will be explained concretely.

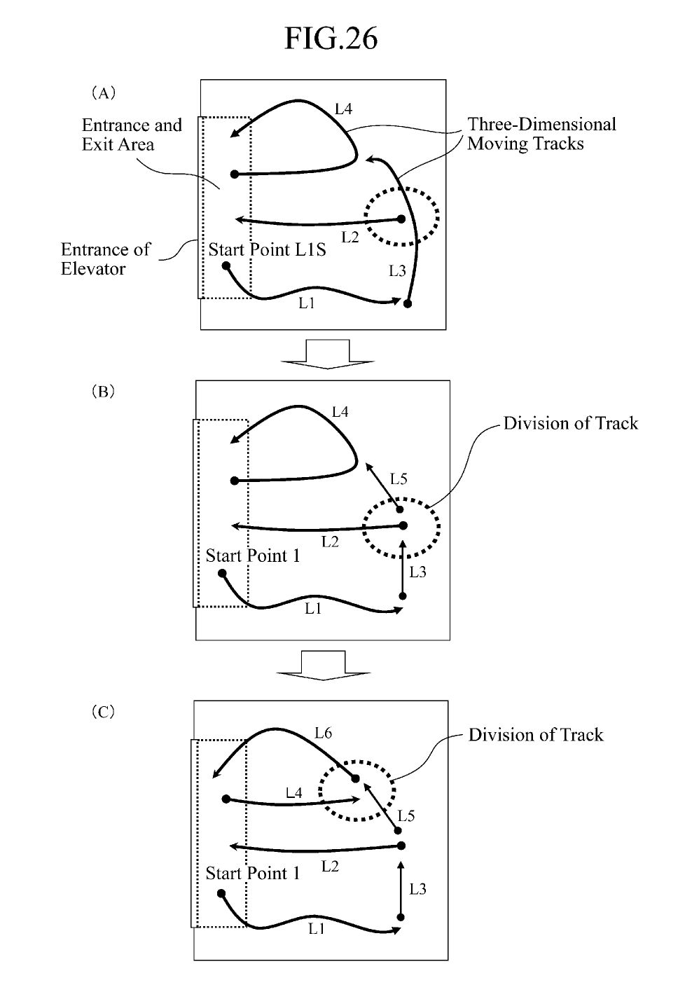

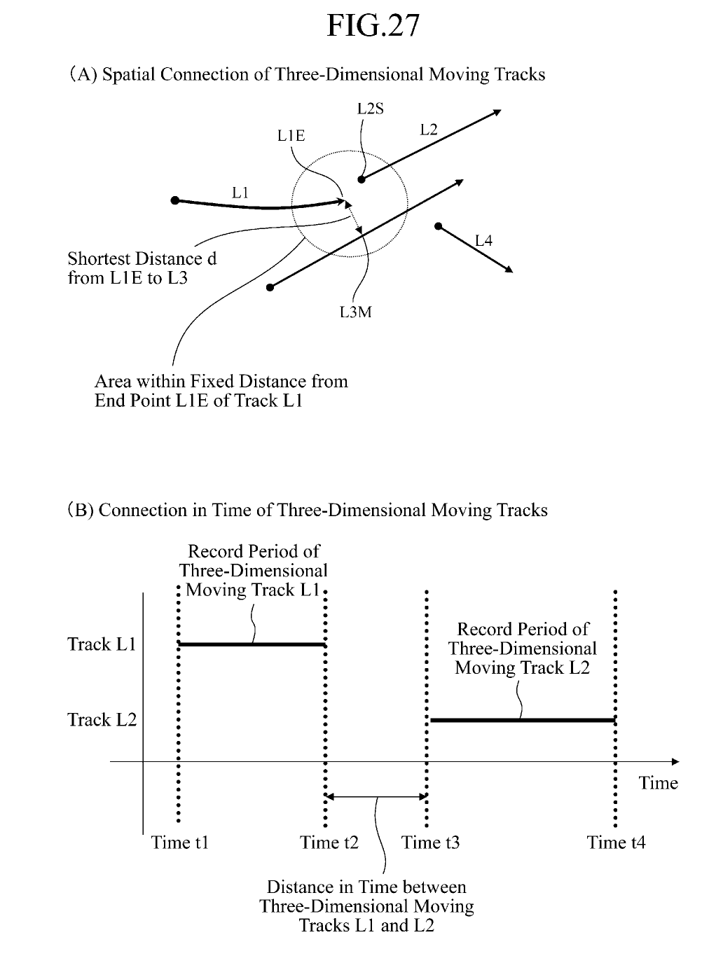

FIGS. 26 and 27 are explanatory drawings showing the process carried out by the three-dimensional moving track graph generating unit 49.

First, an example of three-dimensional moving tracks close to one another with respect to space, which are processed by the three-dimensional moving track graph generating unit 49, will be mentioned.

For example, as shown in FIG. 27(A), as a three-dimensional moving track which exists close to an end point L1E of a three-dimensional moving track L1 with respect to space, either a three-dimensional moving track having a start point located within a fixed distance (e.g., a distance of 25 cm) from the end point L1E or a three-dimensional moving track whose shortest distance to the end point L1E of the two-dimensional moving track L1 falls within a fixed distance is defined.

In the example of FIG. 27(A), the start point L2S of a three-dimensional moving track L2 exists within the fixed distance from the end point L1E of the three-dimensional moving track L1, and it can be therefore said that the three-dimensional moving track L2 exists close to the end point L1E of the three-dimensional moving track L1 with respect to space.

Furthermore, because the shortest distance d between the end point L1E of the three-dimensional moving track L1 and the three-dimensional moving track L3 falls within the fixed distance, it can be said that the three-dimensional moving track L3 exists close to the end point L1E of the three-dimensional moving track L1 with respect to space.

In contrast, because a three-dimensional moving track L4 has a start point which is distant from the end point L1E of the three-dimensional moving track L1, it can be said that the three-dimensional moving track L4 does not exist close to the three-dimensional moving track L1 with respect to space.

Next, an example of three-dimensional moving tracks close to one another with respect to time, which are processed by the three-dimensional moving track graph generating unit 49, will be mentioned.

For example, assuming that a three-dimensional moving track L1 shown in FIG. 27(B) has a record time period of [t1 t2] and a three-dimensional moving track L2 shown in FIG. 27(B) has a record time period of [t3 t4], when the length of a time interval |t3−t2| between the record time t2 of the end point of the three-dimensional moving track L1 and the record time t3 of the start point of the three-dimensional moving track L2 is less than a constant value (e.g., less than 3 seconds), it is defined that the three-dimensional moving track L2 exists close to the three-dimensional moving track L1 with respect to time.

In contrast with this, when the length of the time interval |t3−t2| exceeds the constant value, it is defined that the three-dimensional moving track L2 does not exist close to the three-dimensional moving track L1 with respect to time.

Although the examples of the three-dimensional moving track close to the end point L1E of the three-dimensional moving track L1 with respect to space and with respect to time are described above, three-dimensional moving tracks close to the start point of a three-dimensional moving track with respect to space and with respect to time can be defined similarly.

Next, the track dividing process and the track connecting process carried out by the three-dimensional moving track graph generating unit 49 will be explained.

### [Track Dividing Process]

When another three-dimensional moving track A exists close to the start point S of a three-dimensional moving track calculated by the three-dimensional moving track calculating unit 48 with respect to time and with respect to space, the three-dimensional moving track graph generating unit 49 divides the three-dimensional moving track A into two portions at a point near the start point S.

FIG. 26(A) is a schematic diagram showing the inside of the elevator when is viewed from the top of the elevator, and shows the entrance of the elevator, an entrance and exit area of the elevator, and three-dimensional moving tracks L1 to L4.

In the case of FIG. 26(A), the start point of the three-dimensional moving track L2 exists close to the three-dimensional moving track L3.

Therefore, the three-dimensional moving track graph generating unit 49 divides the three-dimensional moving track L3 into two portions at a point near the start point of the three-dimensional moving track L2 to generate a three-dimensional moving track L3 and a three-dimensional moving track L5 newly and acquire a set of three-dimensional moving tracks as shown in FIG. 20(B).

Furthermore, when another three-dimensional moving track A exists close to the end point Sofa three-dimensional moving track calculated by the track stereo unit 48 with respect to time and with respect to space, the three-dimensional moving track graph generating unit 49 divides the other three-dimensional moving track A into two portions at a point near the end point S.

In the example of FIG. 26(B), a three-dimensional moving track L5 has an endpoint existing close to a three-dimensional moving track L4.

Therefore, the three-dimensional moving track graph generating unit 49 divides the three-dimensional moving track L4 into two portions at a point near the end point of the three-dimensional moving track L5 to generate a three-dimensional moving track L4 and a three-dimensional moving track L6 newly and acquire a set of three-dimensional moving tracks L1 to L6 as shown in FIG. 20(C).

### [Track Connecting Process]

When the start point of another three-dimensional moving track B exists close to the end point of a three-dimensional moving track A with respect to space and with respect to time in the set of three-dimensional moving tracks acquired through the track dividing process, the three-dimensional moving track graph generating unit 49 connects the two three-dimensional moving tracks A and B to each other.

More specifically, the three-dimensional moving track graph generating unit 49 acquires a three-dimensional moving track graph by defining each three-dimensional moving track as a vertex of a graph, and also defining each pair of three-dimensional moving tracks connected to each other as a directed side of the graph.

In the example of FIG. 26(C), the three-dimensional moving track graph having the following information is generated through the track dividing process and the track connecting process.
Set of three-dimensional moving tracks connected to L1={L3}
Set of three-dimensional moving tracks connected to L2={□ (empty set)}
Set of three-dimensional moving tracks connected to L3={L2, L5}
Set of three-dimensional moving tracks connected to L4={L6}
Set of three-dimensional moving tracks connected to L5={L6}
Set of three-dimensional moving tracks connected to L6={□ (empty set)}

In many cases, the three-dimensional moving tracks of each individual person calculated by the track stereo unit 48 are comprised of a set of plural three-dimensional moving track fragments which are discrete with respect to space or time due to a failure to track each individual person's head in a two-dimensional image, or the like.

To solve this problem, the three-dimensional moving track graph generating unit 49 performs the dividing processing and the connecting process on these three-dimensional moving tracks to determine a three-dimensional moving track graph, so that the person tracking device can hold information about a plurality of moving paths of each person.

After the three-dimensional moving track graph generating unit 49 generates the three-dimensional moving track graph, the track combination estimating unit 50 searches through the three-dimensional moving track graph to calculate three-dimensional moving track candidates of each individual person from an entrance to the cage to an exit from the cage, and estimates a combination of optimal three-dimensional moving tracks from the three-dimensional moving track candidates to calculate an optimal three-dimensional moving track of each individual person, and the number of persons existing in the cage at each time (step ST48).

Hereafter, the process carried out by the track combination estimating unit 50 will be explained concretely.

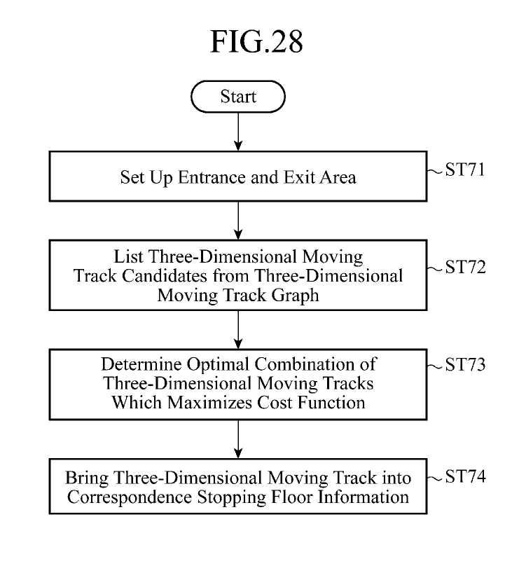

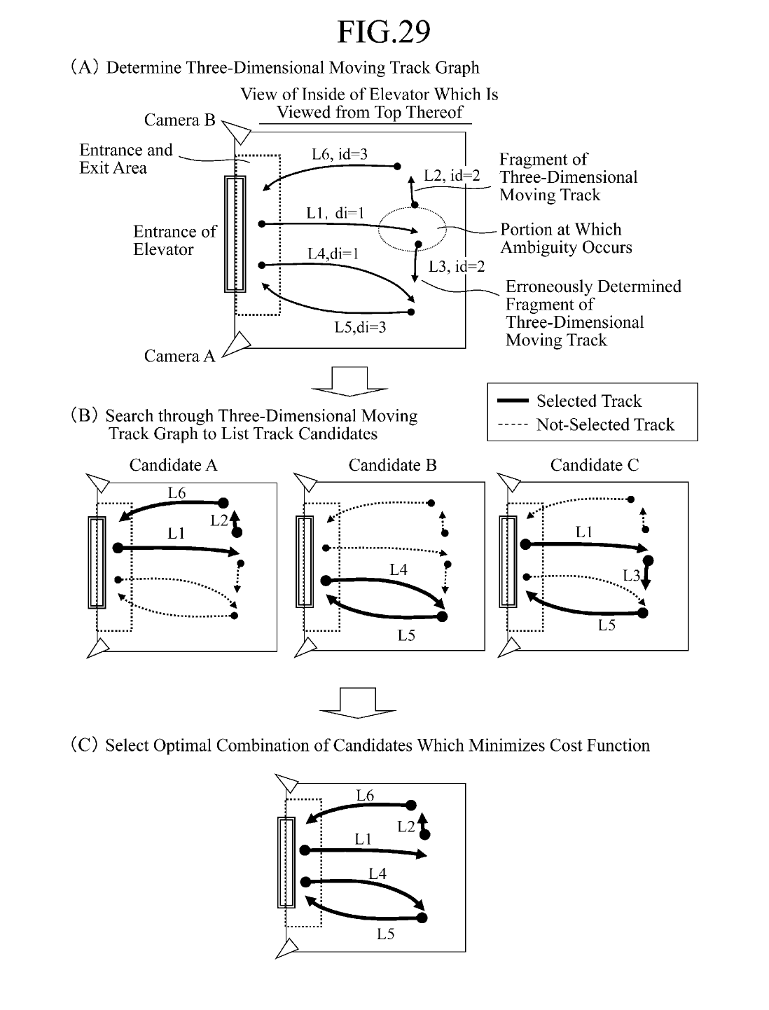

FIG. 28 is a flow chart showing the process carried out by the track combination estimating unit 50, and FIG. 29 is an explanatory drawing showing the process carried out by the track combination estimating unit 50. FIG. 29(A) is a view showing the elevator which is viewed from the top thereof.

First, the track combination estimating unit 50 sets up an entrance and exit area for persons at a location in the area to be monitored (step ST71).

The entrance and exit area is used as the object of a criterion by which to judge whether each person has entered or exited the elevator. In the example of FIG. 29(A), the track combination estimating unit 50 sets up an entrance and exit area in the vicinity of the entrance in the elevator cage virtually.

When the moving track of the head of a person has started from the entrance and exit area which is set up in the vicinity of the entrance of the elevator, for example, it can be determined that the person has got on the elevator on the corresponding floor. In contrast, when the moving track of a person has been ended in the entrance and exit area, it can be determined that the person has got off the elevator on the corresponding floor.

Next, the track combination estimating unit 50 searches through the three-dimensional moving track graph generated by the three-dimensional moving track graph generating unit 49, and calculates candidates for a three-dimensional moving track of each individual person (i.e., a three-dimensional moving track from an entrance to the area to be monitored to an exit from the area) which satisfy the following entrance criteria and exit criteria within a time period determined for the analytical object (step ST72).

### [Entrance Criteria]

(1) Entrance criterion:
The three-dimensional moving track is extending from the door toward the inside of the elevator.
(2) Entrance criterion:
The position of the start point of the three-dimensional moving track is in the entrance and exit area.
(3) Entrance criterion:
The door index di at the start time of the three-dimensional moving track set up by the door opening and closing recognition unit 11 is not “0”.

### [Exit Criteria]

(1) Exit criterion:
The three-dimensional moving track is extending from the inside of the elevator toward the door.
(2) Exit criterion:
The position of the end point of the three-dimensional moving track is in the entrance and exit area.
(3) Exit criteria:
The door index di at the end time of the three-dimensional moving track set up by the door opening and closing recognition unit 11 is not “0”, and the door index di differs from that at the time of entrance.

In the example of FIG. 29(A), three-dimensional moving tracks of an individual person are provided as follows.

It is assumed that the three-dimensional moving track graph G is comprised of three-dimensional moving tracks L1 to L6, and the three-dimensional moving track graph G has the following information.
Set of three-dimensional moving tracks connected to L1={L2, L3}
Set of three-dimensional moving tracks connected to L2={L6}
Set of three-dimensional moving tracks connected to L3={L5}
Set of three-dimensional moving tracks connected to L4={L5}
Set of three-dimensional moving tracks connected to L5={□ (empty set)}
Set of three-dimensional moving tracks connected to L6={□ (empty set)}

Furthermore, it is assumed that the door indexes di of the three-dimensional moving tracks L1, L2, L3, L4, L5, and L6 are 1, 2, 2, 4, 3, and 3, respectively. However, it is further assumed that the three-dimensional moving track L3 is determined erroneously due to a failure to track the individual person's head or shading by another person.

Therefore, two three-dimensional moving tracks (the three-dimensional moving tracks L2 and L3) are connected to the three-dimensional moving track L1, and therefore ambiguity occurs in the person's moving trucking.

In the example of FIG. 29(A), the three-dimensional moving tracks L1 and L4 meet the entrance criteria, and the three-dimensional moving tracks L3 and L6 meet the exit criteria.

In this case, the track combination estimating unit 50 searches through the three-dimensional moving track graph G by, for example, starting from the three-dimensional moving track L1, and then tracing the three-dimensional moving tracks in order of L1→L2→L6 to acquire a candidate {L1, L2, L6} for the three-dimensional moving track from an entrance to the area to be monitored to an exit from the area.

Similarly, the track combination estimating unit 50 searches through the three-dimensional moving track graph G to acquire candidates, as shown below, for the three-dimensional moving track from an entrance to the area to be monitored to an exit from the area.

Track candidate A={L1, L2, L6}

Track candidate B={L4, L5}

Track candidate C={L1, L3, L5}

Next, by defining a cost function which takes into consideration a positional relationship among persons, the number of persons, the accuracy of stereo vision, etc., and selectively determining a combination of three-dimensional moving tracks which maximizes the cost function from among the candidates for the three-dimensional moving track from an entrance to the area to be monitored to an exit from the area, the track combination estimating unit 50 determines a correct three-dimensional moving track of each person and the correct number of persons (step ST73).

For example, the cost function reflects requirements: “any two three-dimensional moving tracks do not overlap each other” and “as many three-dimensional moving tracks as possible are estimated”, and can be defined as follows.

Cost=“the number of three-dimensional moving tracks”−“the number of times that three-dimensional moving tracks overlap each other”

where the number of three-dimensional moving tracks means the number of persons in the area to be monitored.

When calculating the above-mentioned cost in the example of FIG. 29(B), “the number of times that three-dimensional moving tracks overlap each other” is calculated to be “1” because the track candidate A={L1, L2, L6} and the track candidate C={L1, L3, L5} overlap each other in a portion of L1.

Similarly, because the track candidate B={L4, L5} and the track candidate C={L1, L3, L5} overlap each other in a portion of L5, “the number of times that three-dimensional moving tracks overlap each other” is calculated to be “1”.

As a result, the cost of each of combinations of one or more track candidates is calculated as follows.
□The cost of the combination of A, B and C=3−2=1
The cost of the combination of A and B=2−0=2
The cost of the combination of A and C=2−1=1
The cost of the combination of B and C=2−1=1
The cost of only A=1−0=1
The cost of only B=1−0=1
The cost of only C=1−0=1

Therefore, the combination of the track candidates A and B is the one which maximizes the cost function, and it is therefore determined that the combination of the track candidates A and B is an optimal combination of three-dimensional moving tracks.

Because the combination of the track candidates A and B is an optimal combination of three-dimensional moving tracks, it is also estimated simultaneously that the number of persons in the area to be monitored is two.

After determining the optimal combination of the three-dimensional moving tracks of persons, each of which starts from the entrance and exit area in the area to be monitored, and ends in the entrance and exit area, the track combination estimating unit 50 brings each of the three-dimensional moving tracks into correspondence with floors specified by the floor recognition unit 12 (stopping floor information showing stopping floors of the elevator), and calculates a person movement history showing the floor where each individual person has got on the elevator and the floor where each individual person has got off the elevator (a movement history of each individual person showing “how many persons have got on the elevator on which floor and how many persons have got off the elevator on which floor”) (step ST74).

In this embodiment, although the example in which the track combination estimating unit brings each of the three-dimensional moving tracks into correspondence with the floor information specified by the floor recognition unit 12 is shown, the track combination estimating unit can alternatively acquire stopping floor information from control equipment for controlling the elevator, and can bring each of the three-dimensional moving tracks into correspondence with the stopping floor information independently.

As mentioned above, by defining a cost function in consideration of a positional relationship among persons, the number of persons, the accuracy of stereo vision, etc., and then determining a combination of three-dimensional moving tracks which maximizes the cost function, the track combination estimating unit 50 can determine each person's three-dimensional moving track and the number of persons in the area to be monitored even when the result of tracking of a person head has an error due to shading by something else.

However, when a large number of persons have got on and got off the elevator and the three-dimensional moving track graph has a complicated structure, the number of candidates for the three-dimensional moving track of each person is very large and hence the number of combinations of candidates becomes very large, and the track combination estimating unit may be unable to carry out the process within a realistic time period.

In such a case, the track combination estimating unit 50 can define a likelihood function which takes into consideration a positional relationship among persons, the number of persons, and the accuracy of stereo vision, and use a probabilistic optimization technique, such as MCMC (Markov Chain Monte Carlo: Markov chain Monte Carlo) or GA (Genetic Algorithm: genetic algorithm), to determine an optimal combination of three-dimensional moving tracks.

Hereafter, a process of determining an optimal combination of three-dimensional moving tracks of persons which maximizes the cost function by using MCMC, which is carried out by the track combination estimating unit 50, will be explained concretely.

First, symbols are defined as follows.

### [Symbols]

yᵢ(t): the three-dimensional position at a time t of a three-dimensional moving track yᵢ. yᵢ(t)εR3

yᵢ: the three-dimensional moving track of the i-th person from an entrance to the area to be monitored to an exit from the area

yᵢ={yᵢ(t)}

|yᵢ|: the record time of the three-dimensional moving track yᵢ

N: the number of three-dimensional moving tracks each extending from an entrance to the area to be monitored to an exit from the area (the number of persons)

Y={yᵢ}_{i=1, . . . ,N}: a set of three-dimensional moving tracks

S(yᵢ): the stereo cost of the three-dimensional moving track yᵢ

O(yᵢ, yⱼ): the cost of an overlap between the three-dimensional moving track yᵢ and the three-dimensional moving track yⱼ

w₊: a set of three-dimensional moving tracks yᵢ which are selected as correct three-dimensional moving tracks

w₋: a set of three-dimensional moving tracks yᵢ which are not selected w₋=w−w₊

w: w={w₊,w₋}

wₒₚₜ: w which maximizes the likelihood function

|w₊|: the original number of three-dimensional moving tracks in w₊ (the number of tracks which are selected as correct three-dimensional moving tracks)

Ω: a set of w(s) w□εΩ (a set of divisions of the set Y of three-dimensional moving tracks)

L(w|Y): the likelihood function

Lₙᵤₘ(w|Y): the likelihood function of the number of selected tracks

Lₛₜᵣ(w|Y): the likelihood function regarding the stereo vision of the selected tracks

Lₒᵥᵣ(w|Y): the likelihood function regarding an overlap between the selected tracks

q(w′|w): a proposed distribution

A(w′|w): an acceptance probability

### [Model]

After the three-dimensional moving track graph generating unit 49 generates the three-dimensional moving track graph, the track combination estimating unit 50 searches through the three-dimensional moving track graph to determine the set Y={yᵢ}_{i=1, . . . ,N} of candidates for the three-dimensional moving track of each individual person which meet the above-mentioned entrance criteria and exit criteria.

Furthermore, after defining w₊ as the set of three-dimensional moving track candidates which are selected as correct three-dimensional moving tracks, the track combination estimating unit defines both w₋=w−w₊ and w={w₊,w₋}. The track combination estimating unit 50 is aimed at selecting correct three-dimensional moving tracks from the set Y of three-dimensional moving track candidates, and this aim can be formulized into the problem of defining the likelihood function L(w/Y) as a cost function, and maximizing this cost function.

More specifically, when an optimal track selection is assumed to be wₒₚₜ, wₒₚₜ is given by the following equation.

wₒₚₜ=argmax L(w|Y)

For example, the likelihood function L(w|Y) can be defined as follows.

L(w|Y)=Lₒᵥᵣ(w|Y)Lₙᵤₘ(w|Y)Lₛₜᵣ(w|Y)

where Lₒᵥᵣ is the likelihood function in which “any two three-dimensional moving tracks do not overlap each other in the three-dimensional space” is formulized, Lₙᵤₘ is the likelihood function in which “as many three-dimensional moving tracks as possible exist” is formulized, and Lₛₜᵣ is the likelihood function in which “the accuracy of stereo vision of a three-dimensional moving track is high” is formulized.

Hereafter, the details of each of the likelihood functions will be mentioned.

### [The Likelihood Function Regarding an Overlap Between Selected Tracks]

The criterion: “any two three-dimensional moving tracks do not overlap each other in the three-dimensional space” is formulized as follows.

Lₒᵥᵣ(w|Y)∝exp(−c1Σ_{i,jεw+}O(yᵢ,yⱼ))

where O(yᵢ,yⱼ) is the cost of an overlap between the three-dimensional moving track yᵢ and the three-dimensional moving track yⱼ.

When the three-dimensional moving track yᵢ and the three-dimensional moving track yⱼ perfectly overlap each other, O(yᵢ,yⱼ) has a value of “1”, whereas when the three-dimensional moving track yᵢ and the three-dimensional moving track yⱼ do not overlap each other at all, O(yᵢ,yⱼ) has a value of “0”. Furthermore, c1 is a positive constant.

O(yᵢ,yⱼ) is determined as follows.

yᵢ and yⱼ are expressed as yᵢ={yᵢ(t)}_{t=t1, . . . ,t2} and yⱼ={yⱼ(t)}_{t=t3, . . . , t4}, respectively, and it is assumed that the three-dimensional moving track yᵢ and the three-dimensional moving track yⱼ exist simultaneously during a time period F=[t3 t2].

Furthermore, a function g is defined as follows.

g(yᵢ(t),yᵢ(t))=1(if ∥yᵢ(t)−yᵢ(t)∥<Th1),=0 (otherwise)

where Th1 is a proper distance threshold, and is set to 25 cm, for example.

That is, the function g is a function for providing a penalty when the three-dimensional moving tracks are close to each other within a distance less than the threshold Th.

At this time, the overlap cost O(yᵢ, yⱼ) is calculated as follows.
In the case of |F|≠0

O(yᵢ,yⱼ)=Σ_{tεF}g(yᵢ(t),yⱼ(t))/|F|
In the case of |F|=0

O(yᵢ,y₁)=0

### [The Likelihood Function Regarding the Number of Selected Tracks]

The criterion: “as many three-dimensional moving tracks as possible exist.” is formulized as follows.

Lₙᵤₘ(w|Y)∝exp(c2|w₊|)

where |w₊| is the original number of three-dimensional moving tracks in w₊. Furthermore, c2 is a positive constant.

### [The Likelihood Function Regarding the Accuracy of Stereo Vision of the Selected Tracks]

The criterion: “the accuracy of stereo vision of a three-dimensional moving track is high.” is formulized as follows.

Lₛₜᵣ(w|Y)∝exp(−c3Σ_{iεw+}S(yᵢ))

where S(yᵢ) is a stereo cost, and when a three-dimensional moving track is estimated by using the stereo vision, S(yᵢ) of the three-dimensional moving track has a small value, whereas when a three-dimensional moving track is estimated by using monocular vision or when a three-dimensional moving track has a time period during which it is not observed by any camera 1, S(yᵢ) of the three-dimensional moving track has a large value. Furthermore, c3 is a positive constant.

Hereafter, a method of calculating the stereo cost S(yᵢ) will be described.

In this case, when yᵢ is expressed as yᵢ={yᵢ(t)}_{t=t1, . . . ,t2}, the three following time periods F1ᵢ, F2ᵢ, and F3ᵢ exist mixedly within the time period Fᵢ=[t1 t2] of the three-dimensional moving track yᵢ.

□·F1ᵢ: the time period during which the three-dimensional moving track is estimated by using the stereo vision
□·F2ᵢ: the time period during which the three-dimensional moving track is estimated by using the monocular vision
□·F3ᵢ: the time period during which no three-dimensional moving track is observed by any camera 1

In this case, the stereo cost S(yᵢ) is provided as follows.

S(yᵢ)=(c8×|F1ᵢ|+c9×|F2ᵢ|+c10×|F3ᵢ|)/|Fᵢ|

where c8, c9 and c10 are positive constants.

### [Optimization of a Combination of Track Candidates by Using MCMC]

Next, a method of maximizing the likelihood function L(w|Y) by using MCMC which the track combination estimating unit 50 uses will be described.

First, an outline of the algorithm is described as follows.

### [MCMC Algorithm]

Input: Y, wᵢₙᵢₜ, N_{mc} Output: wₒₚₜ

(1) Initialization w=wᵢₙᵢₜ, wₒₚₜ=wᵢₙᵢₜ

(2) Main routine

for n=1 to N_{mc}
step1. sample m according to ζ(m)
step2. select the proposed distribution q according to m, and sample w′
step3. sample u from a uniform distribution Unif[0 1]
step4. if u<A(w,w′), w=w′;
step5. if L(w|Y)/L(wₒₚₜ|Y)>1,
   wₒₚₜ=w′; (storage of maximum)

end

The input to the algorithm is the set Y of three-dimensional moving tracks, an initial division wᵢₙᵢₜ, and a sampling frequency N_{mc}, and the optimal division wₒₚₜ is acquired as the output of the algorithm.

In the initialization, the initial division wᵢₙᵢₜ is given by wᵢₙᵢₜ={w₊=□,w₋=Y}.

In the main routine, in step1, m is sampled according to a probability distribution ζ(m). For example, the probability distribution ζ(m) can be set to be a uniform distribution.

Next, in step2, the candidate w′ is sampled according to the proposed distribution q(w′|w) corresponding to the index m.

As the proposed distribution of a proposal algorithm, three types including “generation”, “disappearance” and “swap” are defined.

The index m=1 corresponds to “generation”, the index m=2 corresponds to “disappearance”, and the index m=3 corresponds to “swap”.

Next, in step3, u is sampled from the uniform distribution Unif[0 1].

In next step4, the candidate w′ is accepted or rejected on the basis of u and the acceptance probability A(w,w′).

The acceptance probability A(w,w′) is given by the following equation.

A(w,w′)=min(1,q(w|w′)L(w′|Y)/q(w′|w)L(w|Y))

Finally, in step5, the optimal wₒₚₜ that maximizes the likelihood function is stored.

Hereafter, the details of the proposed distribution q(w′|w) will be mentioned.

### (A) Generation

One three-dimensional moving track y is selected from the set w₋, and is added to w₊.

At this time, a three-dimensional moving track which does not overlap the tracks in w₊ with respect to space is selected as y on a priority basis.

More specifically, when yεw₋, w={w₊,w₋}, and w′={{w₊+y}, {w₋−y}}, the proposed distribution is given by the following equation.

q(w′|w)∝ζ(1)exp(−c4Σ_{jεw+}O(y,yⱼ))

where O(y,yⱼ) is the above-mentioned overlap cost, and has a value of “1” when the tracks y and yⱼ overlap each other perfectly, whereas O(y,yⱼ) has a value of “0” when the tracks y and yⱼ do not overlap each other at all, and c4 is a positive constant.

### (B) Disappearance

One three-dimensional moving track y is selected from the set w₊, and is added to w₋.

At this time, a three-dimensional moving track which overlaps another track in w₊ with respect to space is selected as y on a priority basis.

More specifically, when yεw₊, w={w₊,w₋}, and w′={{w₊−y}, {w₋+y}}, the proposed distribution is given by the following equation.

q(w′|w)∝ζ(2)exp(c5Σ_{jεw+}O(y,yⱼ))

When w₊ is an empty set, the proposed distribution is shown by the following equation.

q(w′|w)=1 (if w′=w),q(w′|w)=0 (otherwise)

where c5 is a positive constant.

### (C) Swap

A three-dimensional moving track having a high stereo cost is interchanged with a three-dimensional moving track having a low stereo cost.

More specifically, one three-dimensional moving track y is selected from the set w₊ and one three-dimensional moving track z is selected from the set w₋, and the three-dimensional moving track y is interchanged with the three-dimensional moving track z.

Concretely, one three-dimensional moving track having a high stereo cost is selected first as the three-dimensional moving track y on a priority basis.

Next, one three-dimensional moving track which overlaps the three-dimensional moving track y and which has a low stereo cost is selected as the three-dimensional moving track z on a priority basis.

More specifically, assuming yεw₊, zεw₋, and w′={{w₊−y+z}, {w₋+y−z}}, p(y|w)□∝exp(c6 S(y)), and p(z|w,y)∝exp(−c6 S(z) exp(c7 O(z,y))), the proposed distribution is given by the following equation.

q(w′|w)∝ζ(3)×p(z|w,y)p(y|w)

where c6 and c7 are positive constants.

After determining the movement history of each individual person in the above-mentioned way, the video analysis unit 3 provides the movement history to a group management system (not shown) which manages the operations of two or more elevators.

As a result, the group management system becomes possible to carry out optimal group control of the elevators at all times according to the movement history acquired from each elevator.

Furthermore, the video analysis unit 3 outputs the movement history of each individual person, etc. to the image analysis result display unit 4 as needed.

When receiving the movement history of each individual person, etc. from the video analysis unit 3, the image analysis result display unit 4 displays the movement history of each individual person, etc. on a display (not shown).

Hereafter, the process carried out by the image analysis result display unit 4 will be explained concretely.

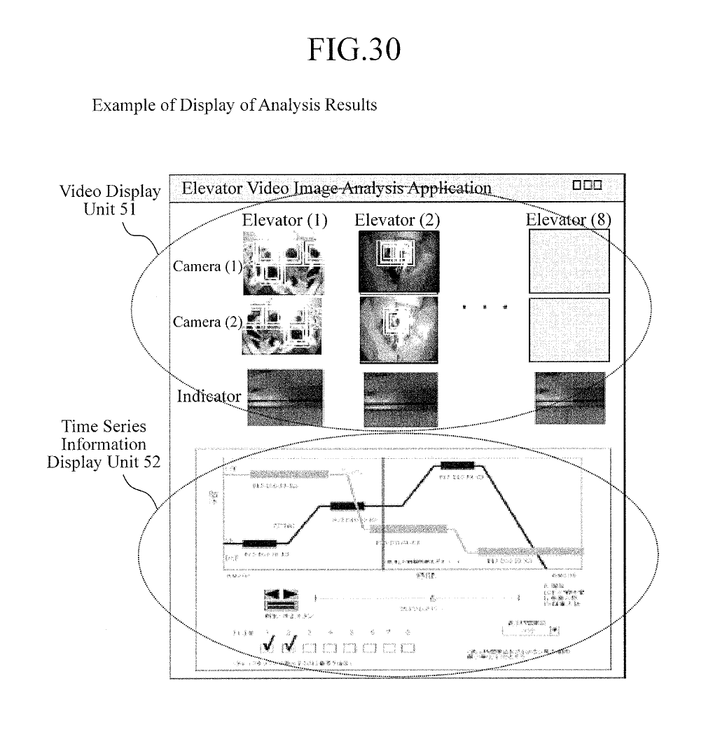

FIG. 30 is an explanatory drawing showing an example of a screen display produced by the image analysis result display unit 4.

As shown in FIG. 30, a main screen of the image analysis result display unit 4 is comprised of a screen produced by the video display unit 51 which displays the video images captured by the plurality of cameras 1, and a screen produced by the time series information display unit 52 which carries out graphical representation of the person movement history in time series.

The video display unit 51 of the image analysis result display unit 4 synchronously displays the video images of the inside of the elevator cage captured by the plurality of cameras 1 (the video image captured by the camera (1), the video image captured by the camera (2), the video image of the indicator for floor recognition), and the analysis results acquired by the video analysis unit 3, and displays the head detection results, the two-dimensional moving tracks, etc. which are the analysis results acquired by the video analysis unit 3 while superimposing them onto each of the video images.

Because the video display unit 51 thus displays the plurality of video images synchronously, a user, such as a building maintenance worker, can know the states of the plurality of elevators simultaneously, and can also grasp the image analysis results including the head detection results and the two-dimensional moving tracks visually.

The time series information display unit 52 of the image analysis result display unit 4 forms the person movement history and cage movement histories which are determined by the three-dimensional moving track calculating unit 46 of the person tracking unit 13 into a time-series graph, and displays this time-series graph in synchronization the video images.

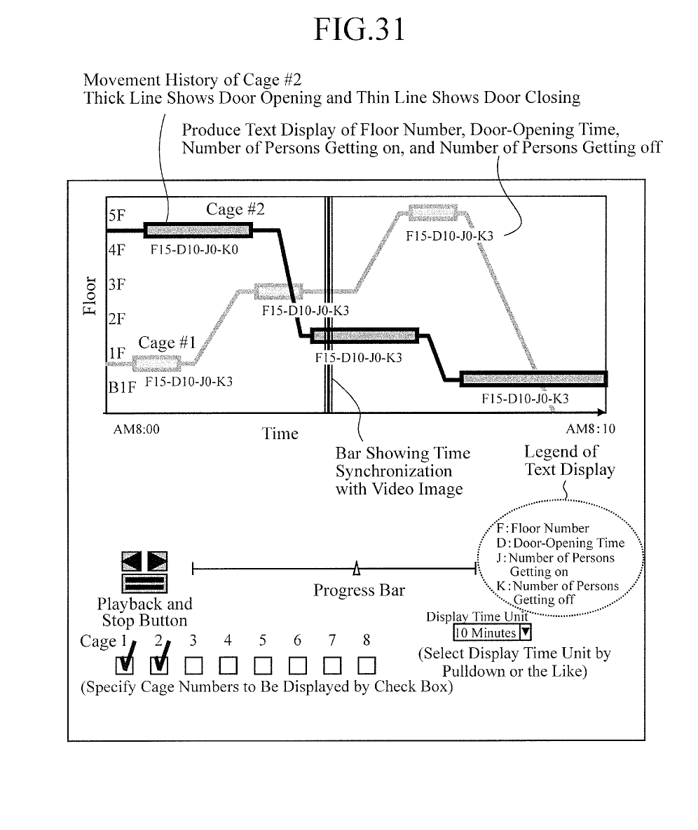

FIG. 31 is an explanatory drawing showing a detailed example of the screen display produced by the time series information display unit 52.

In FIG. 31 in which the horizontal axis shows the time and the vertical axis shows the floors, the time series information display unit carries out graphical representation of the movement history of each elevator (cage) in time series.

In the screen example of FIG. 31, the time series information display unit 52 displays a user interface including a video image playback and stop button for allowing the user to play back and stop a video image, a video image progress bar for enabling the user to seek a video image at random, a check box for allowing the user to select the number of one or more cages to be displayed, and a pulldown button for allowing the user to select a display time unit.

Furthermore, the time series information display unit displays a bar showing time synchronization with the video image being displayed on the graph, and expresses each time period during which an elevator's door is open with a thick line.

Furthermore, in the graph, a text “F15-D10-J0-K3” showing the floor on which the corresponding elevator is located, the door opening time of the elevator, the number of persons who have got on the elevator, and the number of persons who have got off the elevator is displayed in the vicinity of each thick line showing the corresponding door opening time.

This text “F15-D10-J0-K3” is a short summary showing that the floor where the elevator cage is located is the 15th floor, the door opening time is 10 seconds, the number of persons who have got on the elevator is zero, and the number of persons who have got off the elevator is three.

Because the time series information display unit 52 thus displays the image analysis results in time series, the user, such as a building maintenance worker, can know visually a temporal change of information including the number of persons who have got on each of a plurality of elevators, the number of persons who have got off each of the plurality of elevators, the door opening and closing times of each of the plurality of elevators, etc.

The summary display unit 53 of the image analysis result display unit 4 acquires statistics on the person movement histories calculated by the three-dimensional moving track calculating unit 46, and lists, as statistic results of the person movement histories, the number of persons who have got on each of the plurality of cages on each floor in a certain time zone and the number of persons who have got off each of the plurality of cages on each floor in the certain time zone.

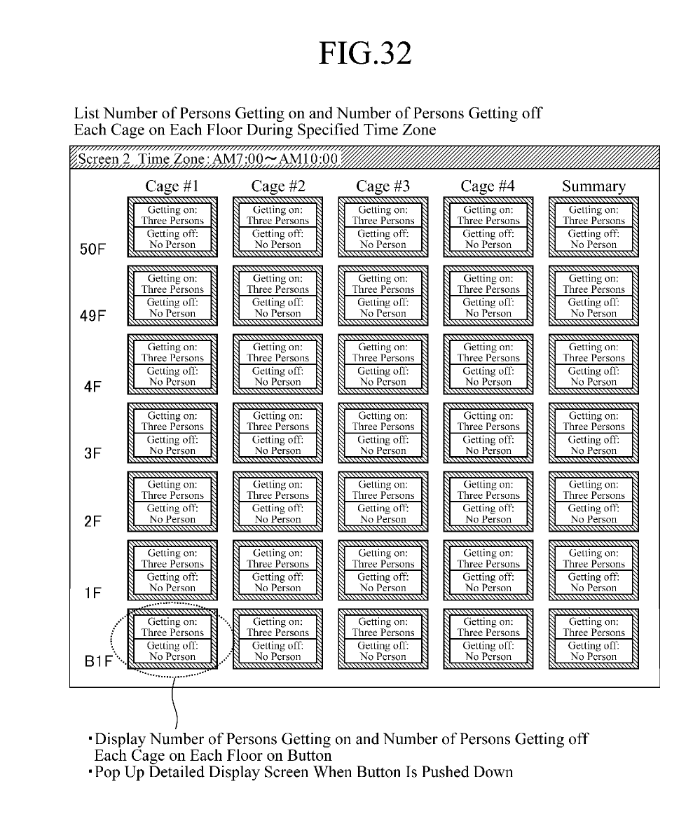

FIG. 32 is an explanatory drawing showing an example of a screen display produced by the summary display unit 53. In FIG. 32, the vertical axis shows the floors and the horizontal axis shows the cage numbers, and the number of persons who have got on each of the plurality of cages on each floor in a certain time zone (in the example of FIG. 32, a time zone from AM 7:00 to AM 10:00) and the number of persons who have got off each of the plurality of cages on each floor in the certain time zone are displayed.

Because the summary display unit 53 thus lists the number of persons who have got on each of the plurality of cages on each floor in a certain time zone and the number of persons who have got off each of the plurality of cages on each floor in the certain time zone, the user can grasp the operation states of all the elevators of a building at a glance.

In the screen example of FIG. 32, each portion showing the number of persons who have got on the corresponding cage on a floor and the number of persons who have got off the cage on the floor is a button, and, when the user pushes down each button, a detailed screen display which is produced by the operation related information display unit 54 and which corresponds to the button can be popped up.

The operation related information display unit 54 of the image analysis result display unit 4 displays detailed information about the person movement histories with reference to the person movement histories calculated by the three-dimensional moving track calculating unit 46. More specifically, for a specified time zone, a specified floor, and a specified elevator cage number, the operation related information display unit displays detailed information about the elevator operation including the number of persons who have moved from the specified floor to other floors, the number of persons who have moved to the specified floor from the other floors, the passenger waiting time, etc.

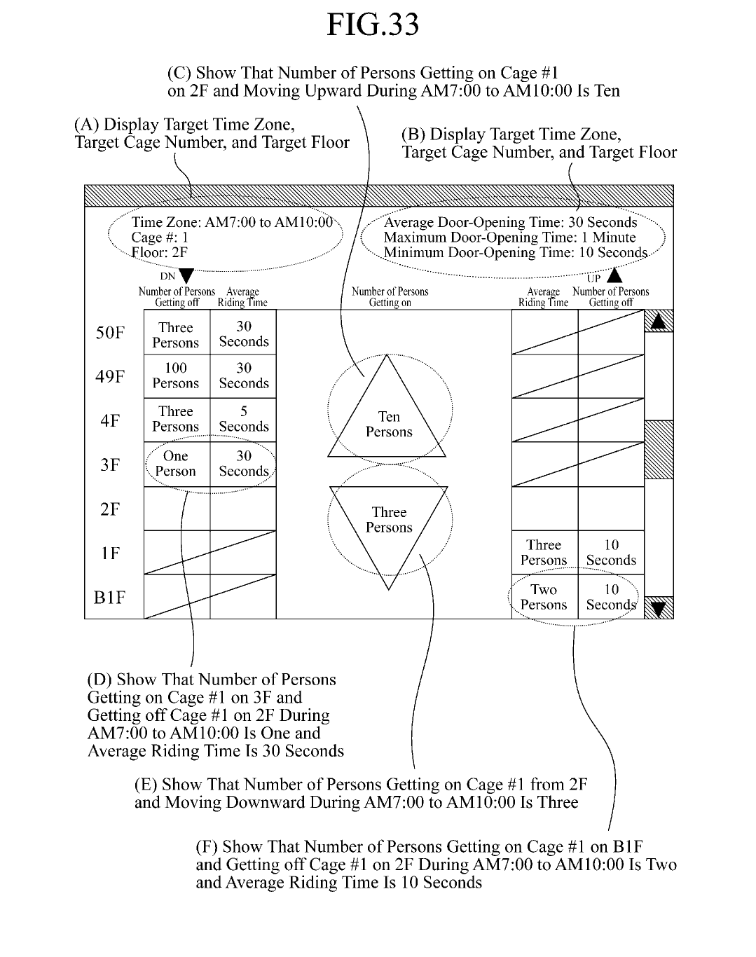

FIG. 33 is an explanatory drawing showing an example of a screen display produced by the operation related information display unit 54.

In regions (A) to (F) of the screen of FIG. 33, the following pieces of information are displayed.

(A): Display the specified time zone, the specified cage number, and the specified floor.

(B): Display the specified time zone, the specified cage number, and the specified floor.

(C): Display that the number of persons getting on cage #1 on 2F and moving upward during AM7:00 to AM10:00 is ten

(D): Display that number of persons getting on cage #1 on 3F and getting off cage #1 on 2F during AM7:00 to AM10:00 is one and average riding time is 30 seconds

(E): Display that number of persons getting on cage #1 from 3F and moving downward during AM7:00 to AM10:00 is three

(F): Display that number of persons getting on cage #1 on B1F and getting off cage #1 on 2F during AM7:00 to AM10:00 is two and average riding time is 10 seconds

By thus displaying the detailed information about the analyzed person movement histories, the operation related information display unit 54 enables the user to browse individual information about each floor and individual information about each cage, and analyze the details of a cause, such as a malfunction of the operation of an elevator.

The sorted data display unit 55 sorts and displays the person movement histories calculated by the three-dimensional moving track calculating unit 46. More specifically, the sorted data display unit sorts the data about the door opening times, the number of persons who have got on each elevator and the number of persons who have got off each elevator (the number of persons getting on or off), the waiting times, or the like by using the analysis results acquired by the video analysis unit 3, and displays the data in descending or ascending order of their ranks.

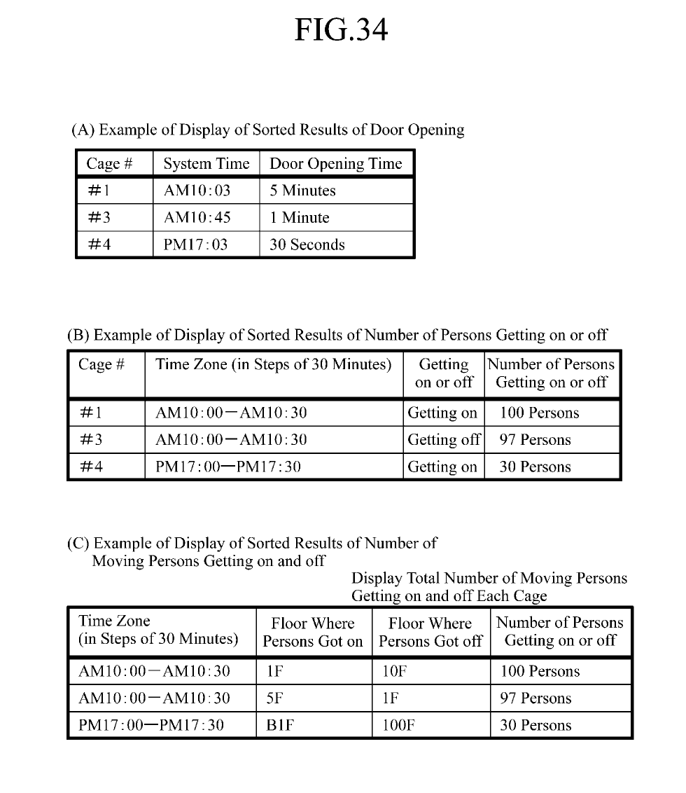

FIG. 34 is an explanatory drawing showing an example of a screen display produced by the sorted data display unit 55.

In the example of FIG. 34(A), the sorted data display unit 55 sorts the analysis results acquired by the video analysis unit 3 by using “door opening time” as a sort key, and displays the data in descending order of the door opening time.

Furthermore, in the example of FIG. 34(A), the sorted data display unit displays the data about “cage number (#)”, system time (video image record time), and “door opening time” simultaneously.

In the example of FIG. 34(B), the sorted data display unit 55 sorts the analysis results acquired by the video analysis unit 3 by using the number of persons getting on or off” as a sort key, and displays the data in descending order of “the number of persons getting on or off”.

Furthermore, in the example of FIG. 34(A), the sorted data display unit displays the data about “cage (#)”, “time zone (e.g., in steps of 30 minutes)”, “getting on or off (flag showing getting on or off)”, and “the number of persons getting on or off” simultaneously.

In the example of FIG. 34(C), the sorted data display unit 55 sorts the analysis results acquired by the video analysis unit 3 by using “the number of moving persons getting on and off” as a sort key, and displays the data in descending order of “the number of moving persons getting on and off”.

Furthermore, in the example of FIG. 34(C), the sorted data display unit displays the data about “time zone (e.g., in steps of 30 minutes)”, “floor where persons have got on”, “floor where persons have got off”, and “the number of persons getting on or off”.

Because the sorted data display unit 55 thus displays the sorted data, the person tracking device enables the user to, for example, find out a time zone in which an elevator's door is open unusually and then refer to a video image and analysis results which were acquired in the same time zone to track the malfunction to its source.

As can be seen from the above description, the person tracking device in accordance with this Embodiment 1 is constructed in such a way that the person tracking device includes the person position calculating unit 44 for analyzing video images of an area to be monitored which are shot by the plurality of cameras 1 to determine a position on each of the video images of each individual person existing in the area to be monitored, and the two-dimensional moving track calculating unit 45 for calculating a two-dimensional moving track of each individual person in each of the video images by tracking the position on each of the video images calculated by the person position calculating unit 44, and the three-dimensional moving track calculating unit 46 carries out stereo matching among the two-dimensional moving tracks in the video images calculated by the two-dimensional moving track calculating unit 45 to calculate the degree of match between a two-dimensional moving track in each of the video images and a two-dimensional moving track in another one of the video images, and then calculates a three-dimensional moving track of each individual person from two-dimensional moving tracks each having a degree of match equal to or larger than a specific value. Therefore, the present embodiment offers an advantage of being able to track correctly each person existing in the area to be monitored even in a situation in which the area to be monitored is crowded greatly.

More specifically, while in a narrow crowded area, such an elevator cage, it is difficult for a conventional person tracking device to carry out detection and tracking of each person because a person may be shaded by another person, the person tracking device in accordance with this Embodiment 1 can determine a correct three-dimensional moving track of each individual person and can estimate the number of persons in the area to be monitored by listing a plurality of three-dimensional moving track candidates and determining a combination of three-dimensional moving track candidates which maximizes the cost function which takes into consideration a positional relationship among persons, the number of persons, the accuracy of the stereoscopic vision, etc. even when there exists a three-dimensional moving track which is determined erroneously because of shading of a person by something else.

Furthermore, even when a three-dimensional moving track graph has a very complicated structure and there is a huge number of combinations of three-dimensional moving track candidates each extending from an entrance to the cage to an exit from the cage, the track combination estimating unit 50 determines an optimal combination of three-dimensional moving tracks by using a probabilistic optimization technique such as MCMC or GA. Therefore, the person tracking device in accordance with this embodiment can determine the combination of three-dimensional moving tracks within a realistic processing time period. As a result, even in a situation in which the area to be monitored is crowded greatly, the person tracking device can detect each individual person in the area to be monitored correctly and also can track each individual person correctly.

Furthermore, because the image analysis result display unit 4 shows the video images captured by the plurality of cameras 1 and the image analysis results acquired by the video analysis unit 3 in such a way that the video images and the image analysis results are visible to the user, the user, such as a building maintenance worker or a building owner, can grasp the operation state and malfunctioned parts of each elevator easily, and can bring efficiency to the operation of each elevator and perform maintenance work of each elevator smoothly.

In this Embodiment 1, the example in which the image analysis result display unit 4 displays the video images captured by the plurality of cameras 1 and the image analysis results acquired by the video analysis unit 3 on the display (not shown) is shown. As an alternative, the image analysis result display unit 4 can display the video images captured by the plurality of cameras 1 and the image analysis results acquired by the video analysis unit 3 on a display panel installed in each floor outside each elevator cage and a display panel disposed in each elevator cage to provide information about the degree of crowdedness of each elevator cage for passengers.

Accordingly, each passenger can grasp when he or she should gen on which elevator cage from the degree of crowdedness of each elevator cage.

Furthermore, in this Embodiment 1, although the case in which the area to be monitored is the inside of each elevator cage is explained, this case is only an example. For example, this embodiment can be applied to a case in which the inside of a train is defined as the area to be monitored and the degree of crowdedness or the like of the train is measured.

This embodiment can be also applied to a case in which an area with a high need for security is defined as the area to be monitored and each person's movement history is determined to monitor a doubtful person's action.

Furthermore, this embodiment can be applied to a case in which a station, a store, or the like is defined as the area to be monitored and each person's moving track is analyzed to be used for marketing or the like.

In addition, this embodiment can be applied to a case in which each landing of an escalator is defined as the area to be monitored and the number of persons existing in each landing is counted, and, when one landing of the escalator is crowded, the person tracking device carries out appropriate control, such as a control operation of slowing down or stopping the escalator, for example, to prevent an accident, such as an accident where people fall over like dominoes on the escalator, from occurring.

### Embodiment 2

The person tracking device in accordance with above-mentioned Embodiment 1 searches through a plurality of three-dimensional moving track graphs to calculate three-dimensional moving track candidates which satisfy the entrance and exit criteria, lists three-dimensional moving track candidates each extending from an entrance to the elevator cage to an exit from the cage, and determines an optimal combination of three-dimensional moving track candidates by maximizing the cost function in a probabilistic manner by using a probabilistic optimization technique such as MCMC. However, when each three-dimensional moving track graph has a complicated structure, the number of three-dimensional moving track candidates which satisfy the entrance and exit criteria becomes large astronomically, and the person tracking device in accordance with above-mentioned Embodiment 1 may be unable to carry out the processing within a realistic time period.

To solve this problem, a person tracking device in accordance with this Embodiment 2 labels the vertices of each three-dimensional moving track graph (i.e., the three-dimensional each moving tracks which construct each graph) to estimate an optimal combination of three-dimensional moving tracks within a realistic time period by maximizing a cost function which takes entrance and exit criteria into consideration in a probabilistic manner.

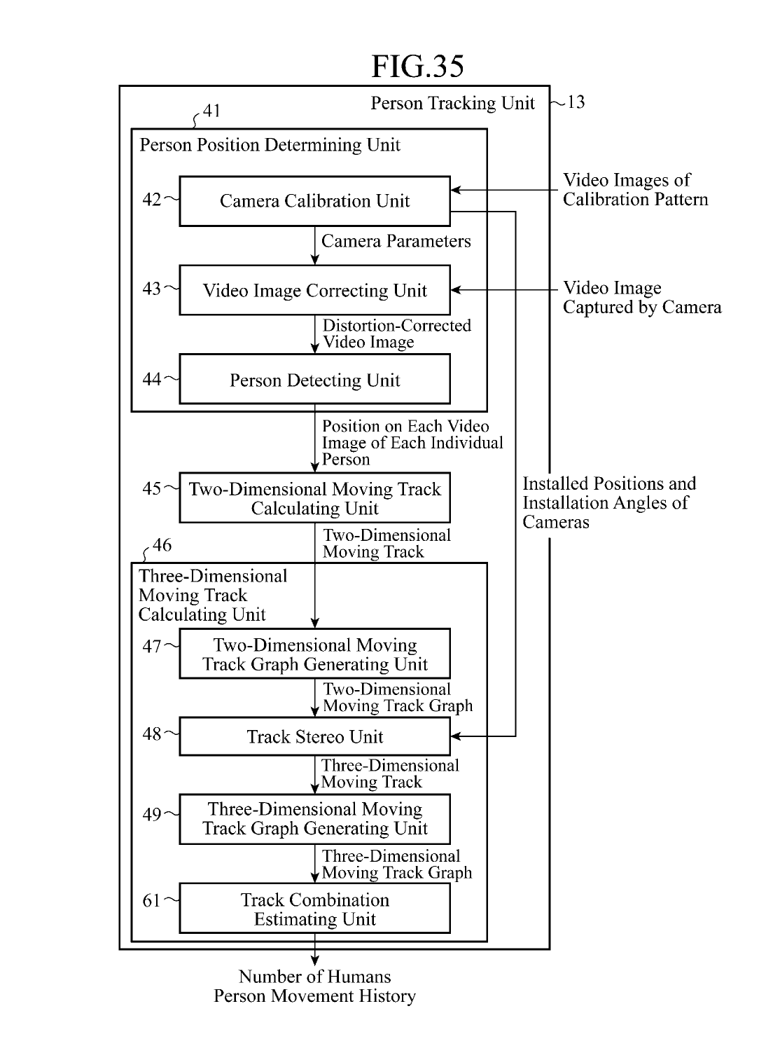

FIG. 35 is a block diagram showing the inside of a person tracking unit 13 of the person tracking device in accordance with Embodiment 2 of the present invention. In the figure, because the same reference numerals as those shown in FIG. 4 denote the same components as those shown in the figure or like components, the explanation of these components will be omitted hereafter.

A track combination estimating unit 61 carries out a process of determining a plurality of candidates for labeling by labeling the vertices of each three-dimensional moving track graph generated by a three-dimensional moving track graph generating unit 49, and selecting an optimal candidate for labeling from among the plurality of candidates for labeling to estimate the number of persons existing in the area to be monitored.

Next, the operation of the person tracking device will be explained.

Because the person tracking device in accordance with this embodiment has the same structure as that in accordance with above-mentioned Embodiment 1, with the exception that the track combination estimating unit 50 is replaced by the track combination estimating unit 61, only the operation of the track combination estimating unit 61 will be explained.

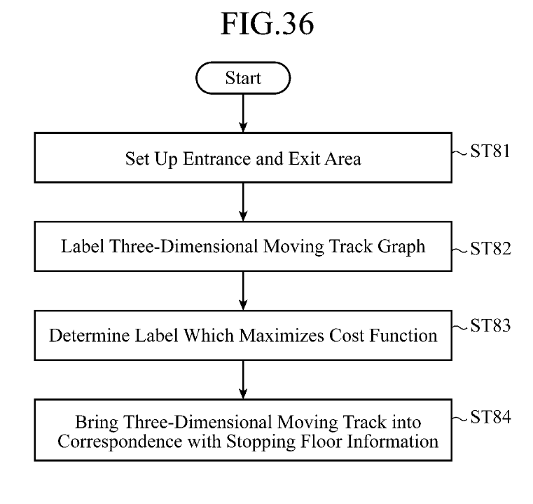

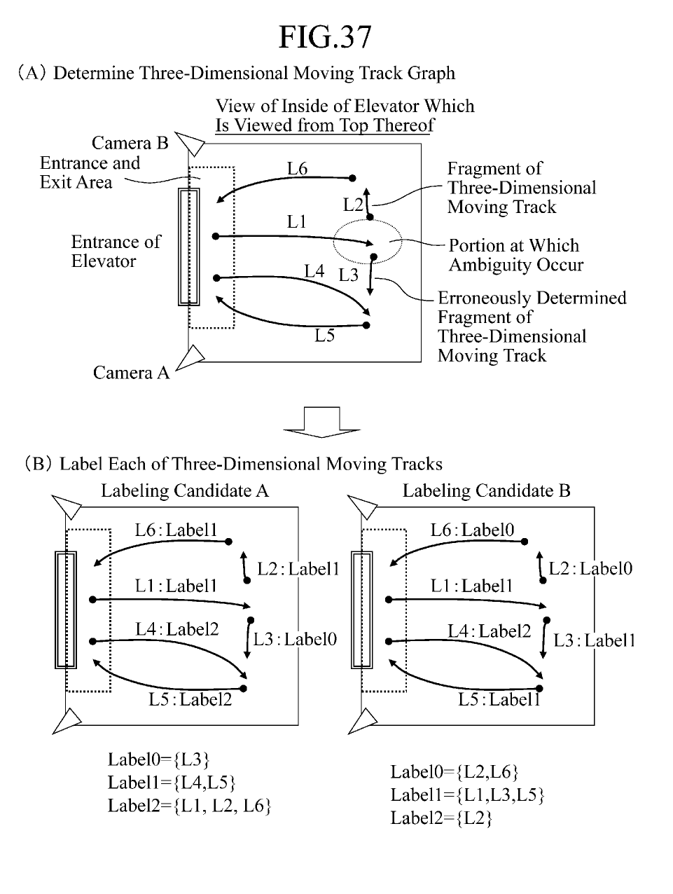

FIG. 36 is a flow chart showing a process carried out by the track combination estimating unit 61, and FIG. 37 is an explanatory drawing showing the process carried out by the track combination estimating unit 61.

First, the track combination estimating unit 61 sets up an entrance and exit area for persons at a location in the area to be monitored (step ST81), like the track combination estimating unit 50 of FIG. 4.

In the example of FIG. 37(A), the track combination estimating unit 61 sets up an entrance and exit area in the vicinity of the entrance of the elevator cage virtually.

Next, the track combination estimating unit 61 labels the vertices of each three-dimensional moving track graph generated by the three-dimensional moving track graph generating unit 49 (i.e., the three-dimensional moving tracks which construct each graph) to calculate a plurality of candidates for labeling (step ST82).

In this case, the track combination estimating unit 61 can search through the three-dimensional moving track graph thoroughly to list all possible candidates for labeling. The track combination estimating unit 61 can alternatively select only a predetermined number of candidates for labeling at random when there are many candidates for labeling.

Concretely, the track combination estimating unit determines a plurality of candidates for labeling as follows.

As shown in FIG. 37(A), it is assumed that a three-dimensional moving track graph having the following information is acquired.
Set of three-dimensional moving tracks connected to L1={L2, L3}
Set of three-dimensional moving tracks connected to L2={L6}
Set of three-dimensional moving tracks connected to L3={L5}
Set of three-dimensional moving tracks connected to L4={L5}
Set of three-dimensional moving tracks connected to L5={□(empty set)}
Set of three-dimensional moving tracks connected to L6={□(empty set)}
   where L2 is assumed to be a three-dimensional moving track which is determined erroneously due to a failure to track the individual person's head or the like.

In this case, the track combination estimating unit 61 calculates candidates A and B for labeling as shown in FIG. 37(B) by labeling the three-dimensional moving track graph of FIG. 37(A).

For example, labels having label numbers from 0 to 2 are assigned to three-dimensional moving track fragments in the candidate A for labeling, respectively, as shown below.
Label 0={L3}
Label 1={L4, L5}
Label 2={L1, L2, L6}

In this case, it is defined that label 0 shows a set of three-dimensional moving tracks which does not belong any person (erroneous three-dimensional moving tracks), and label 1 or greater shows a set of three-dimensional moving tracks which belongs to an individual person.

In this case, the candidate A for labeling shows that two persons (label 1 and label 2) are existing in the area to be monitored, and a person (1)'s three-dimensional moving track is comprised of the three-dimensional moving tracks L4 and L5 to which label 1 is added and a person (2)'s three-dimensional moving track is comprised of the three-dimensional moving tracks L1, L2 and L6 to which label 2 is added.

Furthermore, labels having label numbers from 0 to 2 are added to three-dimensional moving track fragments in the candidate B for labeling, respectively, as shown below.
Label 0={L2, L6}
Label 1={L1, L3, L5}
Label 2={L4}

In this case, the candidate B for labeling shows that two persons (label 1 and label 2) are existing in the area to be monitored, and the person (1)'s three-dimensional moving track is comprised of the three-dimensional moving tracks L1, L3 and L5 to which label 1 is added and the person (2)'s three-dimensional moving track is comprised of the three-dimensional moving track L4 to which label 2 is added.

Next, the track combination estimating unit 61 calculates a cost function which takes into consideration the number of persons, a positional relationship among the persons, the accuracy of stereoscopic vision, entrance and exit criteria for the area to be monitored, etc. for each of the plurality of candidates for labeling to determine a candidate for labeling which maximizes the cost function and calculate an optimal three-dimensional moving track of each individual person and the number of persons (step ST83).

As the cost function, such a cost as shown below is defined:

Cost=“the number of three-dimensional moving tracks which satisfy the entrance and exit criteria”

In this case, the entrance criteria and the exit criteria which are described in above-mentioned Embodiment 1 are used as the entrance and exit criteria, for example.

In the case of FIG. 37(B), in the candidate A for labeling, the three-dimensional moving tracks with label 1 and the three-dimensional moving tracks with label 2 satisfy the entrance and exit criteria.

In the candidate B for labeling, only the three-dimensional moving tracks with label 1 satisfy the entrance and exit criteria.

Therefore, because the candidates A and B for labeling have costs as shown below, the candidate A for labeling is the one whose cost function is a maximum and the candidate A for labeling is determined as labeling of an optimal three-dimensional moving track graph.

Therefore, it is also estimated simultaneously that two persons have been moving in the elevator cage.
The Cost of the candidate A for labeling=2
The Cost of the candidate B for labeling=1

After selecting a candidate for labeling whose cost function is a maximum and then calculating an optimal three-dimensional moving track of each individual person, the track combination estimating unit 61 then brings the optimal three-dimensional moving track of each individual person into correspondence with floors specified by a floor recognition unit 12 (stopping floor information showing stopping floors of the elevator), and calculates a person movement history showing the floor where each individual person has got on the elevator and the floor where each individual person has got off the elevator (a movement history of each individual person showing “how many persons have got on the elevator on which floor and how many persons have got off the elevator on which floor”) (step ST84).

In this embodiment, although the example in which the track combination estimating unit brings each of the three-dimensional moving tracks into correspondence with the floor information specified by the floor recognition unit 12 is shown, the track combination estimating unit can alternatively acquire stopping floor information from control equipment for controlling the elevator, and can bring each of the three-dimensional moving tracks into correspondence with the stopping floor information independently.

However, when there are many persons getting on and off the elevator cage on each floor and each three-dimensional moving track graph has a complicated structure, the labeling of each three-dimensional moving track graph produces many possible sets of labels, and the track combination estimating unit may become impossible to actually calculate the cost function for each of all the sets of labels.

In such a case, the track combination estimating unit 61 can carry out the labeling process of labeling each three-dimensional moving track graph by using a probabilistic optimization technique, such as MCMC or GA.

Hereafter, the labeling process of labeling each three-dimensional moving track graph will be explained concretely.

### [Model]

After the three-dimensional moving track graph generating unit 49 generates a three-dimensional moving track graph, the track combination estimating unit 61 defines the set of vertices of the three-dimensional moving track graph, i.e., a set of each person's three-dimensional moving tracks as

Y={yᵢ}_{i=1, . . . ,N}.

where N is the number of three-dimensional moving tracks. The track combination estimating unit also defines a state space w as follows.

w={τ_{O},τ₁,τ₂, . . . ,τ_{K}}

where τ₀ is a set of three-dimensional moving tracks yᵢ not belonging to any person, τᵢ the set of three-dimensional moving tracks yᵢ belonging to the i-th person's three-dimensional moving tracks, and K is the number of three-dimensional moving tracks (i.e., the number of persons).

τᵢ is comprised of a plurality of connected three-dimensional moving tracks, and can be assumed to be one three-dimensional moving track.

Furthermore, the following equations are satisfied.

□·U_{k=0, . . . ,K}τₖ=Y

□·τᵢ∩□τⱼ=□ (for all i≠j)

□·|τₖ|>1 (for all k)

At this time, the track combination estimating unit 61 is aimed at determining which set of three-dimensional moving tracks from τ₀ to τ_{K} the set Y of three-dimensional moving tracks belongs to. More specifically, this aim is equivalent to the problem of assigning labels from 0 to K to the elements of the set Y.

This aim can be formulized into the problem of defining a likelihood function L(w/Y) as a cost function, and maximizing this cost function.

More specifically, when an optimal track labeling is assumed to be wₒₚₜ, wₒₚₜ is given by the following equation.

wₒₚₜ=argmax L(w|Y)

In this case, the likelihood function L(w|Y) is defined as follows.

L(w|Y)=Lₒᵥᵣ(w|Y)Lₙᵤₘ(w|Y)Lₛₜᵣ(w|Y)

where Lₒᵥᵣ is a likelihood function in which “any two three-dimensional moving tracks do not overlap each other in the three-dimensional space” is formulized, Lₙᵤₘ is a likelihood function in which “as many three-dimensional moving tracks satisfying the entrance and exit criteria as possible exist” is formulized, and Lₛₜᵣ is a likelihood function in which “the accuracy of stereo vision of a three-dimensional moving track is high” is formulized.

Hereafter, the details of each of the likelihood functions will be mentioned.

### [The Likelihood Function Regarding an Overlap Between Tracks]

The criterion: “any two three-dimensional moving tracks do not overlap each other in the three-dimensional space” is formulized as follows.

Lₒᵥᵣ(w|Y)∝exp(−c1Σ_{τiεw-τ0}Σ_{τjεw-τ0}O(τᵢ,τⱼ))

where O(τᵢ,τⱼ) is the cost of an overlap between the three-dimensional moving track τᵢ and the three-dimensional moving track τᵢ. When the three-dimensional moving track τᵢ and the three-dimensional moving track τⱼ perfectly overlap each other, O(τᵢ,τⱼ) has a value of “1”, whereas when the three-dimensional moving track τᵢ and the three-dimensional moving track τⱼ do not overlap each other at all, O(τᵢ,τⱼ) has a value of “0”.

As O(τᵢ,τⱼ), O(yᵢ,yⱼ) which is explained in above-mentioned Embodiment 1 is used, for example. c1 is a positive constant.

### [The Likelihood Function Regarding the Number of Tracks]

The criterion: “as many three-dimensional moving tracks satisfying the entrance and exit criteria as possible exist.” is formulized as follows.

Lₙᵤₘ(w|Y)∝exp(c2×K+c3×J)

where K is the number of three-dimensional moving tracks, and is given by K=|w−τ₀|.

Furthermore, J shows the number of three-dimensional moving tracks which satisfy the entrance and exit criteria and which are included in the K three-dimensional moving tracks τ₁ to τ_{K}.

As the entrance and exit criteria, the ones which are explained in above-mentioned Embodiment 1 are used, for example.

The likelihood function Lₙᵤₘ(w|Y) works in such a way that as many three-dimensional moving tracks as possible are selected from the set Y, and the selected three-dimensional moving tracks include as many three-dimensional moving tracks satisfying the entrance and exit criteria as possible. c2 and c3 are positive constants.

### [The Likelihood Function Regarding the Accuracy of Stereo Vision of the Tracks]

The criterion: “the accuracy of stereo vision of a three-dimensional moving track is high.” is formulized as follows.

Lₛₜᵣ(w|Y)∝exp(−c4×Σ_{τiεw-τ0}S(τᵢ))

where S(τᵢ) is a stereo cost, and when a three-dimensional moving track is estimated by using the stereo vision, S(τᵢ) of the three-dimensional moving track has a small value, whereas when a three-dimensional moving track is estimated by using monocular vision or when a three-dimensional moving track has a time period during which it is not observed by any camera, S(τᵢ) of the three-dimensional moving track has a large value.

For example, as a method of calculating the stereo cost S(τᵢ), the one which is explained in above-mentioned Embodiment 1 is used. c4 is a positive constant.

Each of the likelihood functions which are defined as mentioned above can be optimized by using a probabilistic optimization technique, such as MCMC or GA.

As can be seen from the above description, because the person tracking device in accordance with this Embodiment 2 is constructed in such a way that the track combination estimating unit 61 calculates a plurality of candidates for labeling by labeling the directed sides of each three-dimensional moving track graph generated by the three-dimensional moving track graph generating unit 49, selects an optimal candidate for labeling from among the plurality of candidates for labeling, and estimates the number of persons existing in the area to be monitored, this Embodiment 2 provides an advantage of being able to estimate each person's optimal (or semi-optimal) three-dimensional moving track and the number of persons within a realistic time period even when there are an astronomical number of three-dimensional moving track candidates which satisfy the entrance and exit criteria.

### Embodiment 3

The person tracking device in accordance with above-mentioned Embodiment 2 labels the vertices of each three-dimensional moving track graph (the three-dimensional each moving tracks which construct each graph) and maximizes a cost function which takes into consideration the entrance and exit criteria in a probabilistic manner to estimate an optimal combination of three-dimensional moving tracks within a realistic time period. However, when the number of persons in each video image increases, and each two-dimensional moving track graph has a complicated structure, there is a case in which the number of candidates for three-dimensional moving track fragments which are acquired as results of the stereoscopic vision increases astronomically, and the person tracking device cannot complete the processing within a realistic time period even when using the method in accordance with Embodiment 2.

To solve this problem, a person tracking device in accordance with this Embodiment 3 labels the vertices of each two-dimensional moving track graph (the two-dimensional moving tracks which construct each graph) in a probabilistic manner, performs stereoscopic vision on three-dimensional moving tracks according to the labels respectively assigned to the two-dimensional moving tracks and evaluates a cost function which takes into consideration the entrance and exit criteria for each of the three-dimensional moving tracks to estimate an optimal three-dimensional moving track within a realistic time period.

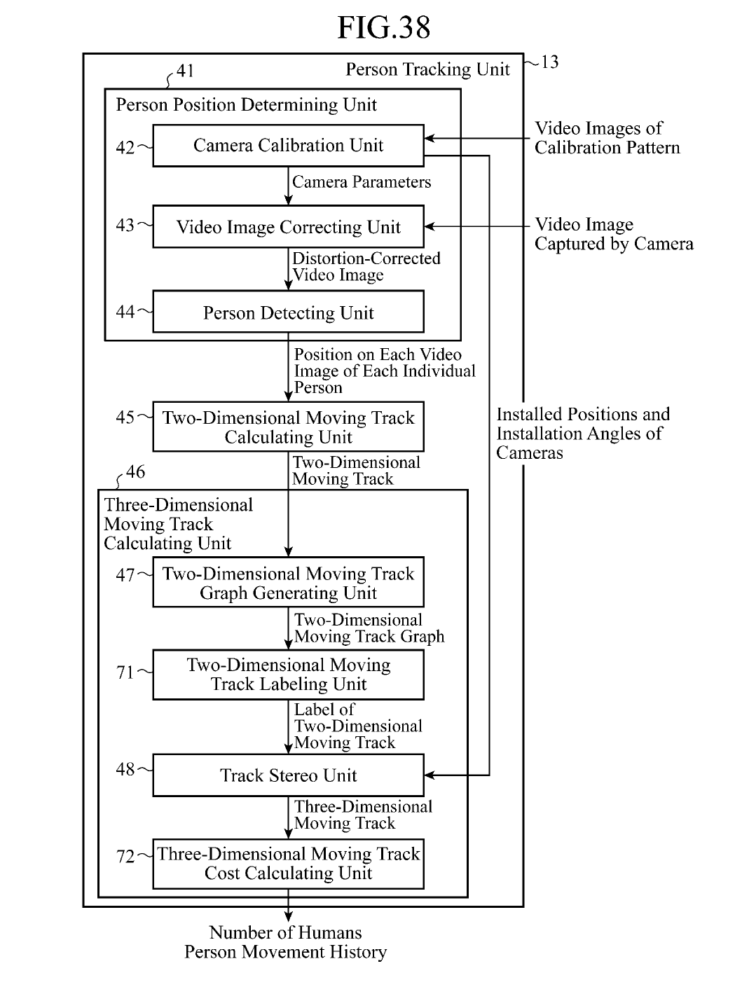

FIG. 38 is a block diagram showing the inside of a person tracking unit 13 of the person tracking device in accordance with Embodiment 3 of the present invention. In the figure, because the same reference numerals as those shown in FIG. 4 denote the same components as those shown in the figure or like components, the explanation of these components will be omitted hereafter. In FIG. 38, a two-dimensional moving track labeling unit 71 and a three-dimensional moving track cost calculating unit 72 are added.

The two-dimensional moving track labeling unit 71 carries out a process of determining a plurality of candidates for labeling by labeling the directed sides of each two-dimensional moving track graph generated by a two-dimensional moving track graph generating unit 47. The three-dimensional moving track cost calculating unit 72 carries out a process of calculating a cost function regarding a combination of three-dimensional moving tracks, and selecting an optimal candidate for labeling from among the plurality of candidates for labeling to estimate the number of persons existing in an area to be monitored.

Next, the operation of the person tracking device will be explained.

The two-dimensional moving track labeling unit 71 and the three-dimensional moving track cost calculating unit 72, instead of the three-dimensional moving track graph generating unit 49 and the track combination estimating unit 50, are added to the components of the person tracking device in accordance with above-mentioned Embodiment 1. Because the other structural components of the person tracking device are the same as those of the person tracking device in accordance with above-mentioned Embodiment 1, the operation of the person tracking device will be explained hereafter, focusing on the operation of the two-dimensional moving track labeling unit 71 and that of the three-dimensional moving track cost calculating unit 72.

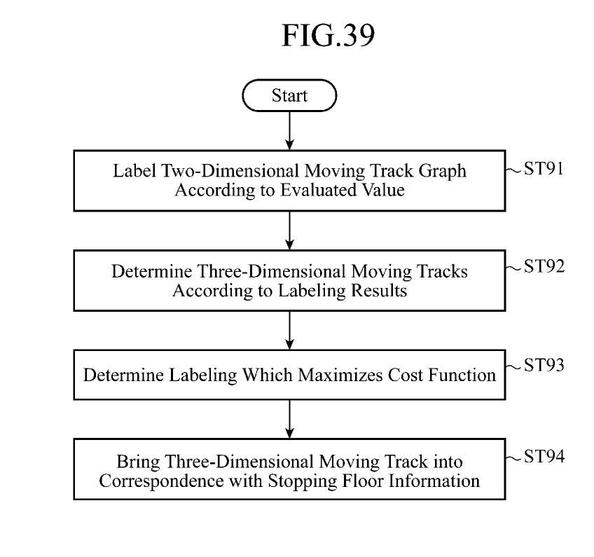

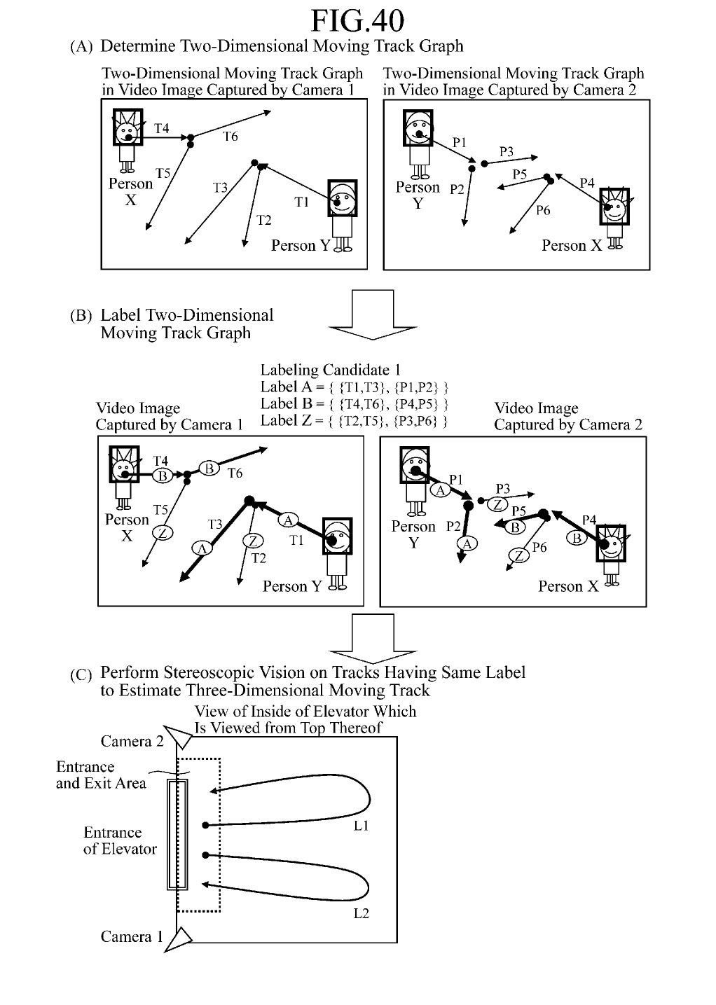

FIG. 39 is a flow chart showing a process carried out by the two-dimensional moving track labeling unit 71 and a process carried out by the three-dimensional moving track cost calculating unit 72, and FIG. 40 is an explanatory drawing showing the process carried out by the two-dimensional moving track labeling unit 71 and the process carried out by the three-dimensional moving track cost calculating unit 72.

First, the two-dimensional moving track labeling unit 71 calculates a plurality of candidates for labeling for each two-dimensional moving track graph generated by the two-dimensional moving track graph generating unit 47 by labeling the vertices of each two-dimensional moving track graph (the two-dimensional moving tracks which construct each graph) (step ST91). In this case, the two-dimensional moving track labeling unit 71 can search through each two-dimensional moving track graph thoroughly to list all possible candidates for labeling. The two-dimensional moving track labeling unit 71 can alternatively select only a predetermined number of candidates for labeling at random when there are many candidates for labeling.

Concretely, the two-dimensional moving track labeling unit determines a plurality of candidates for labeling as follows.

As shown in FIG. 40(A), it is assumed that persons X and Y exist in the target area, and a two-dimensional moving track graph having the following information is acquired.

A video image captured by a camera 1
Set of two-dimensional moving tracks connected to a two-dimensional moving track T1={T2, T3}
Set of two-dimensional moving tracks connected to a two-dimensional moving track T4={T5, T6}
   A video image captured by a camera 2
Set of two-dimensional moving tracks connected to a two-dimensional moving track P1={P2, P3}
Set of two-dimensional moving tracks connected to a two-dimensional moving track P4={P5, P6}

In this case, the two-dimensional moving track labeling unit 71 performs labeling on each two-dimensional moving track graph shown in FIG. 40(A) to estimate each person's moving track and the number of persons (refer to FIG. 40(B)). For example, for a candidate 1 for labeling, labels A to C are assigned to the two-dimensional moving tracks in the camera images, as shown below.

### [Candidate 1 for Labeling]

Label A={{T1, T3}, {P1, P2}}
Label B={{T4, T6}, {P4, P5}}
Label Z={{T2, T5}, {P3, P6}}

In this case, the candidate 1 for labeling is interpreted as follows. The candidate 1 for labeling shows that two person persons (corresponding to the labels A and B) exist in the area to be monitored, and the person Y's two-dimensional moving track is comprised of the two-dimensional moving tracks T1, T3, P1, and P2 to which the label A is assigned. The candidate 1 for labeling also shows that the person X's two-dimensional moving track is comprised of the two-dimensional moving tracks T4, T6, P4, and P5 to which the label B is assigned. In this case, the label Z is defined as a special label, and shows that T2, T5, P3, and P6 to which the label Z is assigned are an erroneously-determined set of two-dimensional moving tracks which belong to something which is not a human being.

In this case, although only the three labels A, B, and Z are used, the number of labels used is not limited to three and can be increased arbitrarily as needed.

After the two-dimensional moving track labeling unit 71 generates a plurality of candidates for labeling for each two-dimensional track graph, the track stereo unit 48 carries out stereo matching between a two-dimensional moving track candidate labeled with a number in each video image and a two-dimensional moving track labeled with the same number in any other video image by taking into consideration the installed positions and installation angles of the plurality of cameras 1 with respect to a reference point in the cage calculated by a camera calibration unit 42 to calculate the degree of match between the two-dimensional moving track candidates, and then calculates a three-dimensional moving track of each individual person (step ST92).

In the example of FIG. 40(C), the track stereo unit carries out stereo matching between the set {T1, T3} of two-dimensional moving tracks in the video image captured by the camera 1 to which the label A is assigned, and the set {P1, P2} of two-dimensional moving tracks in the video image captured by the camera 2 to which the label A is assigned to generate a three-dimensional moving track L1 with the label A. Similarly, the track stereo unit carries out stereo matching between the set {T4, T6} of two-dimensional moving tracks in the video image captured by the camera 1 to which the label B is assigned, and the set {P4, P5} of two-dimensional moving tracks in the video image captured by the camera 2 to which the label B is assigned to generate a three-dimensional moving track L2 with the label B.

Furthermore, because T2, T5, P3 and P6 to which the label Z is assigned are interpreted as tracks of something which is not a human being, the track stereo unit does not perform stereo matching on the tracks.

Because the other operation regarding the stereoscopic vision of two-dimensional moving tracks by the track stereo unit 48 is the same as that shown in Embodiment 1, the explanation of the other operation will be omitted hereafter.

Next, the three-dimensional moving track cost calculating unit 72 calculates a cost function which takes into consideration the number of persons, a positional relationship among the persons, the degree of stereo matching between the two-dimensional moving tracks, the accuracy of stereoscopic vision, the entrance and exit criteria for the area to be monitored, etc. for the sets of three-dimensional moving tracks in each of the plurality of candidates for labeling which are determined by the above-mentioned track stereo unit 48 to determine a candidate for labeling which maximizes the cost function and calculate an optimal three-dimensional moving track of each individual person and the number of persons (step ST93).

For example, as the simplest cost function, such a cost as shown below is defined.

Cost=“the number of three-dimensional moving tracks which satisfy the entrance and exit criteria”

In this case, the entrance criteria and the exit criteria which are described in above-mentioned Embodiment 1 are used as the entrance and exit criteria, for example. For example, in the case of FIG. 40(C), because the labels A and B correspond to three-dimensional moving tracks which satisfy the entrance and exit criteria in the candidate 1 for labeling, the cost of the candidate 1 for labeling is calculated as the cost=2.

As an alternative, as the cost function, such a cost defined as below can be used.

Cost=“the number of three-dimensional moving tracks which satisfy the entrance and exit criteria”−a×“the sum total of overlap costs each between three-dimensional moving tracks”+b×“the sum total of the degrees of match each between two-dimensional moving tracks”

where a and b are positive constants for establishing a balance among evaluated values. Furthermore, as the degree of match between two-dimensional moving tracks and the overlap cost between three-dimensional moving tracks, the ones which are explained in Embodiment 1 are used, for example.

Furthermore, when there are a large number of persons getting on and off and each two-dimensional moving track graph has a complicated structure, there is a case in which the two-dimensional moving track labeling unit 71 determines a large number of possible candidates for labeling for each two-dimensional moving track graph, and the three-dimensional moving track cost calculating unit therefore becomes impossible to actually calculate the cost function for all the labelings.

In such a case, the two-dimensional moving track labeling unit 71 generates candidates for labeling in a probabilistic manner by using a probabilistic optimization technique, such as MCMC or GA, and then determines an optimal or semi-optimal three-dimensional moving track so as to complete the processing within a realistic time period.

Finally, after selecting a candidate for labeling whose cost function is a maximum and then calculating an optimal three-dimensional moving track of each individual person, the three-dimensional moving track cost calculating unit 72 brings the optimal three-dimensional moving track of each individual person into correspondence with floors specified by a floor recognition unit 12 (stopping floor information showing stopping floors of the elevator), and calculates a person movement history showing the floor where each individual person has got on the elevator and the floor where each individual person has got off the elevator (a movement history of each individual person showing “how many persons have got on the elevator on which floor and how many persons have got off the elevator on which floor”) (step ST94).

In this embodiment, although the example in which the three-dimensional moving track cost calculating unit brings each of the three-dimensional moving tracks into correspondence with the floor information specified by the floor recognition unit 12 is shown, the three-dimensional moving track cost calculating unit can alternatively acquire stopping floor information from control equipment for controlling the elevator, and can bring each of the three-dimensional moving tracks into correspondence with the stopping floor information independently.

As can be seen from the above description, because the person tracking device in accordance with this Embodiment 3 is constructed in such away that the two-dimensional moving track labeling unit 71 determines a plurality of candidates for labeling by labeling each two-dimensional moving track graph generated by the two-dimensional moving track graph generating unit 47, selects an optimal candidate for labeling from among the plurality of candidates for labeling, and estimates the number of persons existing in the area to be monitored, this Embodiment 3 provides an advantage of being able to estimate each person's optimal (or semi-optimal) three-dimensional moving track and the number of persons within a realistic time period even when each two-dimensional moving track graph has a complicated structure and there are an astronomical number of candidates for labeling.

### Embodiment 4

In above-mentioned Embodiments 1 to 3, the method of measuring the person movement history of each person getting on and off an elevator is described. In contrast, in this Embodiment 4, a method of using the person movement history will be described.

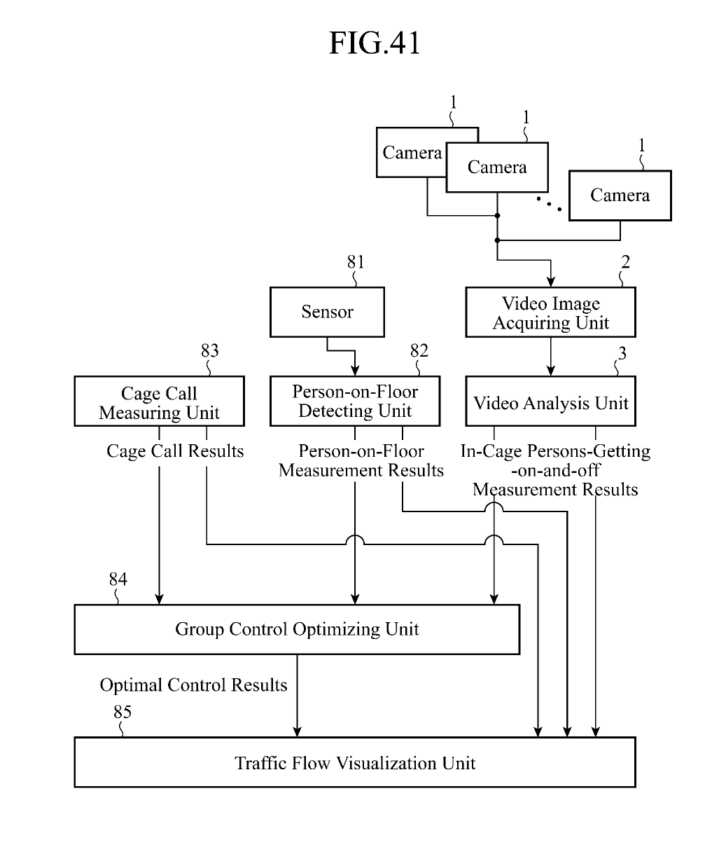

FIG. 41 is a block diagram showing a person tracking device in accordance with Embodiment 4 of the present invention. In FIG. 41, because a plurality of cameras 1 which construct shooting units, a video image acquiring unit 2, and a video analysis unit 3 are the same as those shown in Embodiment 1, Embodiment 2, or Embodiment 3, the explanation of the components will be omitted hereafter.

A sensor 81 is installed outside an elevator which is an area to be monitored, and consists of a visible camera, an infrared camera, or a laser range finder, for example.

A floor person detecting unit 82 carries out a process of measuring a movement history of each person existing outside the elevator by using information acquired by the sensor 81. A cage call measuring unit 83 carries out a process of measuring an elevator call history.

A group control optimizing unit 84 carries out an optimization process for allocating a plurality of elevator groups efficiently in such a way that elevator waiting times are minimized, and further simulates a traffic flow at the time of carrying out optimal group elevator control.

A traffic flow visualization unit 85 carries out a process of comparing a traffic flow which the video analysis unit 3, the floor person detecting unit 82, and the cage call measuring unit 83 have measured actually with the simulated traffic flow which the group control optimizing unit 84 has generated, and displaying results of the comparison with animation or a graph.

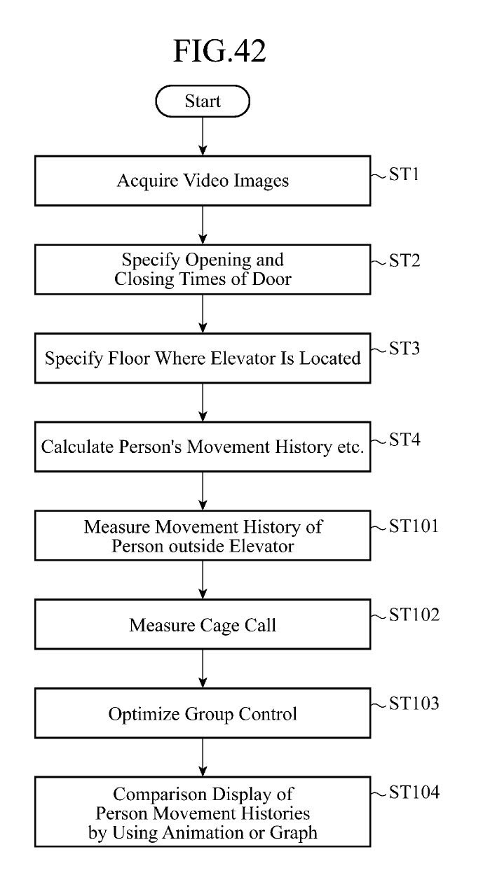

FIG. 42 is a flow chart showing a process carried out by the person tracking device in accordance with Embodiment 4 of the present invention. The same steps as those of the process carried out by the person tracking device in accordance with Embodiment 1 are designated by the same reference characters as those used in FIG. 6, and the explanation of the steps will be omitted or simplified hereafter.

First, the plurality of cameras 1, the video image acquiring unit 2, and the video analysis unit 3 calculate person movement histories of persons existing in the elevator (steps ST1 to ST4).

The floor person detecting unit 82 measures movement histories of persons existing outside the elevator by using the sensor 81 installed outside the elevator (step ST101).

For example, the person tracking device detects and tracks each person's head from a video image by using a visible camera as the sensor 81, like that in accordance with Embodiment 1, and the floor person detecting unit 82 carries out a process of measuring persons who are waiting for arrival of the elevator, three-dimensional moving tracks of persons who are getting on the elevator from now on, the number of the persons waiting, and the number of the persons getting on.

The sensor 81 is not limited to a visible camera, and can be an infrared camera for detecting heat, a laser range finder, or a pressure-sensitive sensor covered on the floor as long as the sensor can measure each person's movement information.

The cage call measuring unit 83 measures elevator cage call histories (step ST102). For example, the cage call measuring unit 83 carries out a process of measuring a history of pushdown of an elevator call button arranged on each floor.

The group control optimizing unit 84 unifies the person movement histories of persons existing in the elevator which are determined by the video analysis unit 3, the person movement histories of persons existing outside the elevator which are measured by the floor person detecting unit 82, and the elevator call histories which are measured by the cage call measuring unit 83, and carries out an optimization process for allocating the plurality of elevator groups efficiently in such away that average or maximum elevator waiting times are minimized. The group control optimizing unit further simulates person movement histories at the time of carrying out optimal group elevator control by using a computer to calculate the results of the person movement histories (step ST103).

In this embodiment, the elevator waiting time of a person is the time which elapses after the person reaches a floor until a desired elevator arrives at the floor.

As an algorithm for optimizing group control, an algorithm disclosed by the following reference 5 can be used, for example.

### REFERENCE 5

Nikovski, D., Brand, M., “Exact Calculation of Expected Waiting Times for Group Elevator Control”, IEEE Transactions on Automatic Control, ISSN: 0018-9286, Vol. 49, Issue 10, pp. 1820-1823, October 2004

Because conventional person tracking devices do not have any means for correctly measuring person movement histories for elevators, according to a conventional algorithm for optimizing group control, a process of optimizing the group elevator control is carried out by assuming a proper probability distribution of person movement histories inside and outside each elevator. In contrast, the person tracking device in accordance with this Embodiment 4 can implement further optimal group control by inputting the measured person movement histories to the conventional algorithm.

The traffic flow visualization unit 85 finally carries out a process of comparing the person movement histories which the video analysis unit 3, the floor person detecting unit 82, and the cage call measuring unit 83 have measured actually with the simulated person movement histories which the group control optimizing unit 84 has generated, and displaying results of the comparison with animation or a graph (step ST104).

For example, on a two-dimensional cross-sectional view of the building showing the elevators and tenants, the traffic flow visualization unit 85 displays the elevator waiting times, the sum total of persons' amounts of travel, or the probability of each person's travel per unit time with animation, or a diagram of elevator cage travels with a graph. The traffic flow visualization unit 85 can perform a simulation using a computer to increase or decrease the number of elevators installed in the building, or virtually calculate the movement history of a person at the time of introducing a new elevator model into the building, and display simultaneously the results of this simulation and the person movement histories which the video analysis unit 3, the floor person detecting unit 82, and the cage call measuring unit 83 have measured actually. Therefore, the present embodiment offers an advantage of making it possible to compare the simulation results with the actually-measured person movement histories to verify a change from the current traffic flow in the building to the expected traffic flow resulting from the reconstruction.

As can be seen from the above description, because the person tracking device in accordance with this Embodiment 4 is constructed in such a way that the sensor 81 is installed in an area outside the elevators, such as an elevator hall, and measures person movement histories, the present embodiment offers an advantage of being able to determine person travels associated with the elevators completely. This embodiment offers another advantage of implementing optimal group elevator control on the basis of the measured person movement histories. Furthermore, the person tracking device in accordance with this embodiment becomes possible to verify a change of the traffic flow resulting from reconstruction of the building correctly by comparing the actually-measured person movement histories with the results of a simulation of the reconstruction which are acquired by a computer.

### Embodiment 5

Conventionally, when a wheelchair accessible button of an elevator is pushed down on a floor, the elevator is allocated to the floor on a priority basis. However, because the elevator is allocated to the floor on a priority basis even when a healthy person accidentally pushes down the wheelchair accessible button without intending to do so, such allocation becomes a cause of lowering the operational efficiency of the elevator group.

To solve this problem, in this Embodiment 5, a structure of, only when recognizing a wheelchair by carrying out image processing and further recognizing that a person in the wheelchair exists on a floor and then in an elevator cage, operating the cage on a priority basis to operate the elevator group efficiently is shown.

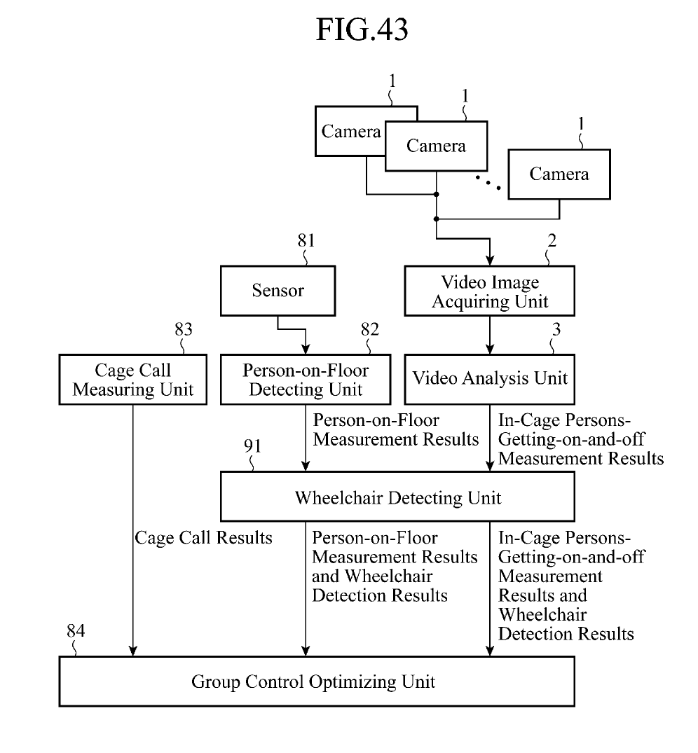

FIG. 43 is a block diagram showing a person tracking device in accordance with Embodiment 5 of the present invention. In FIG. 43, because a plurality of cameras 1 which construct shooting units, a video image acquiring unit 2, a video analysis unit 3, a sensor 81, a floor person detecting unit 82, and a cage call measuring unit 83 are the same as those in accordance with Embodiment 4, the explanation of the components will be omitted hereafter.

A wheelchair detecting unit 91 carries out a process of specifying a wheelchair and a person sitting on the wheelchair from among persons which are determined by the video analysis unit 3 and the floor person detecting unit 82.

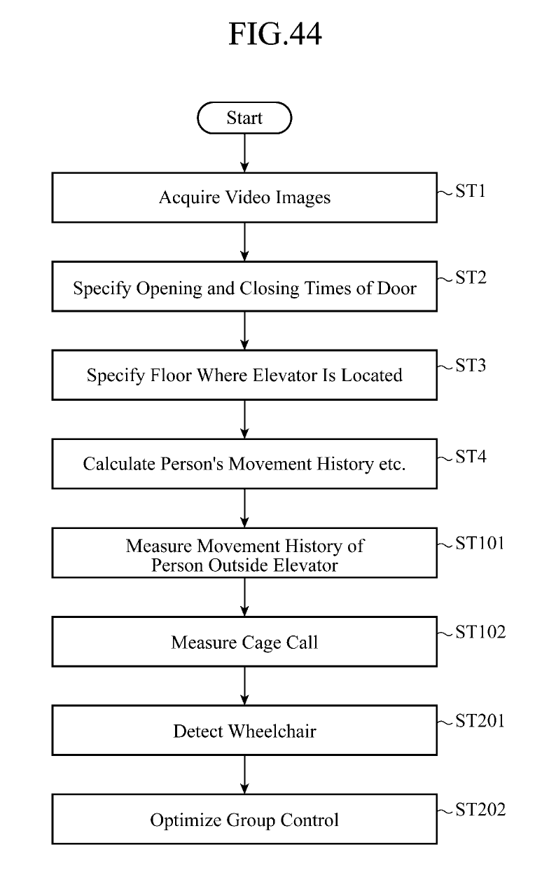

FIG. 44 is a flow chart showing a process carried out by the person tracking device are shown in accordance with Embodiment 5 of the present invention. The same steps as those of the process carried out by each of the person tracking devices in accordance with Embodiments 1 and 4 are designated by the same reference characters as those used in FIGS. 6 and 42, and the explanation of the steps will be omitted or simplified hereafter.

First, the plurality of cameras 1, the video image acquiring unit 2, and the video analysis unit 3 calculate person movement histories of persons existing in the elevator (steps ST1 to ST4). The floor person detecting unit 82 measures movement histories of persons existing outside the elevator by using the sensor 81 installed outside the elevator (step ST101). The cage call measuring unit 83 measures elevator cage call histories (step ST102).

The wheelchair detecting unit 91 carries out the process of specifying a wheelchair and a person sitting on the wheelchair from among persons which are determined by the video analysis unit 3 and the floor person detecting unit 82. (step ST201). For example, by carrying out machine learning of patterns of wheelchair images through image processing by using an Adaboost algorithm, a support vector machine, or the like, the wheelchair detecting unit specifies a wheelchair existing in the cage or on a floor from a camera image on the basis of the learned patterns. Furthermore, an electronic tag, such as an RFID (Radio Frequency IDentification), can be added to each wheelchair beforehand, and the person tacking device can detect that a wheelchair to which an electronic tag is added is approaching an elevator hall.

When a wheelchair is detected by the wheelchair detecting unit 91, a group control optimizing unit 84 allocates an elevator to the person in the wheelchair on a priority basis (step ST202). For example, when a person sitting on a wheelchair pushes an elevator call button, the group control optimizing unit 84 allocates an elevator to the floor on a priority basis, and carries out a preferential-treatment elevator operation of not stopping on any floor other than the destination floor. Furthermore, when a person in a wheelchair is going to enter an elevator cage, the group control optimizing unit can lengthen the time interval during which the door of the elevator is open, and the time required to close the door.

Conventionally, because even when a healthy person accidentally pushes down a wheelchair accessible button without intending to do so, an elevator is allocated to the corresponding floor on a priority basis, such allocation lowers the operational efficiency of the elevator group. In contrast, the person tracking device in accordance with this Embodiment 5 is constructed in such a way that the wheelchair detecting unit 91 detects a wheelchair, and dynamically carries out group elevator control according to the detecting state of the wheelchair, such as allocation of an elevator cage to the corresponding floor on a priority basis. Therefore, the person tracking device in accordance with this Embodiment 5 can carry out elevator operations more efficiently than conventional person tracking devices do. Furthermore, this embodiment offers an advantage of eliminating wheelchair accessible buttons for elevators.

In addition, in this Embodiment 5, although only the detection of a wheelchair is explained, the person tracking device can be constructed in such a way as to detect not only wheelchairs but also important persons, old persons, children, etc. automatically, and adaptively control the allocation of elevator cages, the door opening and closing times, etc.

### INDUSTRIAL APPLICABILITY

Because the person tracking device in accordance with the present invention can surely specify persons existing in an area to be monitored, the person tracking device in accordance with the present invention can be applied to the control of allocation of elevator cages of an elevator group, etc.

1. A person tracking device comprising:
a plurality of shooting units installed at different positions, each for shooting an identical area to be monitored;
a person position calculating unit for analyzing a plurality of video images of the area to be monitored which is shot by said plurality of shooting units to determine a position on each of the plurality of video images of each individual person existing in said area to be monitored;
a two-dimensional moving track calculating unit for calculating a two-dimensional moving track of each individual person in each of the plurality of video images by tracking the position on each of the plurality of video images which is calculated by said person position calculating unit; and
a three-dimensional moving track calculating unit for carrying out stereo matching between two-dimensional moving tracks in the plurality of video images, which are calculated by said two-dimensional moving track calculating unit, to calculate a degree of match between said two-dimensional moving tracks, and for calculating a three-dimensional moving track of each individual person from two-dimensional moving tracks each having a degree of match equal to or larger than a specific value.

2. The person tracking device according to claim 1, wherein the three-dimensional moving track calculating unit generates a three-dimensional moving track graph from the three-dimensional moving track of each individual person, searches through said three-dimensional moving track graph to determine a plurality of three-dimensional moving track candidates, and selects an optimal three-dimensional moving track from among the plurality of three-dimensional moving track candidates.

3. The person tracking device according to claim 2, wherein the person position calculating unit is comprised of a camera calibration unit for analyzing a distortion of a video image of a calibration pattern shot by each of the plurality of shooting units to calculate camera parameters of each of said plurality of shooting units, a video image correcting unit for correcting a distortion of the video image of the area to be monitored shot by each of said plurality of shooting units by using the camera parameters calculated by said camera calibration unit, and a person detecting unit for detecting each individual person in each of the plurality of video images in each of which the distortion has been corrected by said video image correcting unit, and for calculating the position of each individual person in each of the plurality of video images, the two-dimensional moving track calculating unit is comprised of a two-dimensional moving track calculating part for tracking the position on each of the plurality of video images which is calculated by said person detecting unit, and calculating the two-dimensional moving track of the individual person in each of the plurality of video images, and the three-dimensional moving track calculating unit is comprised of a two-dimensional moving track graph generating unit for performing a dividing process and a connecting process on the two-dimensional moving track calculated by said two-dimensional moving track calculating part to generate a two-dimensional moving track graph, a track stereo unit for searching through said two-dimensional moving track graph generated by said two-dimensional moving track graph generating unit to determine a plurality of two-dimensional moving track candidates, for carrying out stereo matching between two-dimensional moving track candidates in the plurality of video images in consideration of installed positions and installation angles of said plurality of shooting units with respect to a reference point in said area to be monitored to calculate a degree of match between said two-dimensional moving track candidates, and for calculating a three-dimensional moving track of each individual person from two-dimensional moving track candidates each having a degree of match equal to or larger than a specific value, a three-dimensional moving track graph generating unit for performing a dividing process and a connecting process on the three-dimensional moving track calculated by said track stereo unit to generate a three-dimensional moving track graph, a track combination estimating unit for searching through said three-dimensional moving track graph generated by said three-dimensional moving track graph generating unit to calculate a plurality of three-dimensional moving track candidates, and for selecting an optimal three-dimensional moving track from among the plurality of three-dimensional moving track candidates to estimate a number of persons existing in said area to be monitored.

4. The person tracking device according to claim 2, wherein said person tracking device includes a door opening and closing time specifying unit for, in a case in which the area to be monitored is an inside of an elevator, analyzing the plurality of video images of the inside of the elevator shot by the plurality of shooting units to specify opening and closing times of a door of said elevator, and, when selecting the optimal three-dimensional moving track from among the plurality of three-dimensional moving track candidates, the three-dimensional moving track calculating unit refers to the opening and closing times of the door specified by said door opening closed time specifying unit to exclude any three-dimensional moving track candidate whose time of track start point and time of track endpoint are within a time interval during which the door is closed.

5. The person tracking device according to claim 3, wherein said person tracking device includes a door opening and closing time specifying unit for, in a case in which the area to be monitored is an inside of an elevator, analyzing the plurality of video images of the inside of the elevator shot by the plurality of shooting units to specify opening and closing times of a door of said elevator, and, when selecting the optimal three-dimensional moving track from among the plurality of three-dimensional moving track candidates, the three-dimensional moving track calculating unit refers to the opening and closing times of the door specified by said door opening closed time specifying unit to exclude any three-dimensional moving track candidate whose time of track start point and time of track endpoint are within a time interval during which the door is closed.

6. The person tracking device according to claim 4, wherein said door opening and closing time specifying unit is comprised of: a background image registering unit for registering, as a background image, an image of a door region in the elevator in a state in which the door is closed; a background difference unit for calculating a difference between the background image registered by said background image registering unit and a video image of the door region shot by the plurality of shooting units; an optical flow calculating unit for calculating a motion vector showing a direction of movement of the door from a change in the video image of the door region shot by said plurality of shooting units; a door opening and closing time specifying part for determining an open or closed state of the door from the difference calculated by said background difference unit and the motion vector calculated by said optical flow calculating unit to specify the opening and closing times of said door; and a background image updating unit for updating said background image by using the video image of the door region shot by said plurality of shooting units.

7. The person tracking device according to claim 5, wherein said door opening and closing time specifying unit is comprised of: a background image registering unit for registering, as a background image, an image of a door region in the elevator in a state in which the door is closed; a background difference unit for calculating a difference between the background image registered by said background image registering unit and a video image of the door region shot by the plurality of shooting units; an optical flow calculating unit for calculating a motion vector showing a direction of movement of the door from a change in the video image of the door region shot by said plurality of shooting units; a door opening and closing time specifying part for determining an open or closed state of the door from the difference calculated by said background difference unit and the motion vector calculated by said optical flow calculating unit to specify the opening and closing times of said door; and a background image updating unit for updating said background image by using the video image of the door region shot by said plurality of shooting units.

8. The person tracking device according to claim 1, wherein a floor specifying unit for analyzing a video image of an inside of an elevator to specify a floor where said elevator is located at each time, and the three-dimensional moving track calculating unit determines a person movement history showing a floor where each individual person has got on the elevator and a floor where each individual person has got off the elevator by bringing the three-dimensional moving track of each individual person into correspondence with floors specified by said floor specifying unit.

9. The person tracking device according to claim 8, wherein the floor specifying unit is comprised of: a template image registering unit for registering images of an indicator showing a floor where the elevator is located as template images; a template matching unit for carrying out template matching between the template images registered by said template image registering unit and a video image of an indicator region in the elevator shot by the plurality of shooting units to specify the floor where said elevator is located at each time; and a template image updating unit for updating said template images by using the video image of the indicator region shot by said plurality of shooting units.

10. The person tracking device according to claim 8, wherein said person tracking device includes an image analysis result display unit for displaying the person movement history determined by the three-dimensional moving track calculating unit.

11. The person tracking device according to claim 9, wherein said person tracking device includes an image analysis result display unit for displaying the person movement history determined by the three-dimensional moving track calculating unit.

12. The person tracking device according to claim 10, wherein the image analysis result display unit is comprised of: a video display unit for displaying video images of the inside of the elevator which are shot by the plurality of shooting units; a time series information display unit for carries out time-series graphical representation of the person movement history determined by the three-dimensional moving track calculating unit in time series; a summary display unit for determining statistics on the person movement history determined by said three-dimensional moving track calculating unit, and for displaying results of the statistics on said person movement history; an operation related information display unit for displaying information related to an operation of the elevator with reference to the person movement history determined by said three-dimensional moving track calculating unit; and a sorted data display unit for sorting and displaying the person movement history determined by said three-dimensional moving track calculating unit.

13. The person tracking device according to claim 11, wherein the image analysis result display unit is comprised of: a video display unit for displaying video images of the inside of the elevator which are shot by the plurality of shooting units; a time series information display unit for carries out time-series graphical representation of the person movement history determined by the three-dimensional moving track calculating unit in time series; a summary display unit for determining statistics on the person movement history determined by said three-dimensional moving track calculating unit, and displaying results of statistics on said person movement history; an operation related information display unit for displaying information related to an operation of the elevator with reference to the person movement history determined by said three-dimensional moving track calculating unit; and a sorted data display unit for sorting and displaying the person movement history determined by said three-dimensional moving track calculating unit.

14. The person tracking device according to claim 3, wherein the camera calibration unit calculates installed positions and installation angles of the plurality of shooting units with respect to a reference point in the area to be monitored by using the video image of the calibration pattern shot by each of the plurality of shooting units, and the camera parameters of each of said plurality of shooting units, and outputs the installed positions and the installation angles of said plurality of shooting units to the track stereo unit.

15. The person tracking device according to claim 3, wherein when determining the position of each individual person on each video image, the person detecting unit calculates a degree of certainty of said individual person, and the two-dimensional moving track calculating part ends the tracking of said person's position when a degree of accumulated certainty calculated by said person detecting unit is equal to or lower than a predetermined threshold.

16. The person tracking device according to claim 3, wherein when the person detecting unit carries out the detecting process of detecting each individual person, and then detects said each individual person, the two-dimensional moving track calculating part raises a value of a counter related to a result of the detection of said each individual person, whereas when the person detecting unit cannot detect said each individual person, the two-dimensional moving track calculating unit carries out a process of lowering the value of the counter related to the result of the detection of said each individual person and, when the value of said counter is equal to or smaller than a predetermined threshold, ends the tracking of said each individual person's position.

17. The person tracking device according to claim 3, wherein when detecting each individual person in each of the video images in each of which the distortion has been corrected by said video image correcting unit, the person detecting unit assumes, as erroneous detection results, person detection results each showing that a person's head size is smaller than a minimum rectangular size and person detection results each showing that a person's head size is larger than a maximum rectangular size to exclude them from person detection results.

18. The person tracking device according to claim 3, wherein when determining the two-dimensional moving track of each individual person in each of the video images, the two-dimensional moving track calculating part determines the two-dimensional moving track by tracking the position of each individual person on each of the video images, which is calculated by the person detecting unit, in a forward direction of time, and also determines the two-dimensional moving track by tracking the position of each individual person on each of the video images in a backward direction of time.

19. The person tracking device according to claim 3, wherein even when, after determining a three-dimensional moving track of each individual person from the two-dimensional moving track candidates each having a degree of match equal to or larger than the specific value, said three-dimensional moving track does not satisfy entrance and exit criteria for the area to be monitored, the track stereo unit discards said three-dimensional moving track.

20. The person tracking device according to claim 3, wherein the track stereo unit determines a three-dimensional moving track of each individual person by determining a three-dimensional position of each individual person in a time zone in which two-dimensional moving track candidates overlap each other, and then estimating a three-dimensional position of each individual person in a time zone in which no two-dimensional moving tracks overlap each other from said three-dimensional position.

21. The person tracking device according to claim 3, wherein when selecting the optimal three-dimensional moving track from among the plurality of three-dimensional moving track candidates, the track combination estimating unit excludes three-dimensional moving track candidates whose track start points and track endpoints do not exist in an entrance and exit portion of the area to be monitored while leaving three-dimensional moving track candidates each extending from an entrance to said area to be monitored to an exit from said area to be monitored unexcluded.

22. The person tracking device according to claim 21, wherein from among the three-dimensional moving track candidates each extending from an entrance to said area to be monitored to an exit from said area to be monitored, the track combination estimating unit selects a combination of three-dimensional moving track candidates which maximizes a cost function which reflects the number of persons existing in the area to be monitored, a positional relationship among the persons, and accuracy of the stereo matching carried out by the track stereo unit.

23. The person tracking device according to claim 2, wherein the person position calculating unit is comprised of a camera calibration unit for analyzing a distortion of a video image of a calibration pattern shot by each of the plurality of shooting units to calculate camera parameters of each of said plurality of shooting units, a video image correcting unit for correcting a distortion of the video image of the area to be monitored shot by each of said plurality of shooting units by using the camera parameters calculated by said camera calibration unit, a person detecting unit for detecting each individual person in each of the plurality of video images in each of which the distortion has been corrected by said video image correcting unit, and for calculating the position of each individual person in each of the plurality of video images, the two-dimensional moving track calculating unit is comprised of a two-dimensional moving track calculating part for tracking the position on each of the plurality of video images which is calculated by said person detecting unit, and calculating the two-dimensional moving track of the individual person in each of the plurality of video images, and the three-dimensional moving track calculating unit is comprised of a two-dimensional moving track graph generating unit for performing a dividing process and a connecting process on the two-dimensional moving track calculated by said two-dimensional moving track calculating part to generate a two-dimensional moving track graph, a track stereo unit for searching through said two-dimensional moving track graph generated by said two-dimensional moving track graph generating unit to determine a plurality of two-dimensional moving track candidates, for carrying out stereo matching between two-dimensional moving track candidates in the plurality of video images in consideration of installed positions and installation angles of said plurality of shooting units with respect to a reference point in said area to be monitored to calculate a degree of match between said two-dimensional moving track candidates, and for calculating a three-dimensional moving track of each individual person from two-dimensional moving track candidates each having a degree of match equal to or larger than a specific value, a three-dimensional moving track graph generating unit for performing a dividing process and a connecting process on the three-dimensional moving track calculated by said track stereo unit to generate a three-dimensional moving track graph, and a track combination estimating unit for labeling vertices of the three-dimensional moving track graph generated by said three-dimensional moving track graph generating unit to determine a plurality of candidates for labeling, and for selecting an optimal candidate for labeling from among the plurality of candidates for labeling to estimate a number of persons existing in said area to be monitored.

24. The person tracking device according to claim 23, wherein from among the plurality of candidates for labeling, the track combination estimating unit selects a candidate for labeling which maximizes a cost function which reflects the number of persons existing in the area to be monitored, a positional relationship among the persons, accuracy of the stereo matching carried out by the track stereo unit, and entrance and exit criteria for the area to be monitored.

25. The person tracking device according to claim 2, wherein the three-dimensional moving track calculating unit is comprised of a two-dimensional moving track graph generating unit for performing a dividing process and a connecting process on the two-dimensional moving track calculated by said two-dimensional moving track calculating part to generate a two-dimensional moving track graph, a two-dimensional moving track labeling unit for labeling vertices of the two-dimensional moving track graph generated by said two-dimensional moving track graph generating unit in a probabilistic manner, a track stereo unit for carrying out stereo matching between two-dimensional moving track candidates having a same label in the plurality of video images, among a plurality of candidates for labeling of two-dimensional moving tracks generated by said two-dimensional moving track labeling unit, in consideration of installed positions and installation angles of the plurality of shooting units with respect to a reference point in the area to be monitored to calculate a degree of match between said two-dimensional moving track candidates, and for calculating a three-dimensional moving track of each individual person from two-dimensional moving track candidates each having a degree of match equal to or larger than a specific value, and a three-dimensional moving track cost calculating unit for, for a set of three-dimensional moving tracks generated by said track stereo unit, evaluating a cost function of a three-dimensional moving track which takes into consideration at least a number of persons, a positional relationship among the persons, the degree of stereo match between the two-dimensional moving tracks, stereoscopic vision accuracy, and entrance and exit criteria for the area to be monitored to estimate an optimal three-dimensional moving track.

26. The person tracking device according to claim 1, wherein said person tracking device includes a floor person detecting unit for measuring a person movement history of each person outside an elevator from information which a sensor installed outside the elevator acquires, a cage call measuring unit for measuring a call history of the elevator, and a group control optimizing unit for carrying out a process of optimizing allocation of a group of elevators from the three-dimensional moving track of each individual person calculated by said three-dimensional moving track calculating unit, the person movement history of each person outside the elevator which is measured by said floor person detecting unit, and the call history measured by said cage call measuring unit, and for calculating a simulated traffic flow of the elevator group based on said optimizing process.

27. The person tracking device according to claim 26, wherein said person tracking device includes a traffic flow visualizing unit for comparing an actually-measured person movement history including a three-dimensional moving track of each individual person, a person movement history of each person outside the elevator, and a call history with the simulated traffic flow calculated by the group control optimizing unit to display results of the comparison.

28. The person tracking device according to claim 26, wherein said person tracking device includes a wheelchair detecting unit for detecting a wheelchair, and the group control optimizing unit carries out elevator group control according to a detecting state of said wheelchair detecting unit.

29. A person tracking program for causing a computer to carry out:
a position calculating process of, when receiving video images of an identical area to be monitored shot by a plurality of shooting units installed at different positions, determining a position on each of the plurality of video images of each individual person existing in said area to be monitored;
a two-dimensional moving track calculating process of calculating a two-dimensional moving track of each individual person in each of the plurality of video images by tracking the position on each of the plurality of video images which is calculated through said person position calculating process; and
a three-dimensional moving track calculating process of carrying out stereo matching between two-dimensional moving tracks in the plurality of video images, which are calculated through said two-dimensional moving track calculating process, to calculate a degree of match between said two-dimensional moving tracks, and for calculating a three-dimensional moving track of each individual person from two-dimensional moving tracks each having a degree of match equal to or larger than a specific value.
